(19) United States
(12) Patent Application Publication
(10) Pub. No.: US 2004/0220872 A1
(43) Pub. Date: Nov. 4, 2004

(54) Lending based on an asset and securitization of loan interests

(76) Inventor: Frederick E. Pollock III, Henderson, NV (US)

Correspondence Address: FISH & RICHARDSON PC, 225 FRANKLIN ST, BOSTON, MA, 02110, US

(21) Appl. No.: 10/430,865

(22) Filed: May 7, 2003

Related U.S. Application Data
(60) Provisional application No. 60/466,316, filed on Apr. 29, 2003.

(51) Int. Cl. G06F 17/60

(52) U.S. Cl. 705/38

(57) ABSTRACT

In one aspect, a value is credited to a holder of an appreciating asset, and, in exchange for the crediting, a commitment is received by the holder (a) of repayment of an amount, which declines over time whether or not the holder has paid any portion of the amount, and (b) that a share of appreciation of the asset will be paid upon the transfer of the asset by the holder.

This application is entitled to and claims the benefit of the priority of a provisional U.S. patent application, filed on Apr. 29, 2003, entitled Lending Based on an Asset and Securitization of Loan Interests, the entire contents of which are incorporated by reference.

### BACKGROUND

This description relates to lending based on an asset and securitization of loan interests.

Lending on homes, for example, is often done by conventional mortgage financing and also by other less conventional techniques.

Home equity loans are used to release value from an existing home. Such loans require recurring payments by the borrower during the term, have a fixed interest rate, and have a principal balance that does not automatically decline without repayment. A borrower risks losing his or her home if payments are not made.

Reverse mortgages have fixed interest rates and the fixed balance accumulates over time. In addition, there are limitations, such as age-based ones, on reverse mortgage borrowers.

So-called shared appreciation mortgages allow a lender to take an equity participation in an underlying asset. The equity participation is applied to reduce the interest payments due on the mortgage. Shared appreciation mortgages are used to finance acquisition indebtedness such as for a conventional mortgage, and the principal balance is fixed.

The Reverse Mortgage Advisor Volume 3.2 (Spring 2000) edition contained the following statement about another mortgage instrument:

“The new product, called the home appreciation loan (HAL), is still under development and may be unveiled in the third quarter of this year. HAL would have many characteristics of a reverse mortgage. For example, a borrower could take the loan proceeds as a lump sum, and the loan wouldn't have to be repaid until the borrower dies or sells the home. The repayment obligation would be the loan amount borrowed, plus accrued interest and a predetermined percentage share of the home appreciation during the loan period, which would be negotiated upfront between Financial Freedom and each borrower. The greater the percentage, the larger the loan size. For example, if a borrower's home was valued at $150,000 when the HAL was made, and the home was sold five years later for $180,000, the borrower would have to pay Financial Freedom a percentage of the $30,000 gain from the sale of the home.”

A variety of techniques are available to investors who want to participate in the real estate market, including direct investment in residential real estate, indirect investment through real estate vehicles such as real estate investment trusts (REITs) or real estate limited partnerships (RELPs). Most REITs and RELPs concentrate on commercial, not residential real estate investment. Those that do invest in residential real estate tend to invest in apartment or other multi-family complexes, not single-family residential real estate.

### SUMMARY

In general, in one aspect, the invention features a method that includes crediting a value to a holder of an appreciating asset, and in exchange for the crediting, receiving a commitment by the holder (a) of repayment of an amount, which declines over time whether or not the holder has paid any portion of the amount, and (b) that a share of appreciation of the asset will be paid upon the transfer of the asset by the holder.

In general, in another aspect, the invention features a method that includes crediting a value to a holder of an appreciating asset, and in exchange for the crediting, receiving a commitment by the holder that a share of appreciation of the asset will be paid upon the transfer of the asset by the holder, without receiving a commitment by the holder to pay any other interest amount not based on appreciation.

In general, in another aspect, the invention features a method that includes receiving from a holder of an asset an indication of a share of appreciation of the asset that would be paid in exchange for a loan, and calculating proposed terms of the loan based on the indicated share of appreciation.

In general, in another aspect, the invention features a method that includes setting a value to be credited to a holder of an appreciating asset, setting a share of appreciation of the asset that would be paid in exchange for the value, and determining a time period in which a repayment amount will decline to a predetermined value, based on the credited value and the share of appreciation.

Implementations of the invention may include one or more of the following features. The repayment amount declines to a predetermined amount. The repayment amount declines to the predetermined amount within a predefined number of months. The predetermined amount is $0. The share of appreciation is measured as a percentage of the appreciation. The asset comprises a house and the holder is an owner of the house. A commitment is received from the holder to fund insurance against risk of loss of the asset. A transferable right of first refusal may be received from the holder with respect to the asset. An information updating commitment is received from the holder. An anti-subordination commitment is received from the holder. A lien is placed on the asset. A mechanism is provided for reimbursement of the holder's maintenance, improvement, or selling expenses with respect to the asset. An estimate is received of the value of the asset, and the accuracy of the estimated value is analyzed to determine a corrected value. In general, in another aspect, the invention features a method that includes receiving information describing an asset associated with the appreciation loan, and comparing the information to information defining properties qualifying to underlie the appreciation loan. The method of claim in which, if the corrected value is not within a threshold of the estimated value, the holder may either accept the estimated value, accept the corrected value, or obtain an appraisal.

In general, in another aspect, the invention features a method that includes determining if an asset which is to be associated with an appreciation loan is subject to a legal impediment that would restrict transfer of the asset, and if so, adjusting terms of the appreciation loan. The impediment may be associated with one of following (among others): homesteading laws, usury laws, mandatory loan waiting periods, and mandatory cancellation periods.

In general, in another aspect, the invention features a method that includes receiving from a holder of an asset, proposed values of variables associated with a proposed appreciation loan supported by the asset, the variables including at least one of the amount of the loan, the share of appreciation to be paid back by the holder, and the number of months during which a principal balance will decline to a predetermined amount, and providing to the holder proposed values for the variables that have not been received from the holder.

In general, in another aspect, the invention features a method that includes generating a schedule of a balance of a principal amount and an appreciation interest for any time period after issuance of a loan associated with an appreciating asset.

In general, in another aspect, the invention features a method that includes receiving a proposed nominal value of an appreciation loan associated with an appreciating asset, and determining whether the nominal value meets guidelines of a lender of the loan.

In general, in another aspect, the invention features a method that includes recording values of the terms of asset appreciation loans and information about aborted loans or rejected borrowers.

In general, in another aspect, the invention features a method that includes calculating amounts due to a lender upon transfer of an appreciating asset or repayment of an appreciation loan associated with the asset based on a loan schedule.

In general, in another aspect, the invention features a method comprising determining a lender's economic interest in an asset associated with an appreciation loan at a given time, and reimbursing a holder of the asset for maintenance, improvement, or selling expenses up to a specified contribution percentage determined as a function of the lender's economic interest.

In general, in another aspect, the invention features a method comprising aggregating asset appreciation interests, the assets being organized based on geographic characteristics of the assets.

Implementations of the invention may include one or more of the following features. The aggregating comprises bundling asset appreciation interests. The aggregating comprises securitizing asset appreciation interests with another form of instrument. The other form of instrument includes a financial instrument, a derivative instrument, or an obligation. The instrument includes a guarantee of a stream of fixed payments. The fixed payments comprise a compensating fixed interest rate component of a securitized asset with respect to collection of the asset appreciation interests. An acquirer of the asset appreciation interests specifies a minimum acceptable fixed interest rate and the method includes determining that an expected variable interest rate formed as an aggregate of the asset appreciation interests and fixed balance payments is below the minimum acceptable rate. The aggregated appreciation assets are consolidated with other instruments selected to achieve financial characteristics that match predetermined financial characteristics. A database is updated to include records for the other instruments. The other instruments include an obligation to make a lump sum payment. The lump sum payment comprises a cash payment equal to a nominal amount of a loan granted by a third-party vendor/financial intermediary. The consolidating is triggered either by an action of a lender or an action of a third party vendor/financial intermediary.

In general, in another aspect, the invention features a method comprising organizing asset appreciation interests to include a fixed repayment balance and an asset appreciation participation interests. The asset appreciation participation interests are subdivided. The interests are bundled or securitized.

In general, in another aspect, the invention features a method comprising forming a pooled financial instrument that includes asset appreciation interests, and basing the constituents of the pooled financial instrument on predefined financial characteristics. The predefined financial characteristics are received from a third-party vendor/financial intermediary. Existing or expected appreciation asset interests are bundled or securitized as the financial instrument having the financial characteristics. The financial instrument comprises an asset appreciation contingent financial instrument in which a value of the instrument is based upon a change in a contractually-specified valuation metric. The valuation metric comprises indices of values of the financial instrument.

In general, in another aspect, the invention features a method comprising evaluating a portfolio of geographically-pegged appreciation assets of a third-party vendor/financial intermediary, and offering a financial product through the intermediary a based on the evaluated portfolio. The financial product is offered based on a consideration of old assets, new assets, and exchanges of assets.

In general, in another aspect, the invention features a method comprising rebalancing a portfolio of asset appreciation interests to achieve at least one of improved diversification, more accurate price contingent liability correlation, and geographic adjustment.

In general, in another aspect, the invention features a method comprising maintaining a database, the database comprising relational pairs, each of the pairs linking an amount of funds associated with asset appreciation interests with a geographic area associated with appreciation assets.

In general, in another aspect, the invention features a method comprising evaluating a party as a possible third-party vendor/financial intermediary to serve as a counterparty in an exchange transaction involving appreciation loan assets. The third-party vendor/financial intermediary is identified as a previous counterparty in a transaction involving appreciation loan assets.

In general, in another aspect, the invention features a method comprising evaluating whether a lender of funds on asset appreciation loans can utilize funds proposed to be provided by a third-party vendor/financial intermediary, and if so, accepting the funds from the intermediary.

Implementations of the invention may include one or more of the following features. The relational pair database is evaluated for a correlation of asset appreciation interests in the area. A fund of asset appreciation interests is divided into three categories: those interests that can be correlated in a lender's ordinary course of lending, those interests that can be correlated through modification of lending practices within predefined limits, and those interests that cannot be correlated exactly with the region specified by the third-party vendor/financial intermediary. Distinct appreciation assets are included or excluded in a bundled or securitized instrument based upon their categorization. The constituents of the appreciation interest comprise appreciation assets that are included or excluded in the instrument based on a probabilistic estimate of their falling into one of the categories. The inclusion or exclusion is based on a choice made by the third-party vendor/financial intermediary. Historical asset appreciation loan lending is statistically analyzed to predict whether correlation will be achieved in the future within the three categories.

In general, in another aspect, the invention features a method comprising matching available appreciation assets with geographic regions specified by a third-party vendor/financial intermediary, with respect to a narrower geographic region and then with respect to a broader region within which an asset is associated.

In general, in another aspect, the invention features a method comprising maximizing a diversification of available matched appreciation assets based on geographic diversity. The maximizing comprises maximizing geographic distances among included assets or based on historic negative correlation or lack of correlation.

In general, in another aspect, the invention features a method comprising selecting appreciation assets for inclusion in a financial security, the selecting being based on an appreciation asset loan lender's lending limit, and from the selected group, identifying appreciation loan assets to be included in the new financial security.

Implementations of the invention may include one or more of the following features. The assets to be included are identified based on at least one of historical lending data, historical price appreciation data, predicted lending data, and predicted price appreciation data. The appreciation loan assets are identified in a manner to achieve at least one of: maximizing or minimizing projected returns, risk-weighting metrics, optimizing diversification within a targeted zone, correlating components positively or negatively, ensuring regulatory compliance of the financial security, and tailoring the financial security to appeal to a targeted investor.

In general, in another aspect, the invention features a method comprising scanning a third-party vendor's/financial intermediary's existing or expected portfolio of appreciation assets according to lender-specified characteristics, and triggering a bundling or securitization process when the characteristics are satisfied.

Among the advantages of the invention are one or more of the following.

When used for home financing, existing homeowners can receive a lump-sum payment (or equivalent value stream of payments) without making recurring interest payments or risking being forced out of their homes, while having the loan's fixed repayment balance decline to $0 over time.

Because homeowners are able to monetize the expected future appreciation in the value of their homes, they can accelerate their present consumption, as they do with other forms of consumer credit. Homeowners are able to receive a lump-sum payment (or equivalent value stream of payments) to spend as they desire with the possibility of a preserved tax deduction akin to a traditional home equity loan. The absence of recurring payments makes alternative use of the funds feasible. The home appreciation loan product gives borrowers greater financial freedom. The financing technique could be used with properties other than homes.

With respect to home appreciation loan bundling or securitization process, the home appreciation loan lender is able to transfer loan assets, representing future claims, to third party vendors/financial intermediaries in exchange for current assets. Second, the third party vendor/financial intermediary is able to earn investment returns that are geographically-correlated or guaranteed to match contractually-specified home price indices changes. Such a third party vendor/financial intermediary (1) gains access to a low transaction cost vehicle to earn returns linked to residential real estate price changes, and (2) offsets risk associated with any liabilities on accounts or other obligations pegged to residential real estate price changes. The offering of home price-pegged accounts becomes feasible.

The direct beneficiaries are third party vendors/financial intermediaries that wish to earn investment returns correlated with the change in geographically-pegged residential real estate assets or price indices. These returns may be independently valuable or may be valuable as a mechanism to offset the third party vendor/financial intermediary's own risk. For example, if the third party vendor/financial intermediary offered geographically-pegged home price accounts with returns correlated to home price indices changes then the acquisition of home appreciation loan assets would offset such risk. This risk reduction creates value, which can be reflected in the exchange terms via such mechanisms as an explicit transaction fee or below market compensating interest rate paid by the home appreciation lender.

Indirect beneficiaries are ultimate investors who can save their funds in a financial vehicle derived from home appreciation loan assets. For example, individuals saving towards a first-home down payment have no good way to match their investment returns to the price change of homes within the geographic area in which they wish to purchase. These individuals are forced to bear uncompensated risk due to this investment return/home price change mismatch. The home appreciation loan bundling or securitization process will facilitate the offering by third party vendors/financial intermediaries of investment vehicles and accounts that peg the returns on invested funds to the returns on the homes they wish to purchase with respect to geographic areas as broad as the entire globe or potentially as narrow as a zip code or neighborhood.

Possible indirect beneficiaries include: (1) individuals and families saving towards a first time home purchase, (2) existing homeowners with foreseeable plans to relocate to a different geographic region, and (3) existing homeowners that will increase their home equity investment by “sizing up” to a larger home within the same geographic area. All three groups have no effective means of guarding against the risk that their investment returns will not match the changes in home prices within their desired geographic area.

The category of potential beneficiaries is vast, but some likely member-beneficiaries include first-time homebuyers, relocating retirees, planned career shifters, family status changers (due to marriage, divorce, childbirth, etc.), lifestyle improvers (housing upgraders), and investors and real estate speculators.

Although many of the aspects above are recited in terms of methods, other aspects of the invention relate to the apparatus, systems, and user interfaces of which examples are described below.

Other advantages and features will become apparent from the following description and from the claims.

### DESCRIPTION

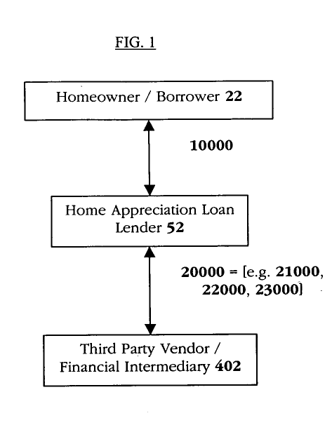

FIG. 1 illustrates a mortgage financing system.

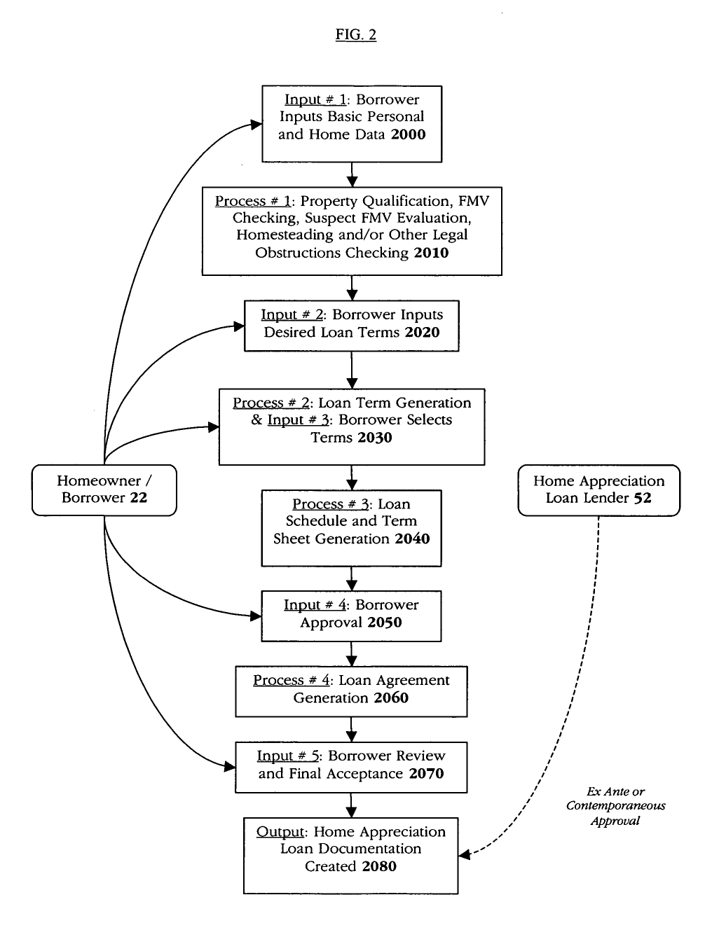

FIG. 2 illustrates a flow chart of steps for effecting a home appreciation loan.

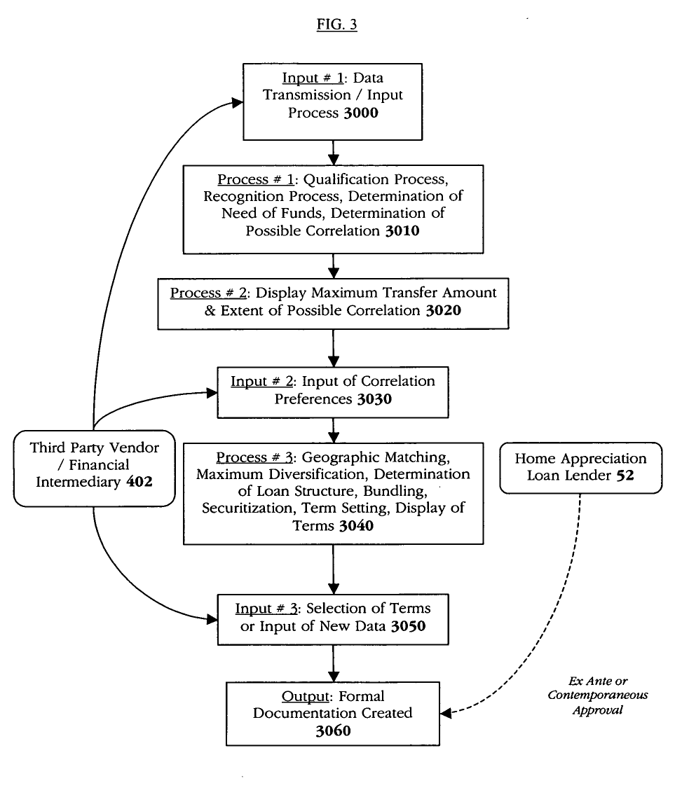

FIG. 3 illustrates one example of a bundled or securitized home appreciation asset-based financial instrument. In particular, it demonstrates a third party vendor/financial intermediary-initiated process to create a tailored financial instrument.

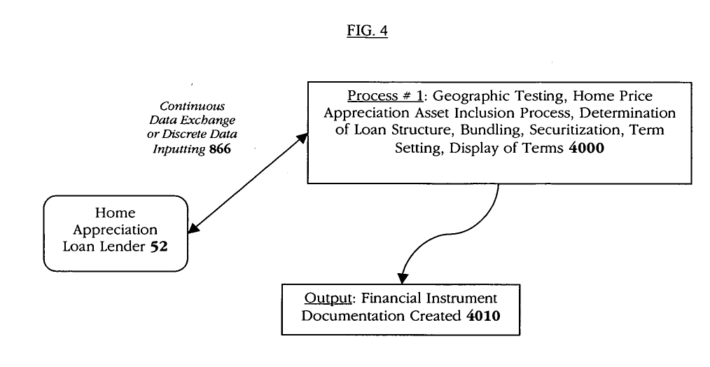

FIG. 4 illustrates another example of a bundled or securitized home appreciation asset-based financial instrument. In particular, it demonstrates a home appreciation lender-initiated process to create a standard financial instrument.

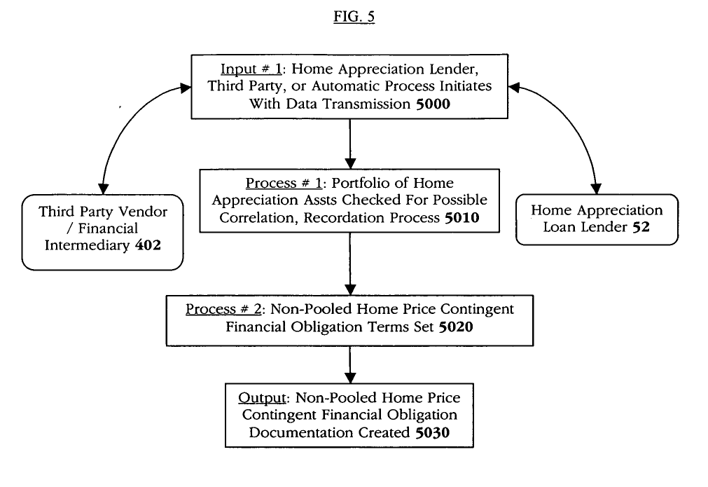

FIG. 5 illustrates another facet of the bundling or securitizing of home price contingent assets. In particular, it demonstrates the creation of a non-pooled home price contingent financial obligation.

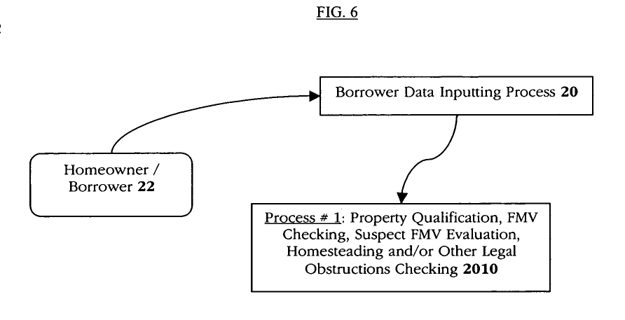

FIGS. 6 through 28 are flow charts.

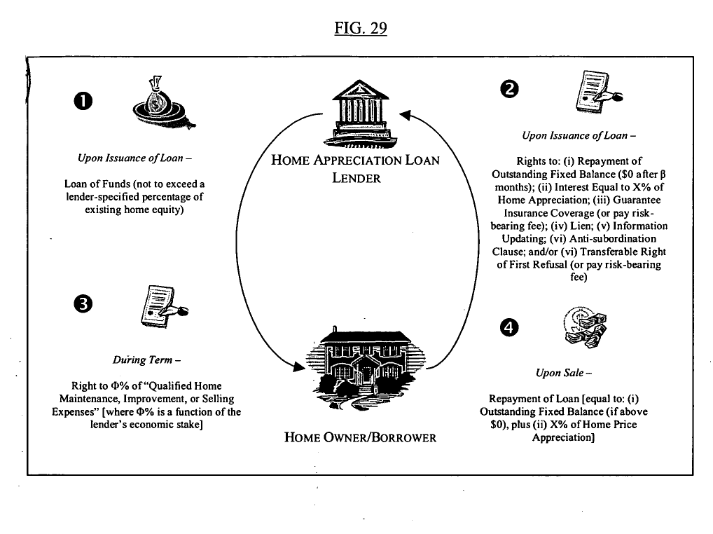

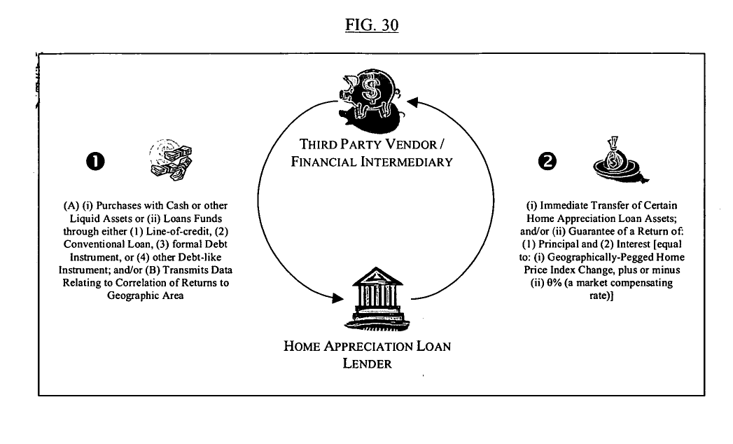

FIGS. 29 and 30 are block diagrams.

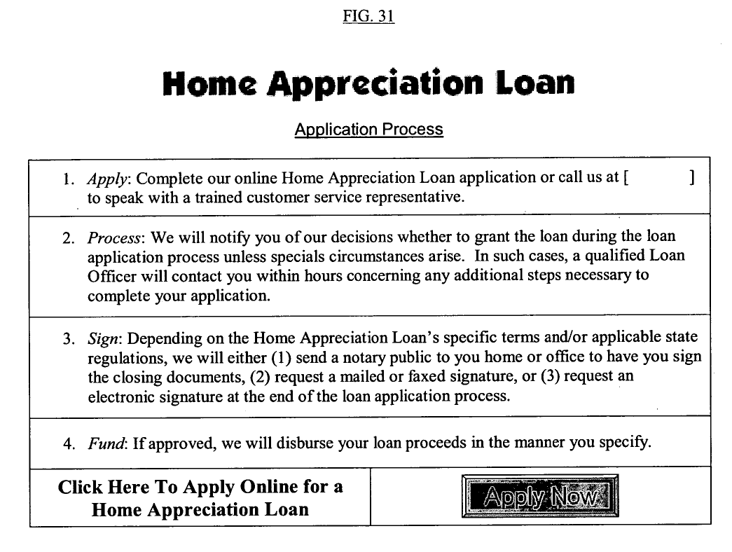

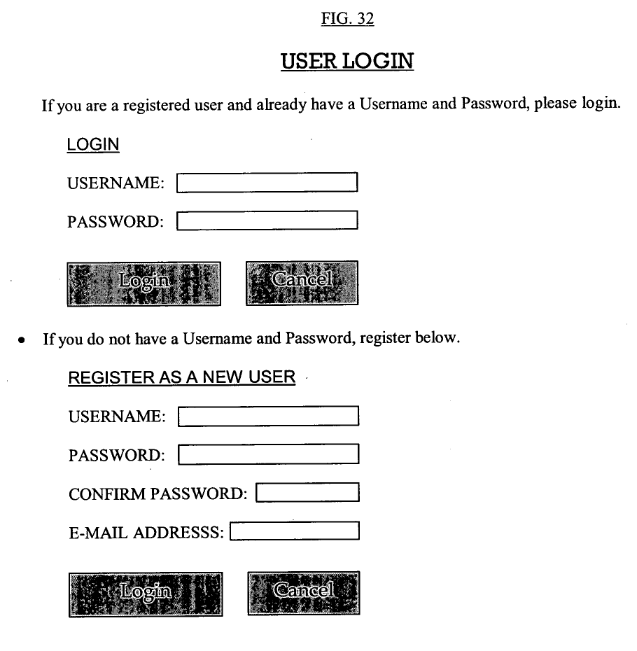

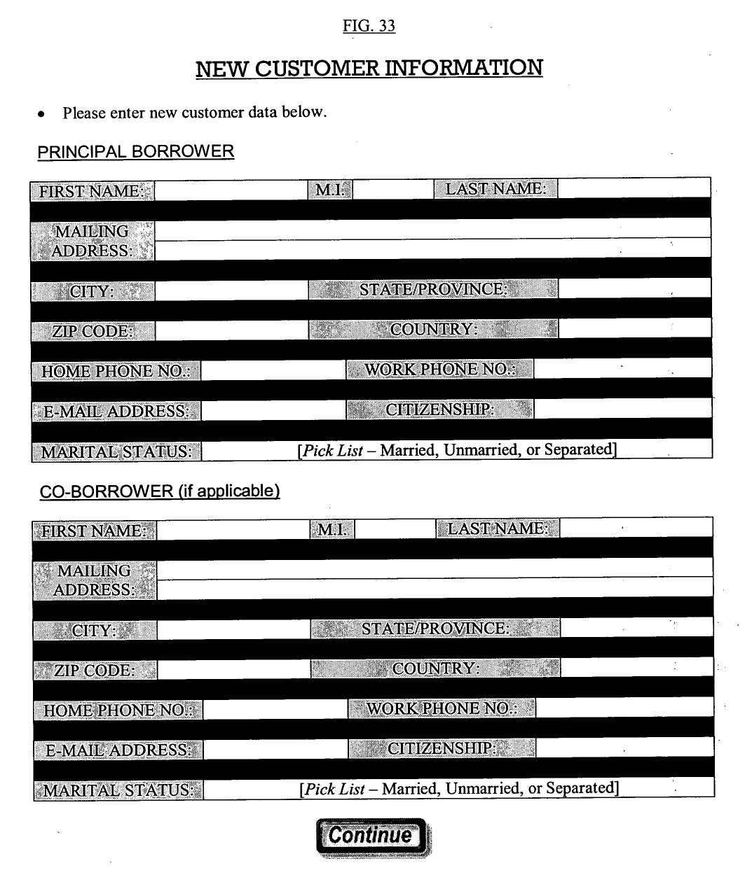

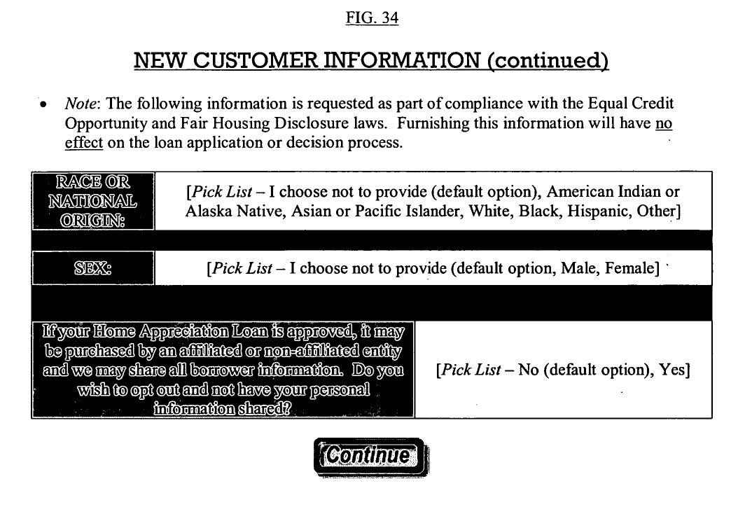

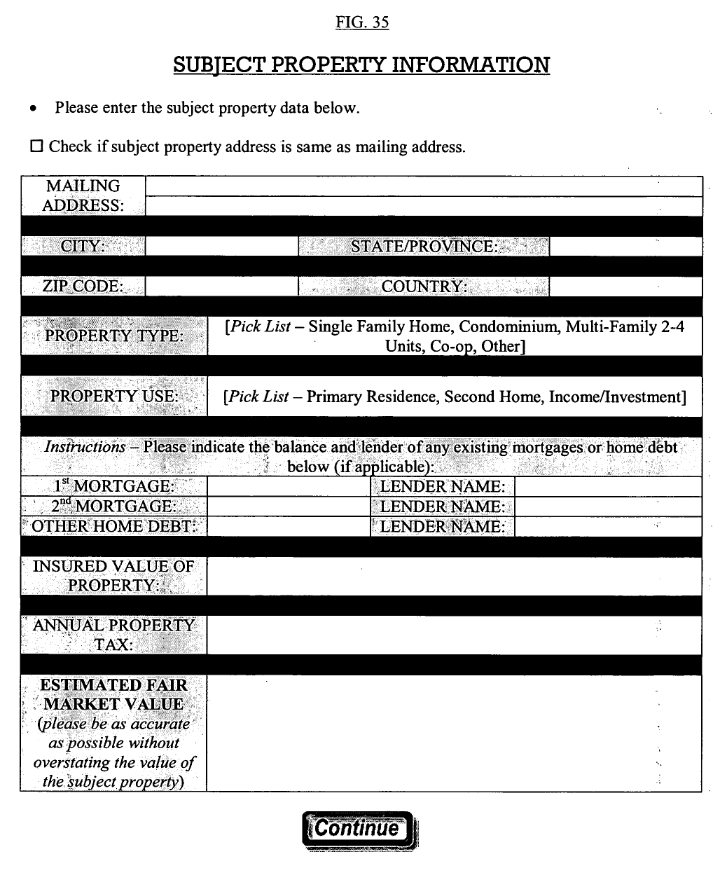

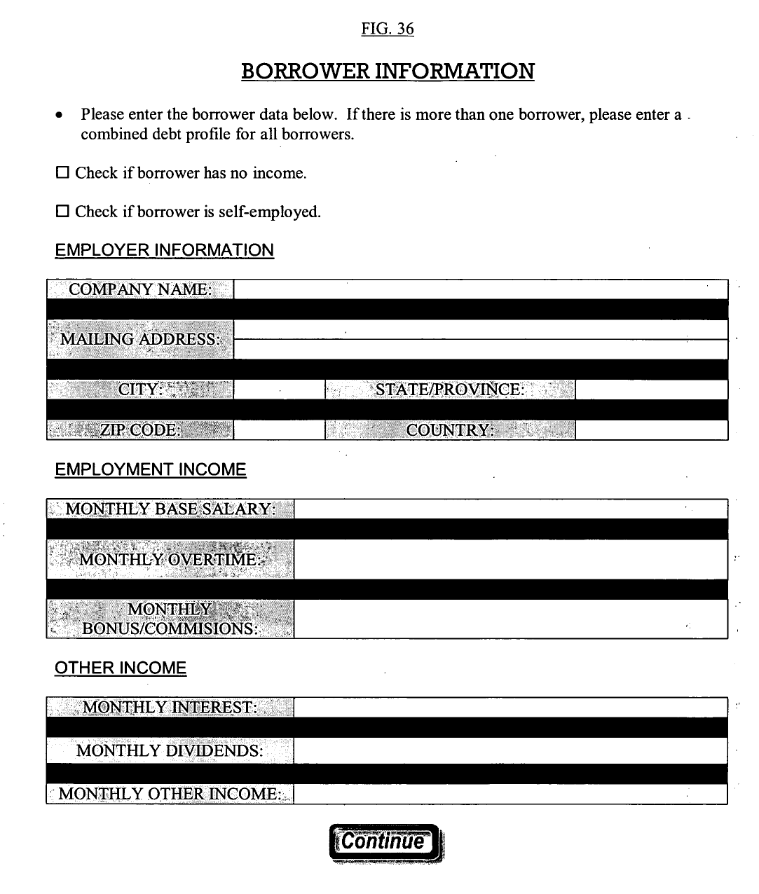

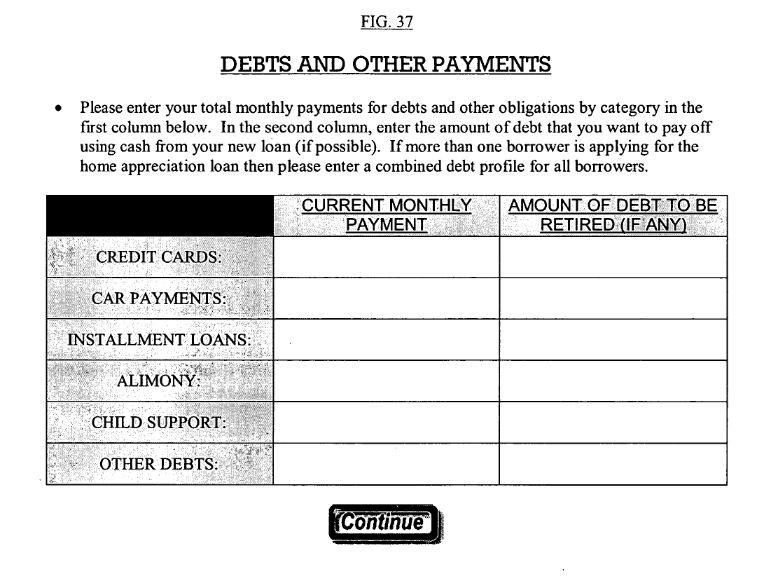

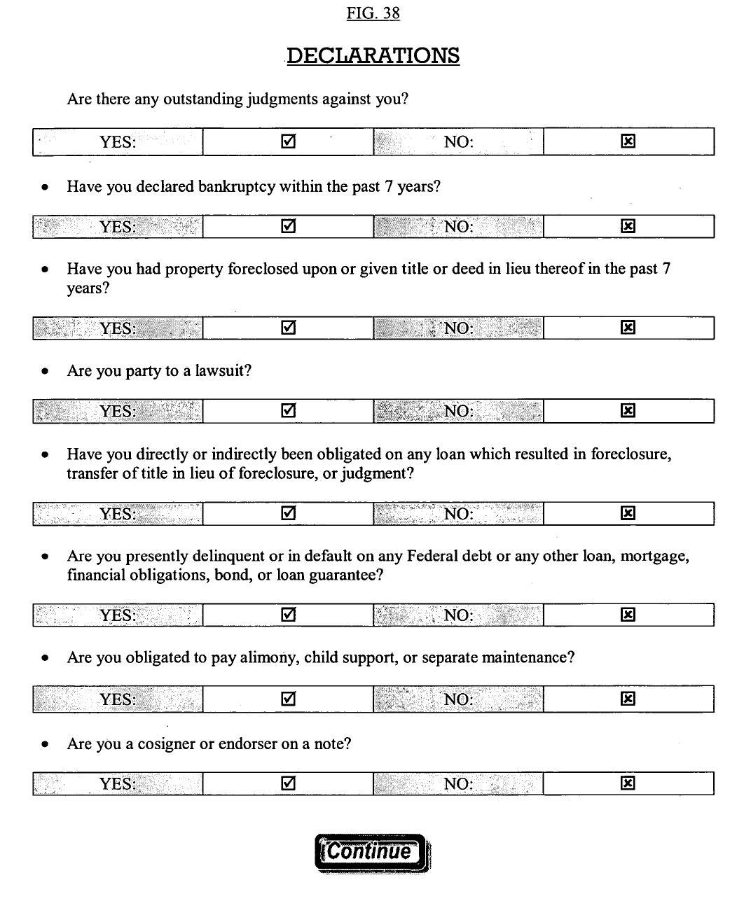

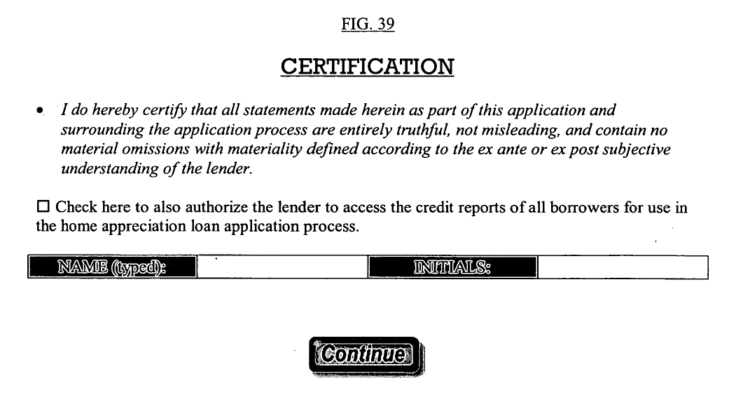

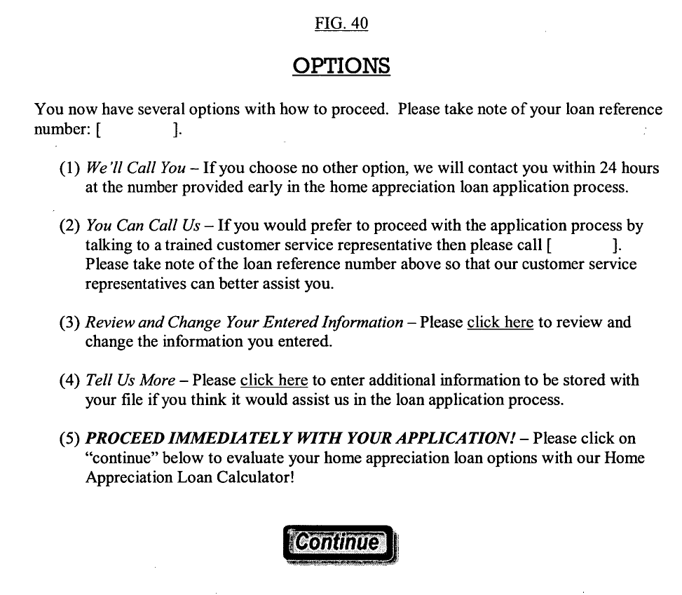

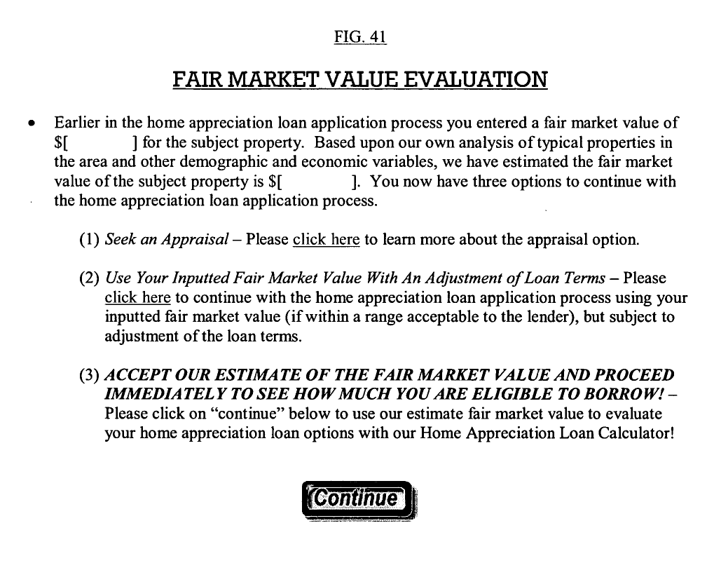

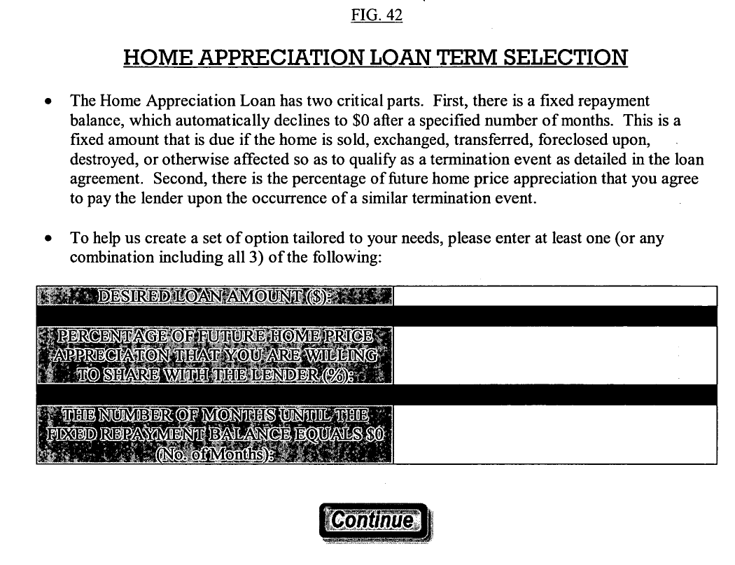

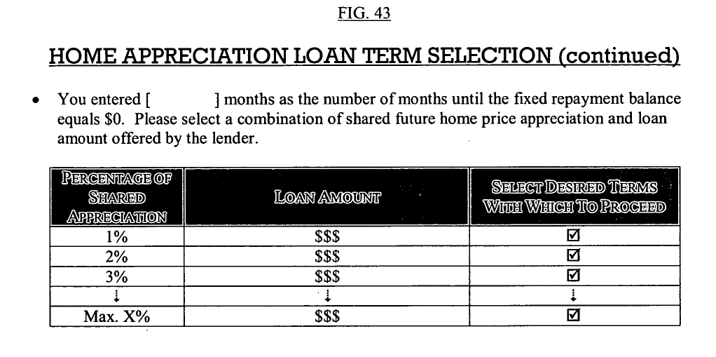

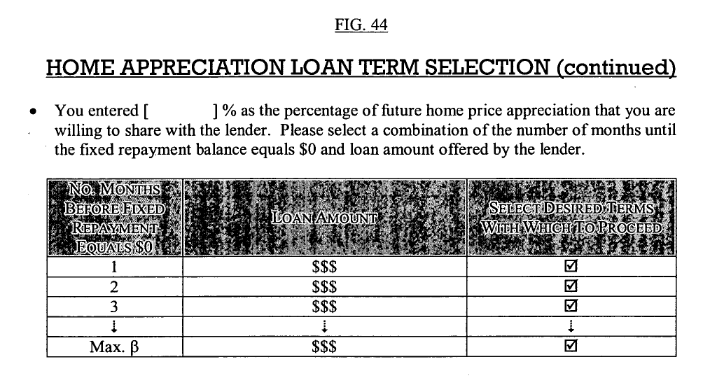

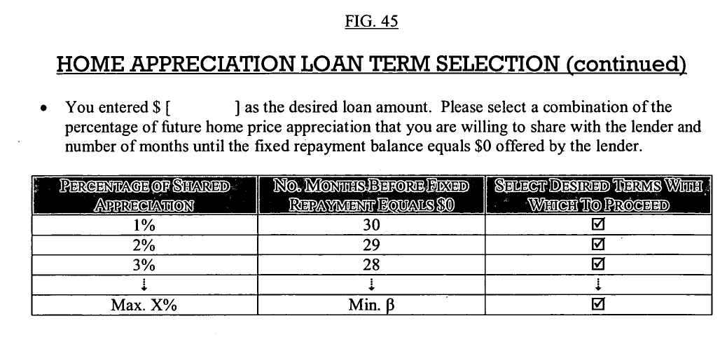

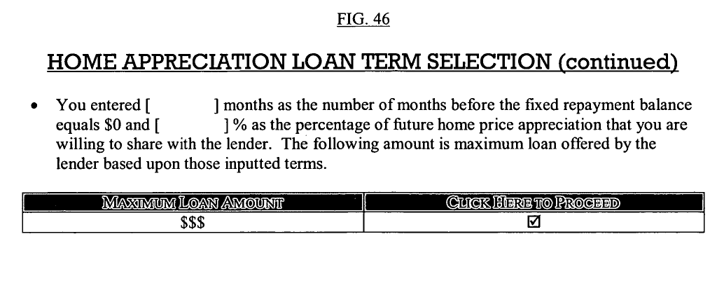

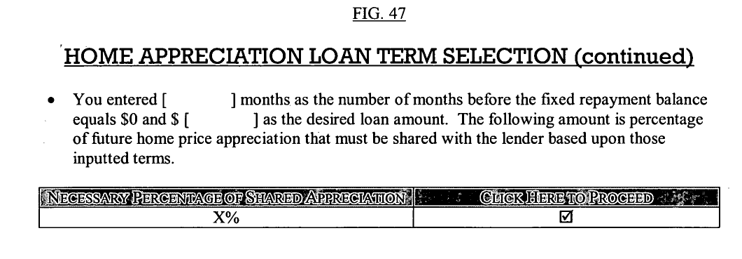

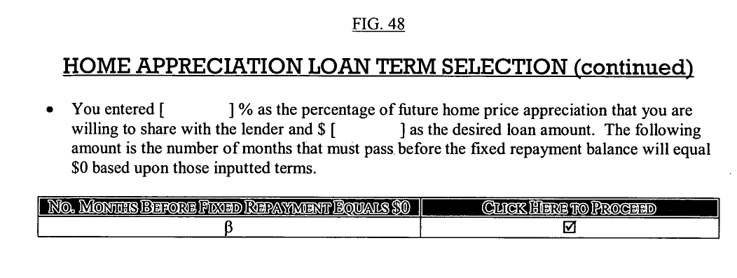

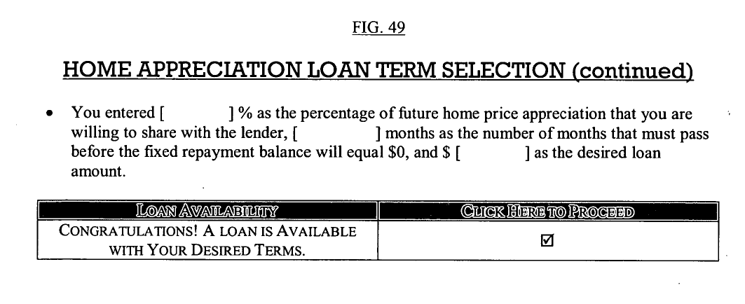

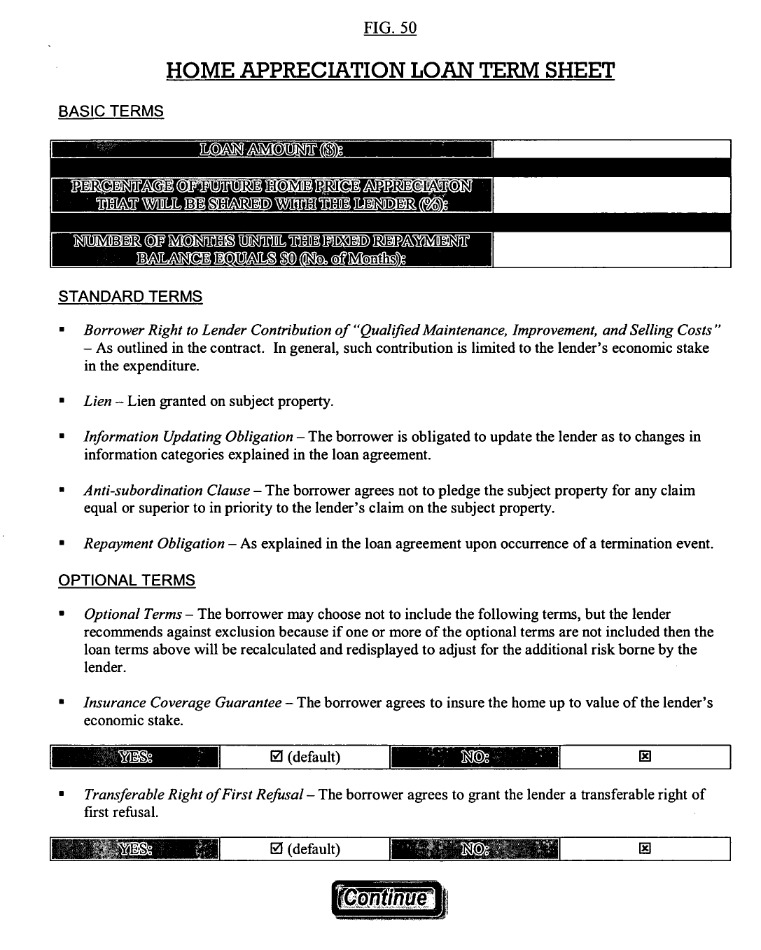

FIGS. 31 through 51 illustrate aspects of an example interface for a home appreciation loan borrower.

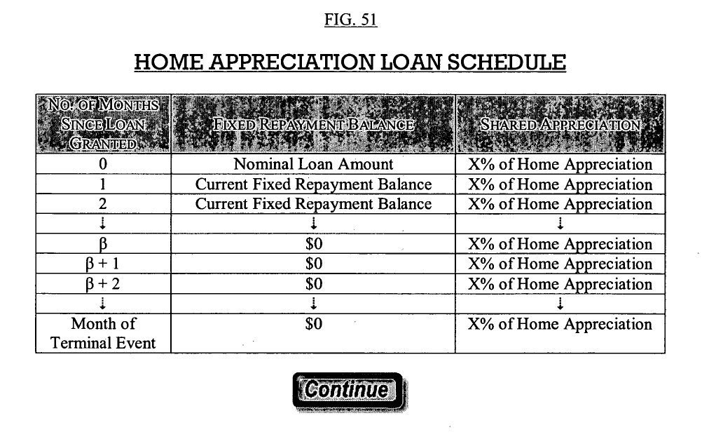

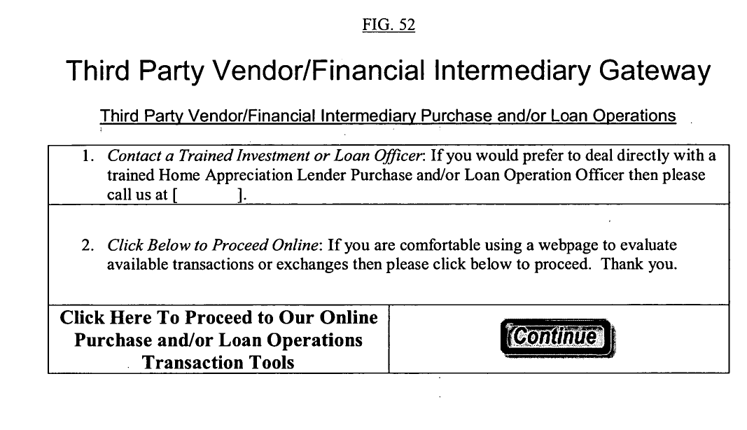

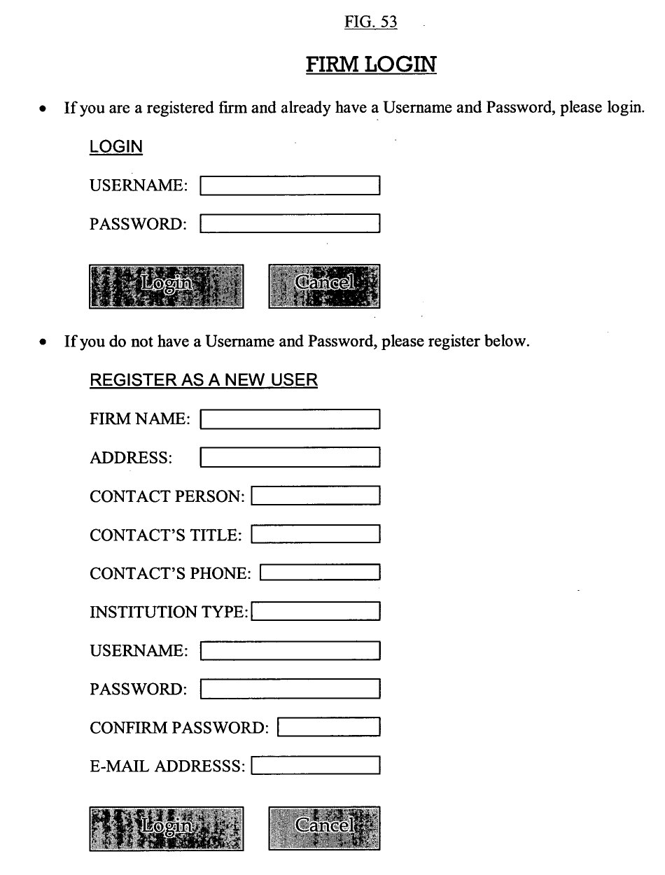

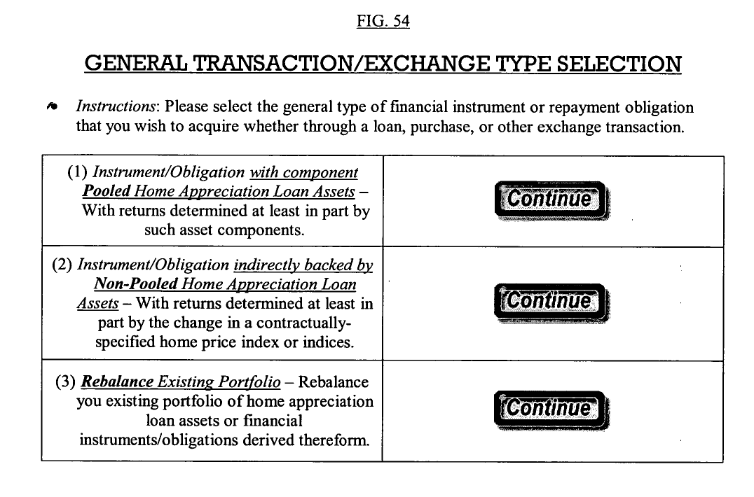

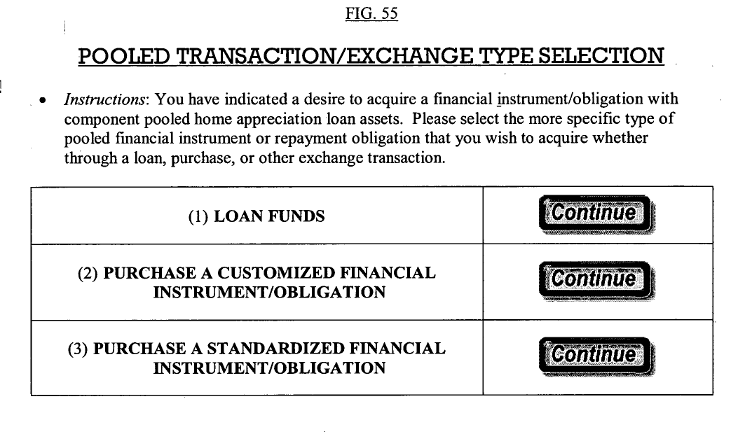

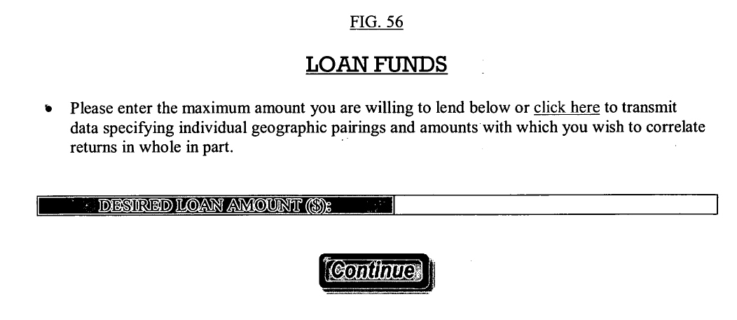

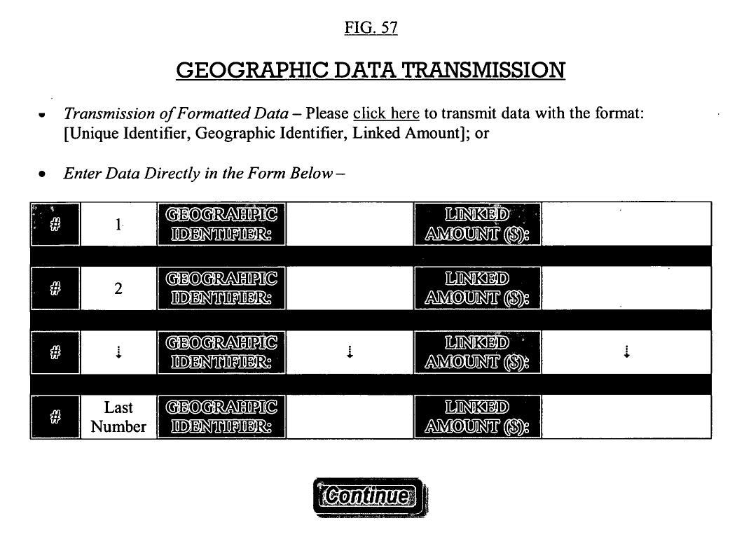

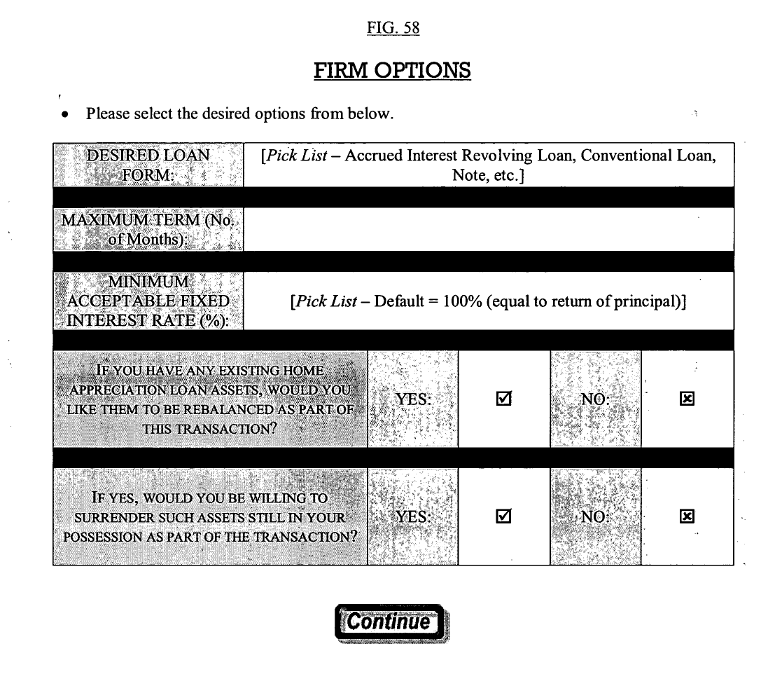

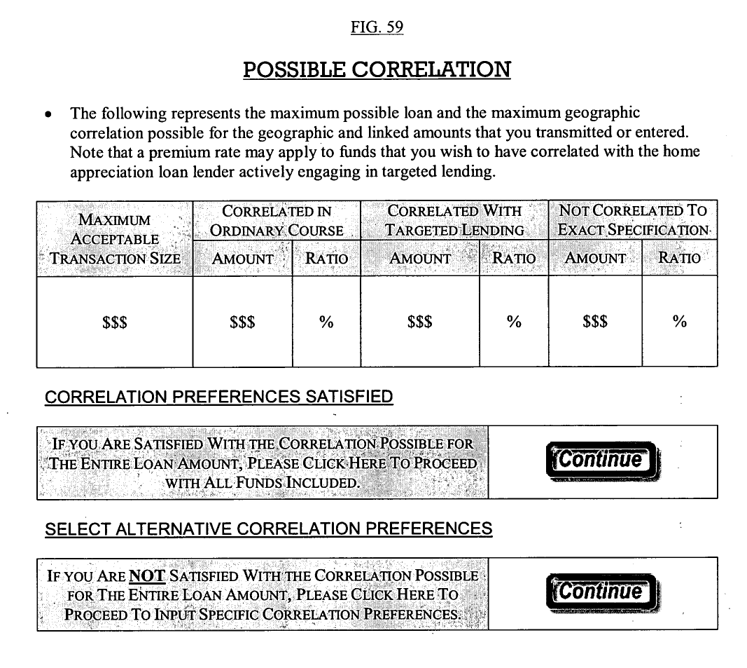

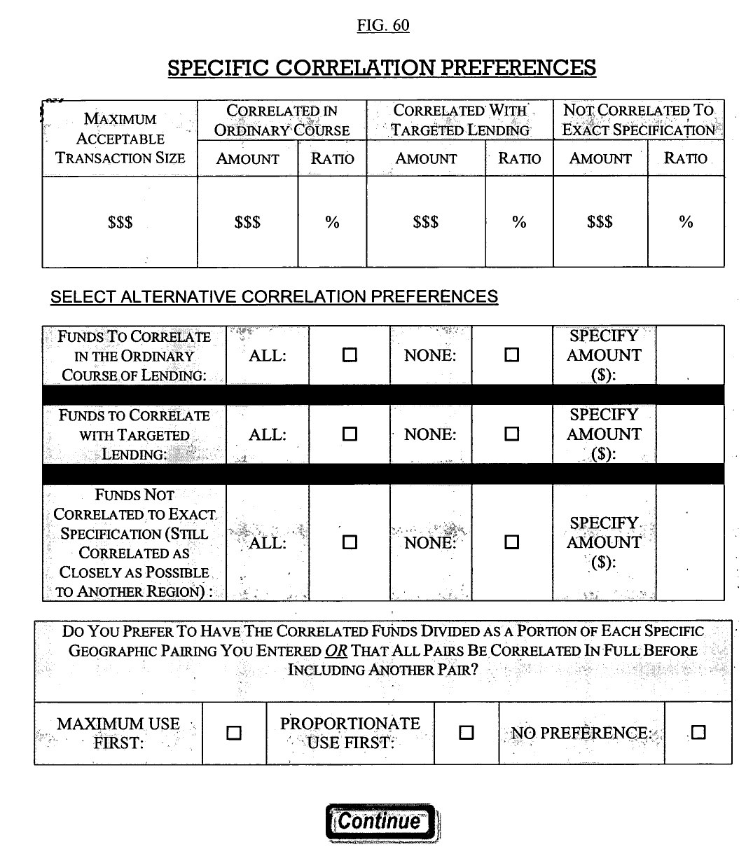

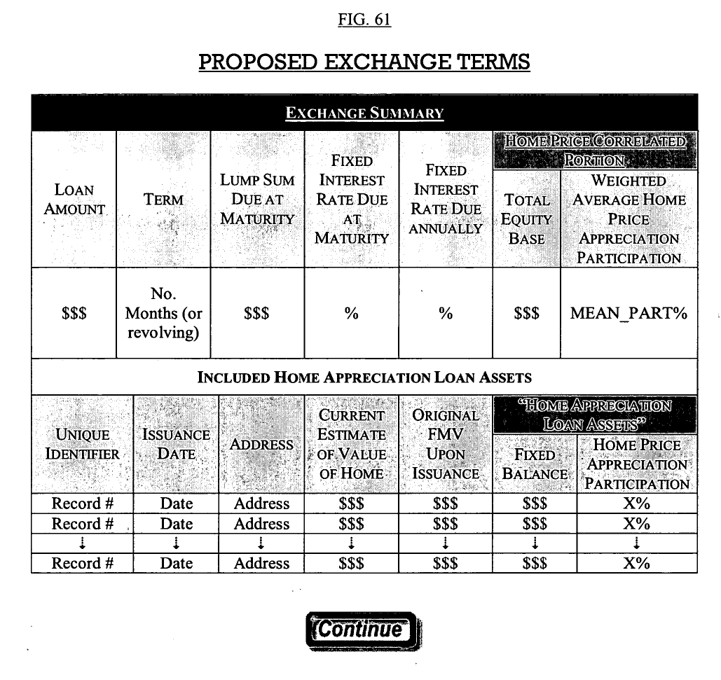

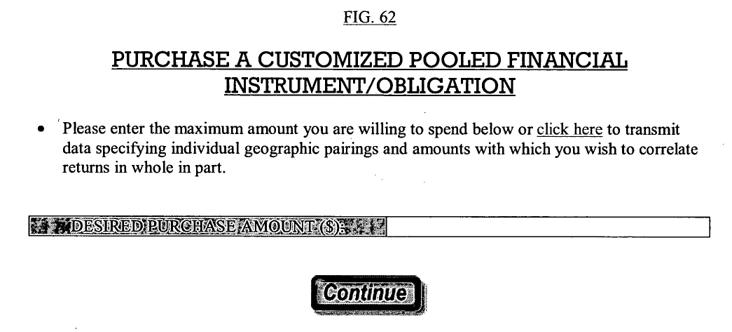

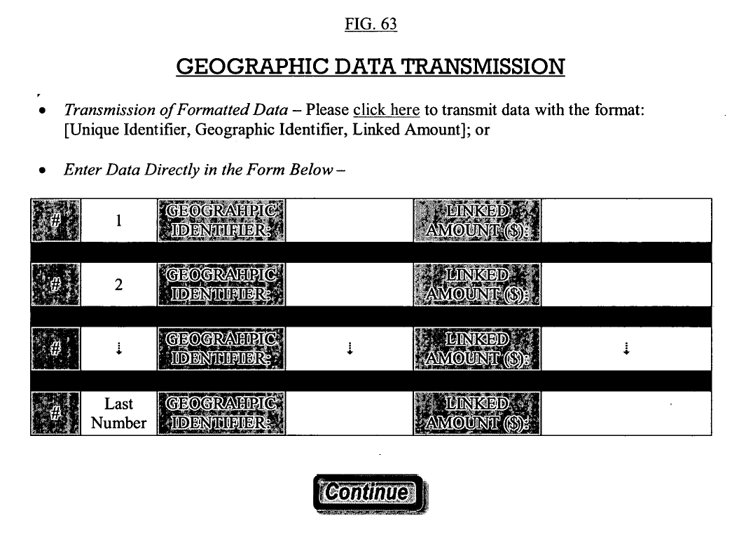

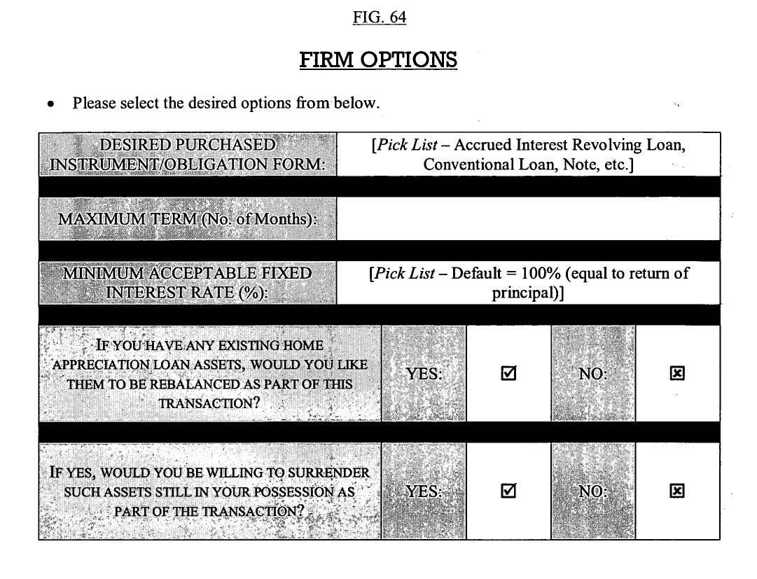

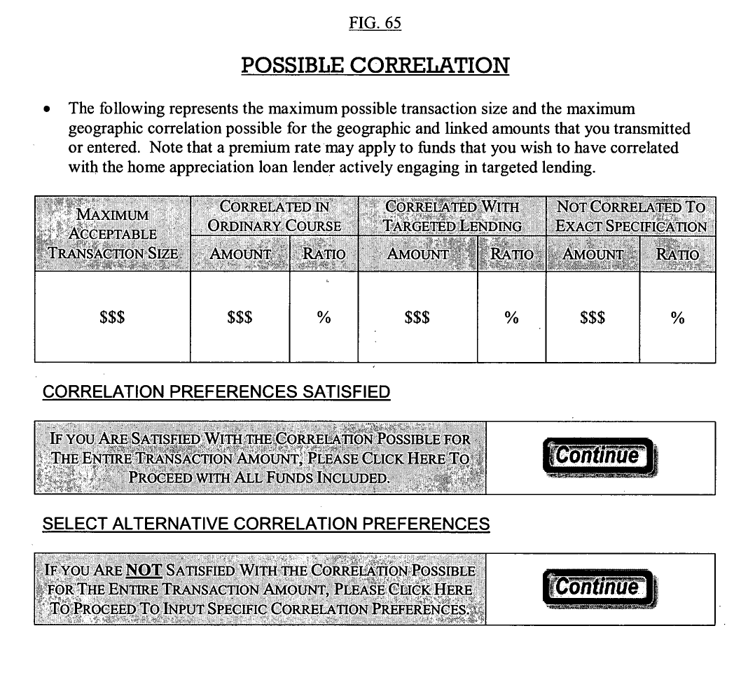

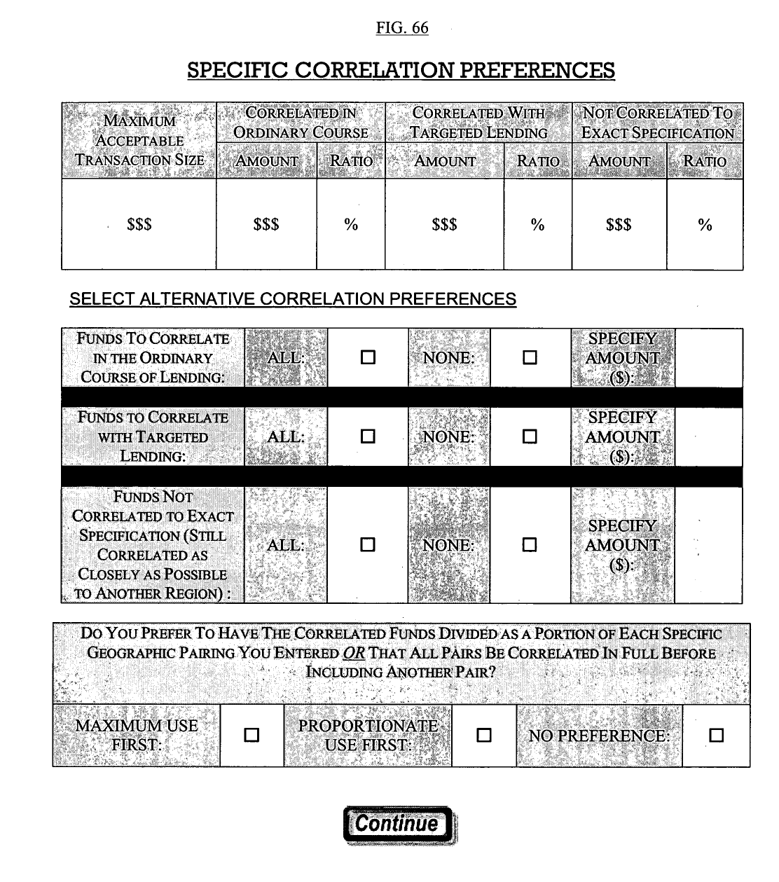

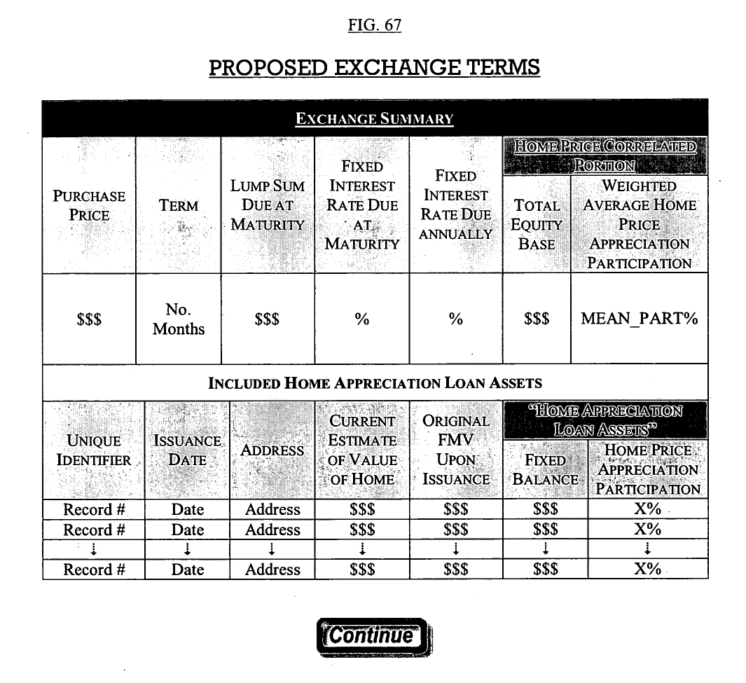

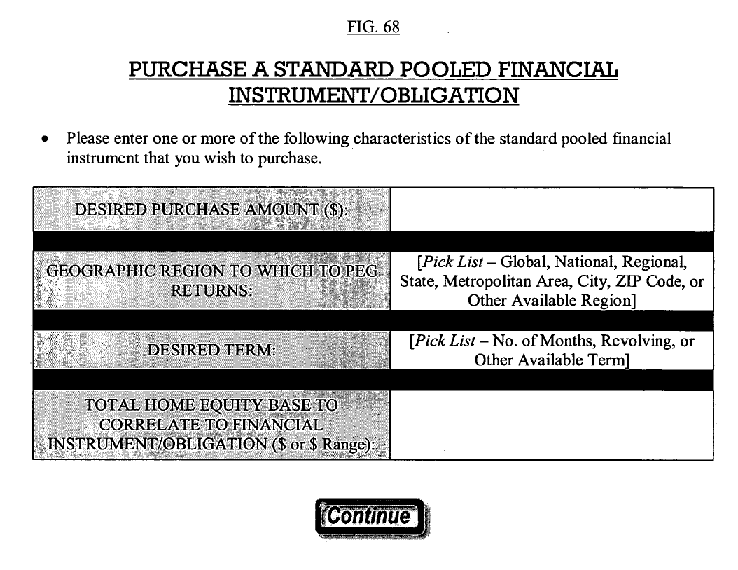

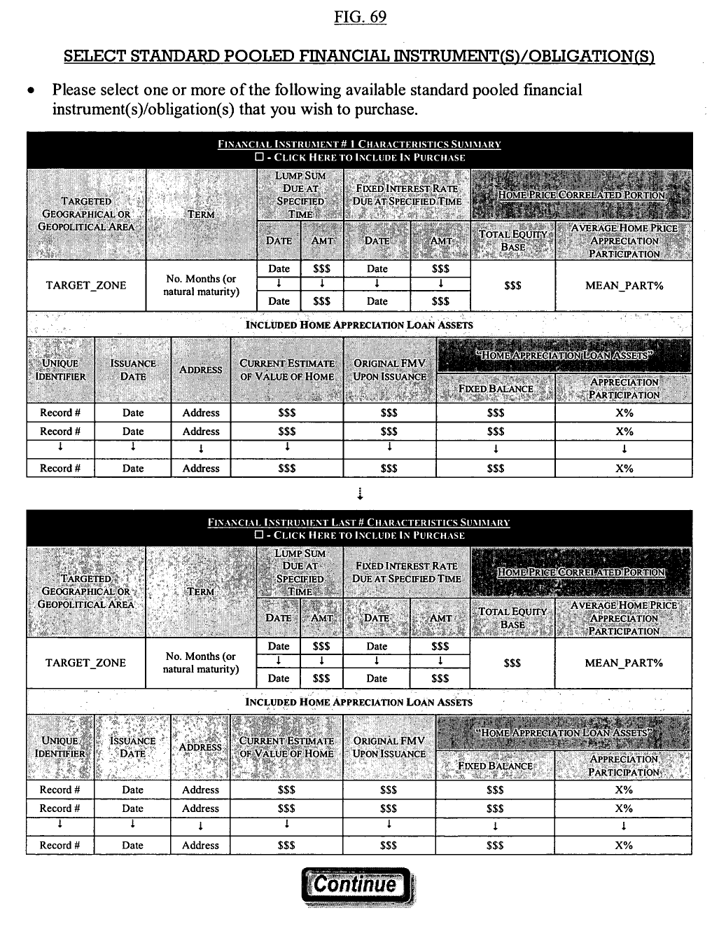

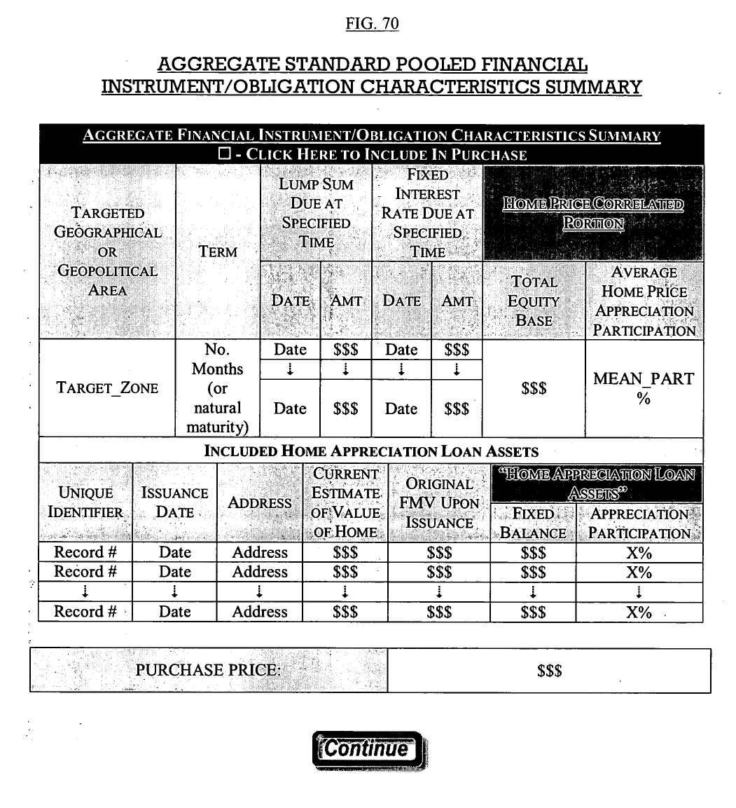

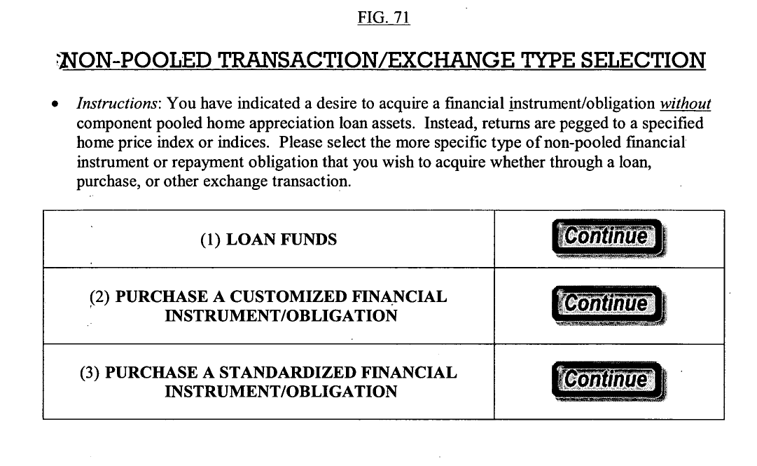

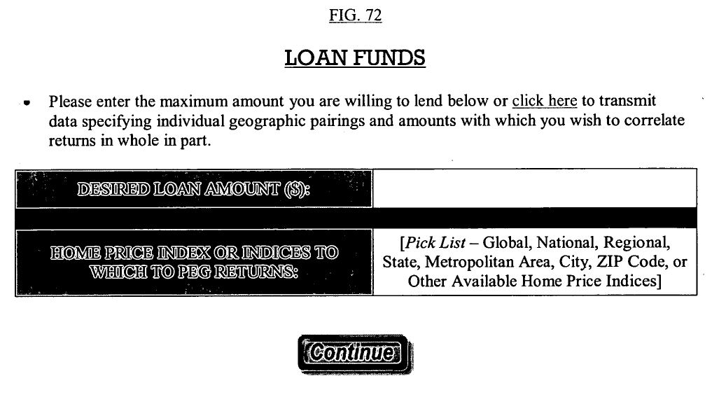

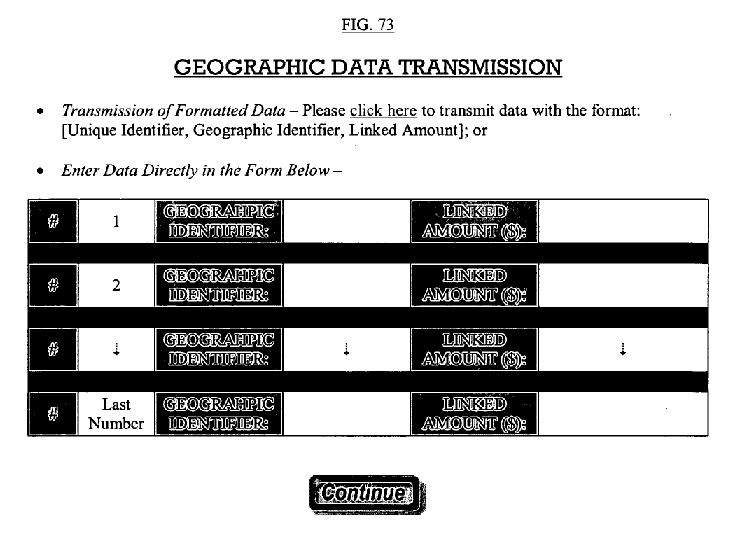

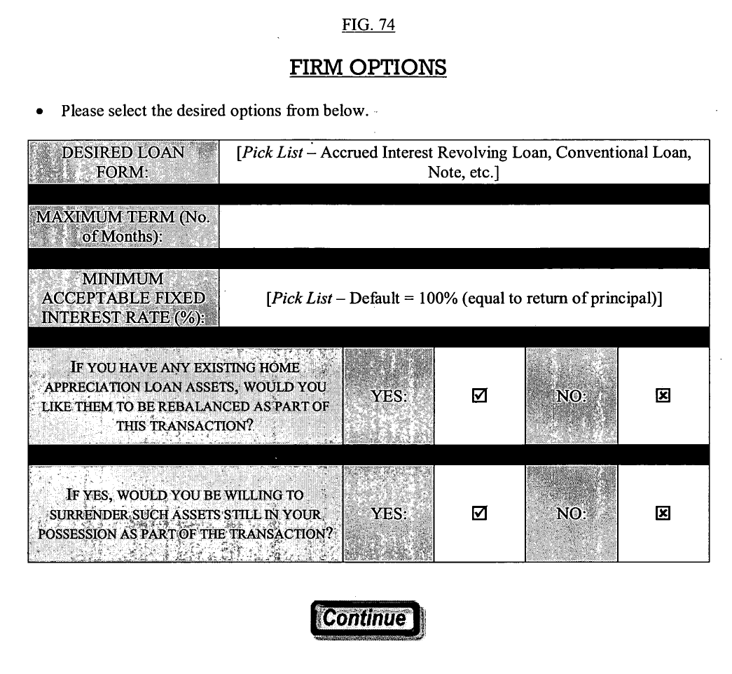

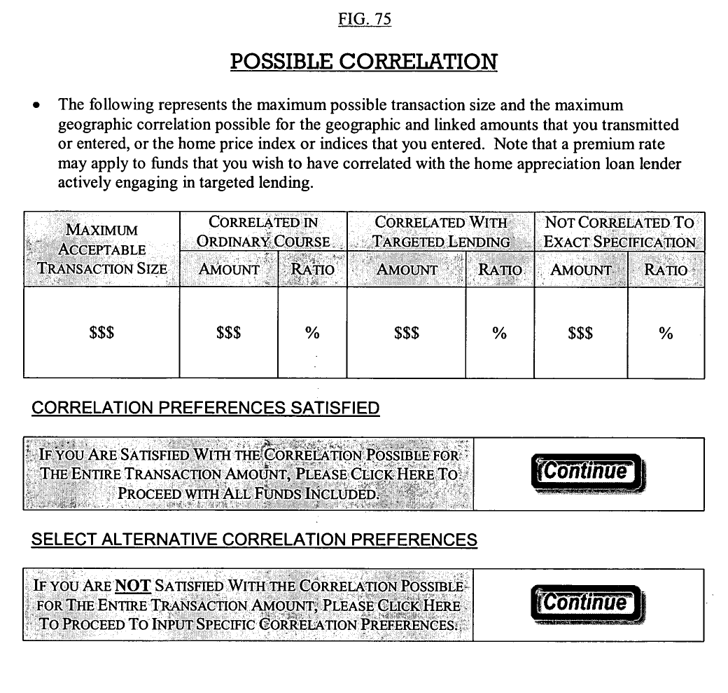

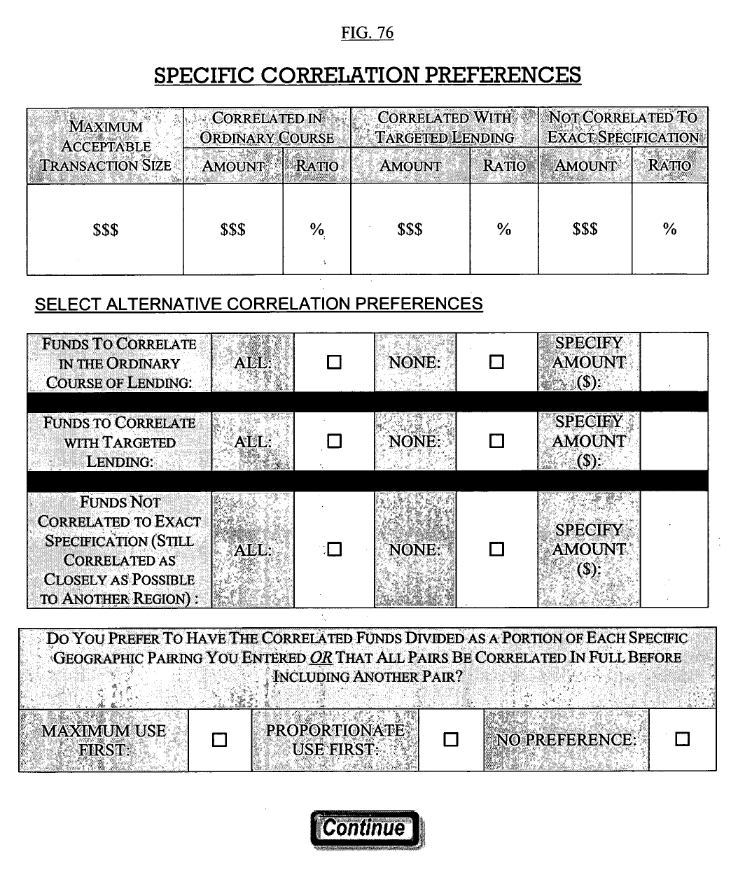

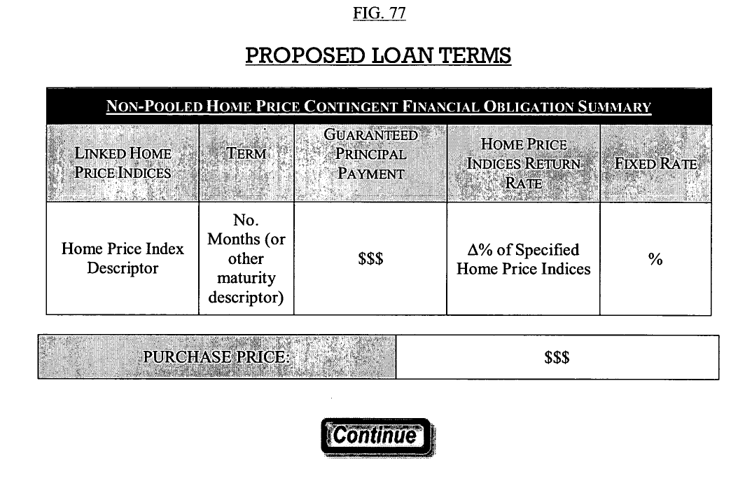

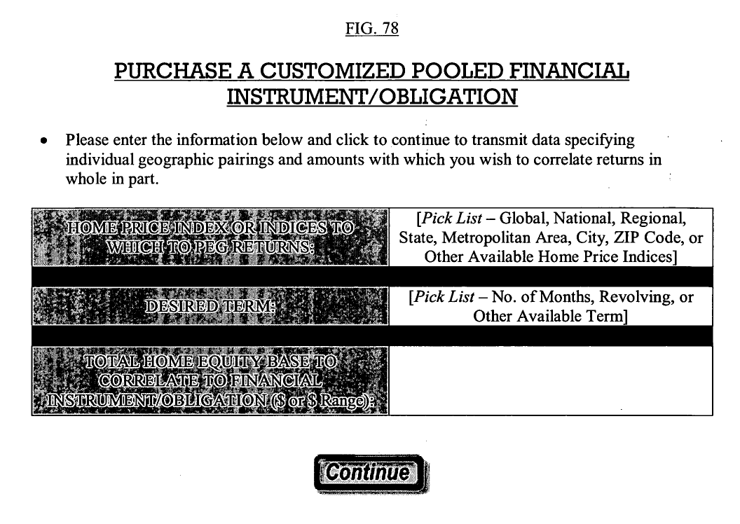

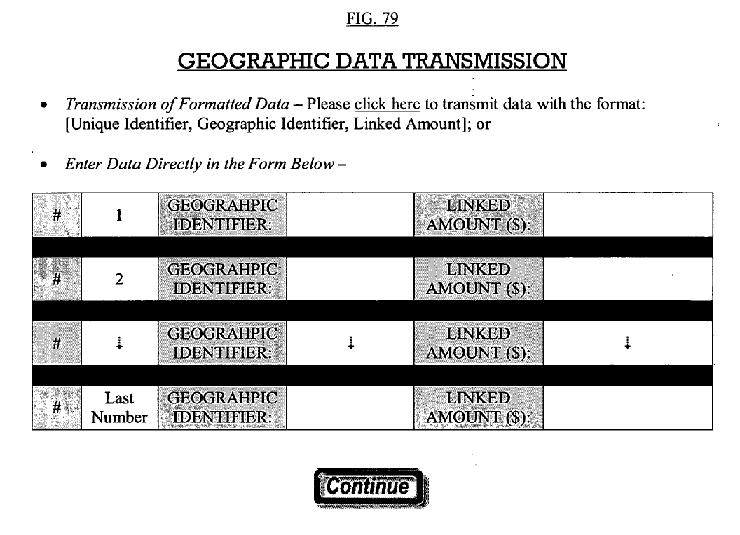

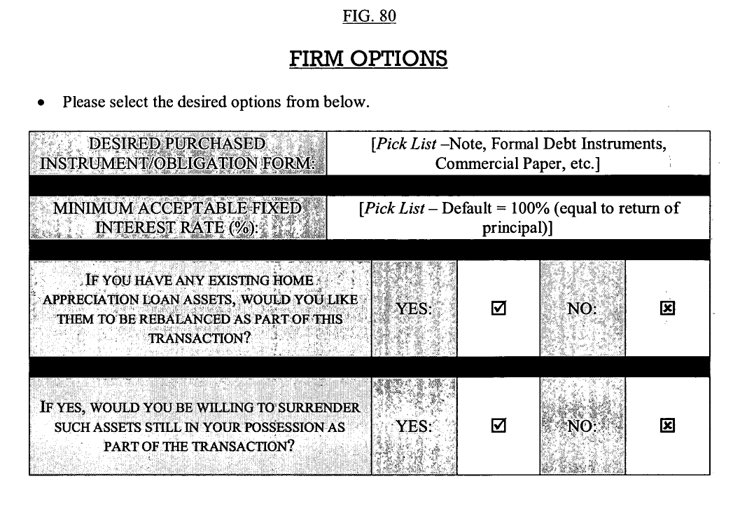

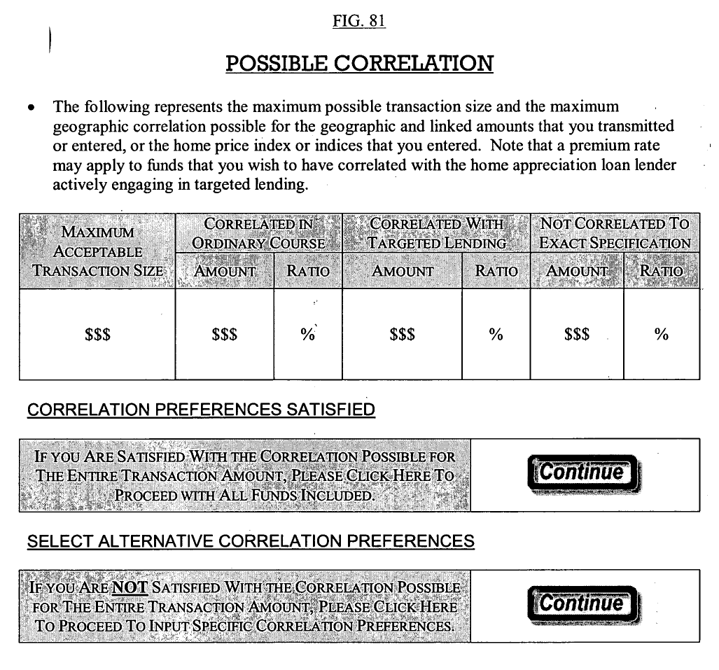

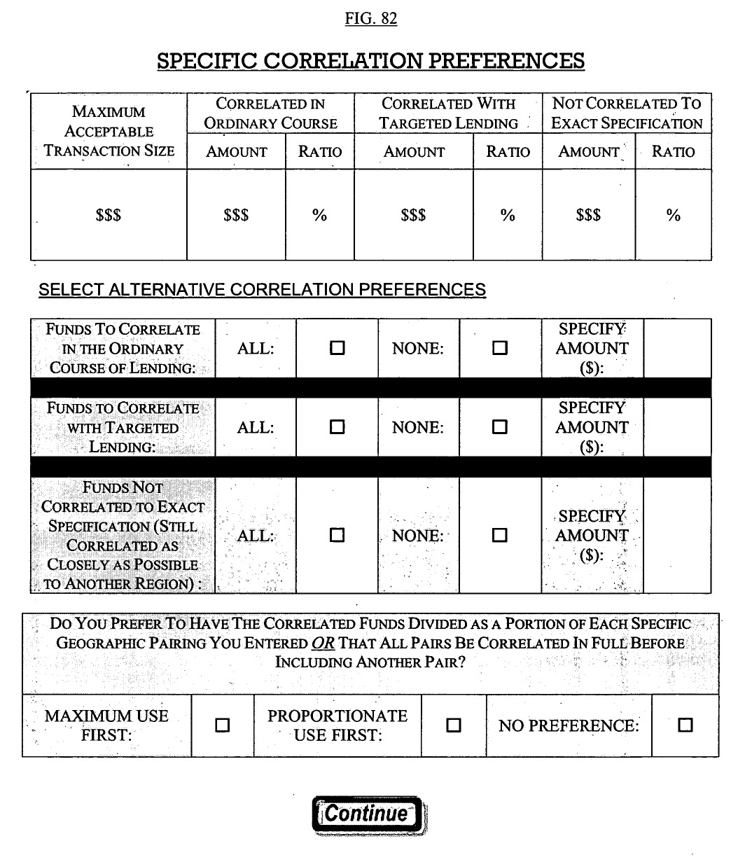

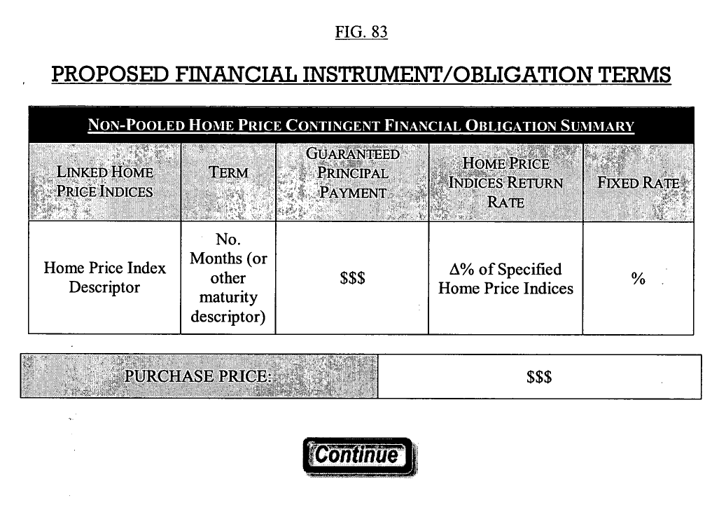

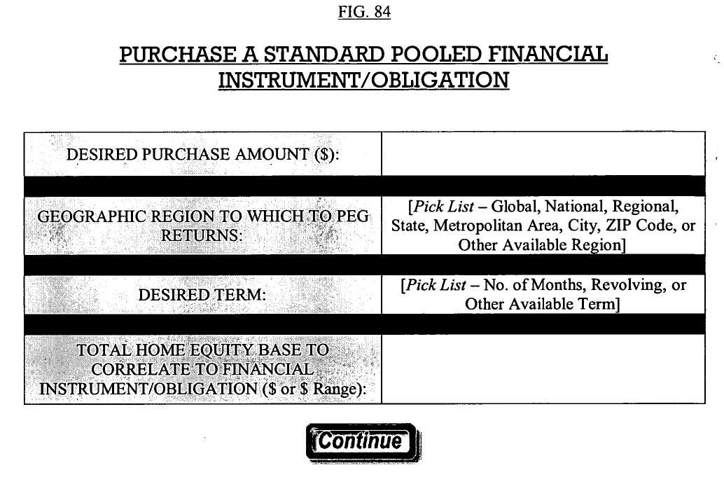

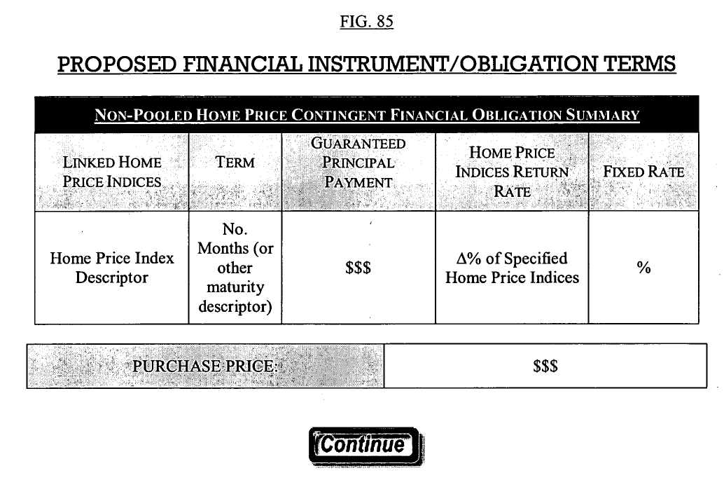

FIGS. 51 through 85 illustrate aspects of an example interface for a third party vendor/financial intermediary.

Preliminarily, we note the following meanings of phrases used later:

Geographical Pegging—The word geographical (or similar terms) refer to a broad notion of pegging investment returns to identifiable geographical, social, cultural, geopolitical, or other ascertainable subdivisions.

Loan, Debt, Debt-like Instrument, Security, Derivative, and other Financial Terms—Such terms are used with reference to a broad notion of a financial obligation, transaction, or exchange. Where a single financial instrument or set of financial instruments are named, it is meant to signify the larger set of all possible existing financial instrument forms. In order to be clear and concise, not all such intended and claimed forms are listed in all places, but the alternate variations are nonetheless within the scope of the claims.

Method of Provision—The techniques for implementing, bundling, or securitizing a loan described below use electronic data records and databases, computer processing and calculation devices, and various other mechanical or electronic tools. The examples presented, are merely illustrative. The claims are not limited to implementation, bundling, or securitizing a home appreciation loan as part of an electronic data gathering or transmission process. The process of information exchange, storage, and maintenance could occur in person, via the telephone, through a referral network with or without transferred data files, by inputting data through a website, via direct computer entry, or through utilization of any other communicative distribution mechanism. Some implementations could be made using a wide variety of hardware, software, firmware, or combinations of them at various geographic locations and associated with various parties. The implementations could separate the processing and databases in a variety of ways both at a given location and between locations. The separated locations may be interconnected by one or more networks such as a local area network, a wide area network, or a publicly accessible network.

In the discussion below, we refer to the particular example of what we call a home appreciation loan that enables a homeowner to receive a lump sum payment in exchange for a guarantee (1) to repay a declining fixed balance, and (2) to pay the lender a certain percentage of the appreciation in the home price upon sale (or the occurrence of another contractually-specified termination event). The borrower makes no payments during the term of the loan. Upon sale of the underlying home (or the occurrence of another contractually-specified termination event), the loan is repaid, including any outstanding declining fixed balance and a percentage of appreciation in the price of the home. During the loan term, the lender may choose to obligate itself to reimburse the borrower for a percentage of all qualified home maintenance, improvement, or selling expenses up to the level of its economic stake in the home. The borrower grants the lender a lien against the property. The borrower also grants the lender certain information-updating privileges. The terms of the contract are adjusted to accommodate the borrower's election of whether to guarantee to insure the lender's economic interest and/or grant the lender a transferable right of first refusal.

Alternatives—The home appreciation loan terms could be simply modified to also pay the lump-sum in an equivalent value regular or irregular stream of payments. Similarly, the home appreciation loan could be issued in the form of a line-of-credit or closed end line-of-credit. All such alternatives (among all other consistent with the basic spirit of the invention) are within the scope of the claims.

As mentioned above, the applications of the techniques are not limited to home-based financing, but could be extended to other real estate financing transactions such as financing commercial real estate or undeveloped land and to transactions involving other kinds of appreciating assets such as artwork or jewelry.

Implementing a Home Appreciation Loan 10000 (in FIG. 1). See FIG. 29 also.

Process Overview (illustrated in FIG. 2)

I. INPUT #1: Borrower 22 Inputs Basic Personal and Home Data 2000 (FIG. 6)

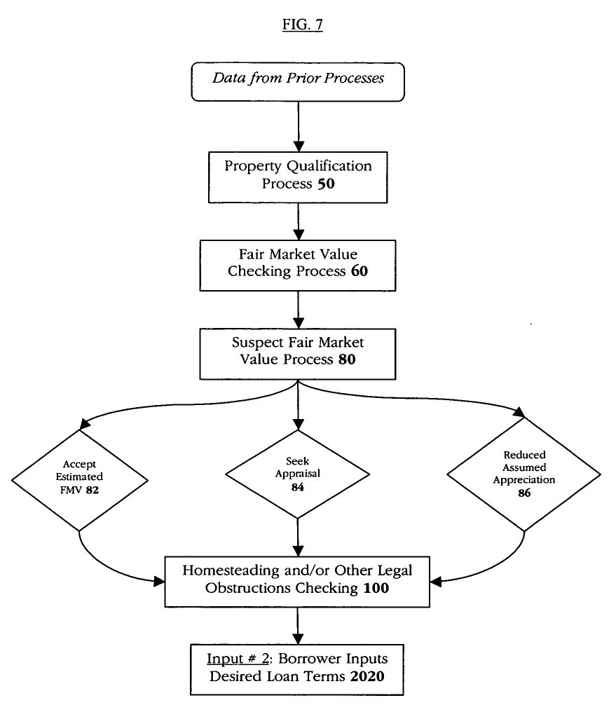

II. PROCESS #1: Property Qualification, Fair Market Value (FMV) Checking, Suspect FMV Evaluation Process, and Homesteading and/or Other Legal Obstructions Checking Processes 2010 (FIG. 7)

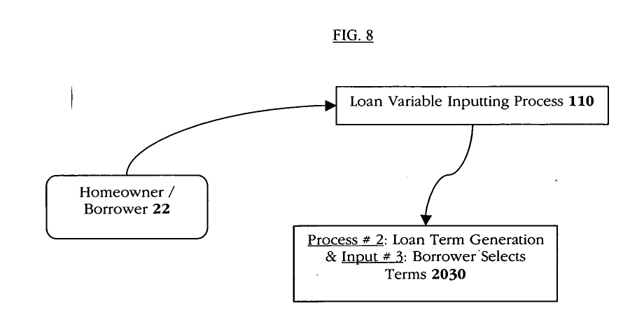

III. INPUT #2: Borrower Inputs Desired Loan Terms 2020 (FIG. 8)

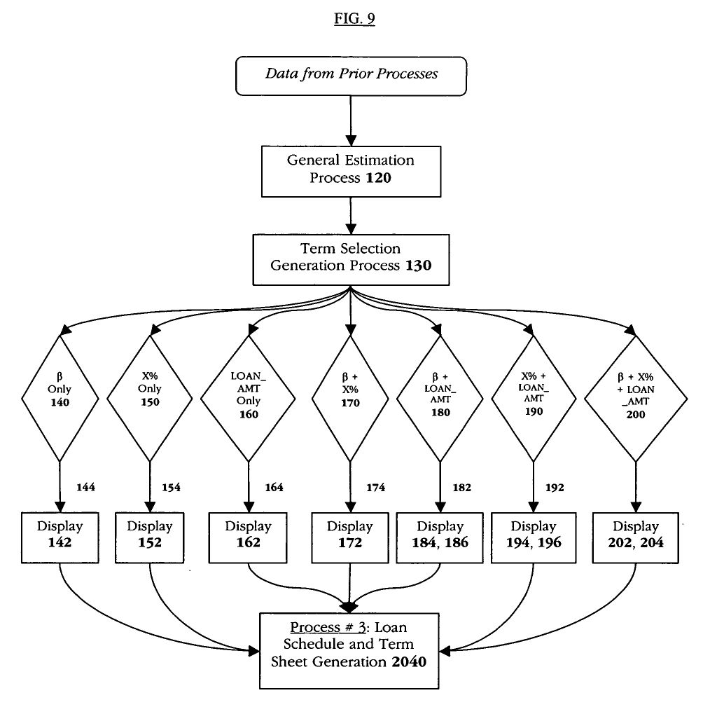

IV. PROCESS #2: Loan Term Variations Generation Process & INPUT #3: Borrower Selects Desired Available Loan Term Variation 2030 (FIG. 9)

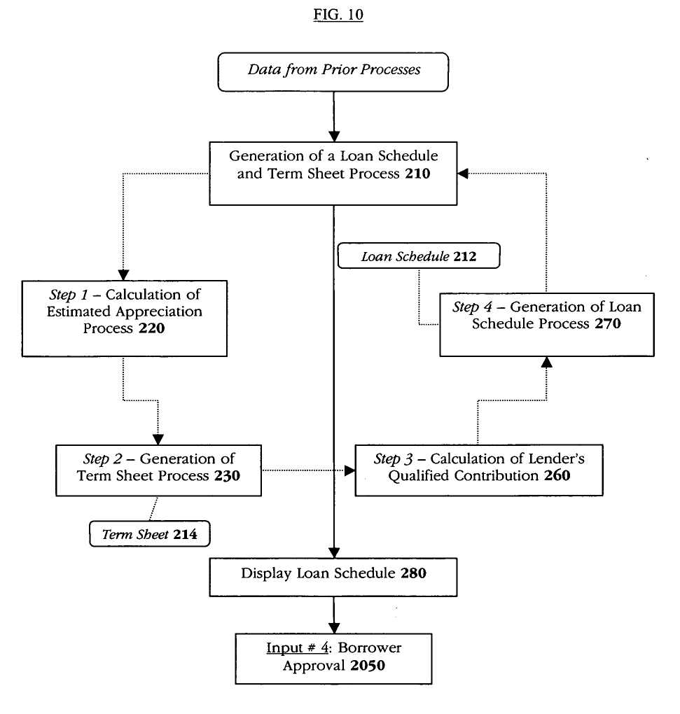

V. PROCESS #3: Loan Schedule and Tern Sheet Generation Process 2040 (FIG. 10)

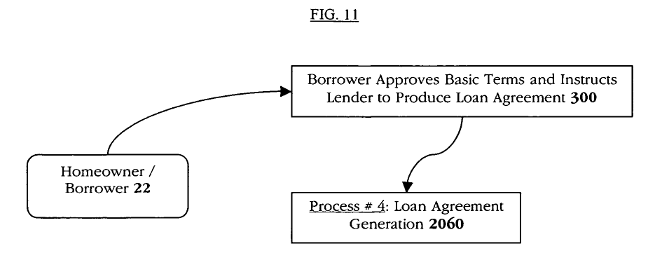

VI. INPUT #4: Borrower Approves Basic Terms and Instructs Lender 52 to Produce Loan Agreement 2050 (FIG. 11)

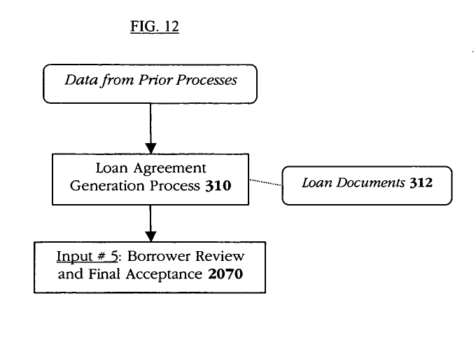

VII. PROCESS #4: Loan Agreement Generation Process 2060 (FIG. 12)

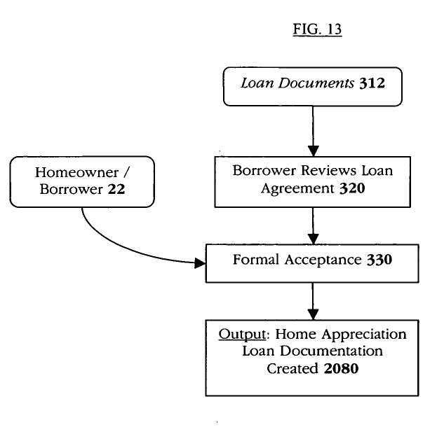

VIII. INPUT #5: Borrower Reviews Loan Agreement and Formally Accepts Loan Offer 2070 (FIG. 13)

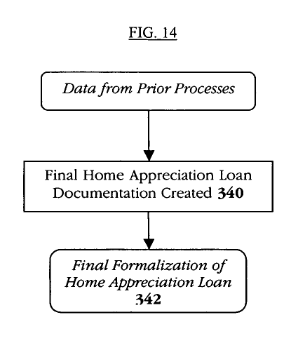

IX. OUTPUT: Home Appreciation Loan Documentation Created 2080 (FIG. 14)

Definition of Inputs, Outputs, and Other Variables

ACCEPTED_FMV=Fair market value of home accepted for use in loan term calculations.

ADDRESS=Address of borrower's home.

AMT_DUE=Amount due to the lender upon sale, transfer, or occurrence of other terminal event.

APP_RATE_PREDICTED=Estimated rate of appreciation.

β=Number of months after loan granted until fixed repayment balance [FIXED_BALANCE] equals $0. After β months, the outstanding fixed repayment balance is $0 and the lender is only entitled to X % of the home price appreciation.

BIO=A database entry containing biographical information such as a name, social security number, property description (single family, etc.) and/or other identifying information.

CREDIT_HIST=Credit information or credit score.

CURRENT_EST_FMV=Estimate of current FMV based on statistical, actuarial, demographic, and other accurate forms of price analysis, as of day of testing subsequent to loan grant.

DEV_FMV=Deviation of borrower's inputted FMV [INPUT_FMV] from the mathematically estimated FMV [EST FMV].

EST_FMV=Estimate of current FMV based on statistical, actuarial, demographic, and other accurate forms of price analysis, on the day of the loan application.

EXPECTED_APPRECIATION=Nominal amount of predicted home price appreciation.

FIXED_BALANCE=Portion of repayment that is predetermined and set forth in the loan schedule.

HOME_DEBT=Amount of existing debt of an equal or superior claim to the prospective home appreciation loan.

HOME_EQUITY=Amount of existing home equity.

HOME_STEAD=Flag for state with homesteading laws and/or other legal obstructions.

INPUT_FMV=Borrower's inputted fair market value of the home.

INTEREST=Portion of repayment equal to X % of the home's appreciation since the loan was made; equal to the sale price [SALE_PRICE] less the accepted FMV when the loan was granted [ACCEPTED_FMV].

LOAN_AMT=Nominal value of home appreciation loan granted.

LOAN_DATE=Date upon which the home appreciation loan was issued.

MIN_ACCEPT_TRANS=Nominal value of smallest acceptable transaction size as specified by the lender.

MONTH=Number of months following the grant of the home appreciation loan.

PROB_OVERSTATEMENT=Probability that borrower's inputted FMV is overstated.

PROB_THRESHOLD=Maximum value of probability of overstatement [PROB_OVERSTATEMENT] at which the lender will still offer loan.

REPAYMENT_AMT=Amount of repayment to lender upon sale of the home, which is equal to the outstanding declining fixed balance [FIXED_BALANCE] plus the interest [INTEREST].

SALE_PRICE=Nominal sale price of home subject to the home appreciation loan.

X %=Percentage of home price appreciation shared by the lender.

Φ %=Percentage of“Qualified Maintenance, Improvement, or Selling Expenses” that will be reimbursed by the lender to the borrower upon submission; a function of the lender's economic stake in the home.

We now discuss the elements of the process in more detail.

Input #1 (FIG. 6)

I. Borrower Data Inputting Process 20 (in FIG. 6)

i. The borrower 22 submits basic data concerning: (1) name, social security number, property description (single family, etc.), and other biographical data [BIO 24]; (2) credit history [CREDIT_HIST 26]; (3) home address [ADDRESS 28]; and (4) current amount of home debt [HOME_DEBT] or home equity [HOME_EQUITY 32]. If home debt is entered then HOME_EQUITY is calculated as a function of ACCEPTED_FMV where HOME_EQUITY=ACCEPTED_FMV minus HOME_DEBT.

ii. The borrower may also choose to enter: (5) an estimate of the current fair market value of his or her home (or allow the computer to estimate the value [EST_FMV=function (ADDRESS, HOME_DEBT, HOME_EQUITY)], and then be given an opportunity to agree, or disagree and enter his or her own estimation). The result is either an inputted FMV [INPUT_FMV 40] or if the default is accepted then an accepted FMV [ACCEPTED_FMV].

Process #1 (FIG. 7)

I. Property Qualification Process 50

i. Purpose—The home appreciation lender 52 may choose to restrict home appreciation loan origination/lending to particular types of homes.

ii. Qualification Process—The data inputted by the borrowers describing the underlying home [part of BIO] is compared with the list of qualifying properties as specified by the home appreciation lender. If the property qualifies then “Fair Market Checking Process” commences. Otherwise, the borrower is notified as to the unavailability of the home appreciation loan for the particular type of property described.

II. Fair Market Value Checking Process 60

i. Purpose—The borrower will have a dual incentive to overstate the FMV of his or her home. First, an overstatement of the current FMV will result in the appearance of lower appreciation than actually occurs during the loan period. This will reduce the lender's return while increasing the borrower's share of the true appreciation. Second, the amount of the loan is capped by a certain percentage of existing home equity. Overstating the current FMV effectively overstates the existing home equity and thus allows for a larger loan amount than otherwise permissible.

ii. FMV Checking Mechanism

1. A calculation is performed to generate an Estimated FMV [EST_FMV] as a function of the address entered by the borrower.

EST_FMV=function (ADDRESS, other inputs)

2. A calculation is performed to determine if the borrower's inputted FMV [INPUT_FMV] is greater than the estimated FMV [EST_FMV].

If INPUT_FMV>EST_FMV Then FMV Checking Process Continues.

If INPUT_FMV≦EST_FMV Then ACCEPTED_FMV=INPUT_FMV and the FMV Checking Process terminates.

3. The deviation between the inputted FMV and the estimated FMV is calculated.

DEV_FMV=INPUT_FMV−EST_FMV

4. The probability that the borrower has overstated the current FMV of the home is then calculated using the borrower's inputted data and other metrics, including the (i) ADDRESS, (ii) INPUT_FMV, (iii) EST_FMV, (iv) DEV_FMV, (v) CREDIT_HISTORY, (vi) HOME_DEBT, and (vii) HOME_EQUITY.

PROB_OVERSTATEMENT=function (ADDRESS, INPUT_FMV, EST_FMV, DEV_FMV, CREDIT_HISTORY, HOME_DEBT, HOME_EQUITY)

5. If the probability of overstatement [PROB_OVERSTATMENT] exceeds a certain threshold [PROB_THRESHOLD] then the borrower may be asked to input more data and another probability function is used and a new probability is calculated. If not, then the FMV Checking Process terminates and ACCEPTED_FMV is set equal to INPUT_FMV.

6. If the probability of overstatement continues to exceed the threshold after all data has been entered then the borrower proceeds to the “Suspect FMV Process” described in the next section.

7. If the ACCEPTED_FMV has been set and the FMV Checking Process terminated automatically then the “Selection Generation Process” commences as described below.

III. Suspect FMV Process 80

i. Stage in Process—The borrower has inputted an FMV that has been flagged as suspect because it exceeds the estimated FMV by such an amount so as to pose a probability of overstatement higher than the threshold probability set by the lender. Additional data was entered by the borrower, but the suspect flag was not removed.

ii. Options—The borrower is then presented with three options:

(1) Accept the Estimated FMV 82—The borrower is presented with an opportunity to accept the estimated FMV [EST_FMV] as the accepted FMV [ACCEPTED_FMV] for purposes of the loan.

(2) Appraisal 84—The borrower is presented with an opportunity to employ a certified appraiser approved by the lender. The borrower pays the appraisal fee. The appraisal fee is reimbursed if (a) the actual FMV equals or exceeds the inputted FMV, and (b) the borrower accepts a home appreciation loan from the lender based upon the actual FMV as appraised. A loan may be offered at the appraised value even if that value proves to be less than the inputted FMV, but no part of the appraisal fee is reimbursed. Regardless, ACCEPTED_FMV is set at the appraised value of the home.

(3) Reduced Appreciation Assumption 86—If the borrower refuses options 1 and 2, and still firmly believes that his or her inputted FMV is correct then he or she is offered the opportunity to continue with the process with an expected home appreciation rate [APP_RATE_PREDICTED] decreased to accommodate the risk of overstatement. The ACCEPTED_FMV is set equal to INPUT_FMV.

If no adjustment is necessary then APP_RATE_PREDICTED=function (ADDRESS, other inputs).

If an adjustment is necessary then APP_RATE_PREDICTED=function (APP_RATE_PREDICTED, PROB_OVERSTATEMENT, ADDRESS, other inputs).

IV. Homesteading and/or Other Legal Obstruction Checking Process 100

i. Homesteading Laws and Other Legal Obstructions—Particular states may have laws, including homesteading laws, which would make the lender's ability to collect upon default more difficult. To account for this, a variable called HOME_STEAD is formulated as a function of ADDRESS. HOME_STEAD is included among other inputs in the calculation of the offered loan terms.

HOME_STEAD=function (ADDRESS).

Potential other legal obstructions that would be flagged for recordation and additional processing and/or factored into pricing calculations below include (among others) usury limits, mandatory loan waiting periods, or mandatory loan cancellation periods. These obstructions are similarly treated as a function of ADDRESS.

Input #2 (FIG. 8)

I. Loan Variable Inputting Process 110 (in FIG. 8)

i. Stage in Process—At this point, the borrower has entered all background data concerning himself or herself, the home, and the current obligations thereon. Process #1 was run to verify the borrower's inputted FMV, replace that value with an estimated FMV, or accept the borrower's inputted FMV with an appropriately reduced appreciation rate (for use in Process #2). Now the borrower must input the desired loan variables.

ii. The borrower must enter at least one of the following (but may enter any combination thereof):

(A) The number of months until the fixed principal repayment balance equals $0 [β 112].

(B) The percentage of appreciation that will be shared by the lender [X % 114].

(C) The desired loan amount (LOAN_AMT 116).

Process #2 & Input #3 (2030 on FIG. 2)

I. General Estimation Process 120

i. Prediction of Appreciation Rate—An estimated rate of future appreciation [APP_RATE_PREDICTED] is calculated for the home as a function of the home's address, the other data inputs, and calculated derivations thereof.

APP_RATE_PREDICTED=function (ADDRESS, other inputs).

II. Term Selection Generation Process 130 (in FIG. 9)

i. Overview—Depending on which of the three variables (β, X %, LOAN_AMT) the borrower entered, one of seven selection generation processes begin to run on the computer. The variations include an input of:

(1) β

(2) X %

(3) LOAN_AMT

(4) β+X %

(5) β+LOAN_AMT

(6) X %+LOAN_AMT

(7) β+X %+LOAN_AMT

ii. Process—For each scenario, a computer executes a process as described below.

III. “β” Only Process 140

i. Input—The borrower has chosen to enter only the number of months until the fixed principal repayment balance equals $0 [β].

ii. Generation of Available Loan Terms—All combinations of the possible percentage of share appreciation [X %] and loan amounts [LOAN_AMT] are calculated as a function of the: (a) Accepted FMV [ACCEPTED_FMV]; (b) Number of months until the fixed principal repayment balance equals $0 [β]; (c) Predicted appreciation rate [APP_RATE_PREDICTED]; (d) credit history [CREDIT_HIST]; and (e) All other relevant data inputs collected earlier in the process.

iii. Display of Available Terms—All, or a sub-sample, of the available percentage of share appreciation [X %] and loan amount [LOAN_AMT] term are displayed 142 for the borrower. For example, the output might look as follows:

| PERCENTAGE OF | | |
|---|---|---|
| SHARED | | SELECT DESIRED TERMS |
| APPRECIATION | LOAN AMOUNT | [LINK TO TERM SHEET |
| [X %] | [LOAN_AMT] | AND LOAN SCHEDULE] |
| 1% | $$$ | [symbol] |
| 2% | $$$ | [symbol] |
| 3% | $$$ | [symbol] |
| ↓ | ↓ | ↓ |
| Max. X % | $$$ | [symbol] |

iv. Direction—Process #3 then commences. The borrower can always come back and reselect an available option.

v. Other Processes—Some of the possible combinations of X % and LOAN_AMT will not be offered to the borrower and not displayed. A set of processes 144 using the inputs from above, cost estimates, risk metrics, historical maturities, and minimum profitability metrics will be run to determine which loan options to offer and display.

IV. “X %” Only Process 150

i. Input—The borrower has chosen to enter only the percentage of appreciation that will be shared by the lender [X %].

ii. Generation of Available Loan Terms—All combinations of the number of months until the fixed principal repayment balance equals $0 [β] and loan amounts [LOAN_AMT] are calculated as a function of the: (a) Accepted FMV [ACCEPTED_FMV]; (b) Percentage of appreciation that will be shared by the lender [X %]; (c) Predicted appreciation rate [APP_RATE_PREDICTED]; (d) credit history [CREDIT_HIST]; and (e) All other relevant data inputs collected earlier in the process.

iii. Display of Available Terms—All, or a sub-sample, of the available number of months until the fixed principal payment balance equals $0 [β] and loan amount [LOAN_AMT] term are displayed 152 for the borrower. For example, the output might look as follows:

| NO. MONTHS | | |
|---|---|---|
| BEFORE FIXED | | |
| REPAYMENT | | SELECT DESIRED TERMS |
| EQUALS $0 | LOAN AMOUNT | [LINK TO TERM SHEET |
| [β] | [LOAN_AMT] | AND LOAN SCHEDULE] |
| 1 | $$$ | [symbol] |
| 2 | $$$ | [symbol] |
| 3 | $$$ | [symbol] |
| ↓ | ↓ | ↓ |
| Max. β | $$$ | [symbol] |

iv. Direction—Process #3 then commences. The borrower can always come back and reselect an available option.

v. Other Processes—Some of the possible combinations of β and LOAN_AMT will not be offered to the borrower and not displayed. A set of processes 154 using the inputs from above, cost estimates, risk metrics, historical maturities, and minimum profitability metrics will be run to determine which loan options to offer and display.

V. “LOAN_AMT” Only Process 160

i. Input—The borrower has chosen to enter only the desired loan amount (LOAN_AMT).

ii. Generation of Available Loan Terms—All combinations of the possible percentage of shared appreciation [X %] and the number of months until the fixed principal repayment balance equals $0 [β] are calculated as a function of the: (a) Accepted FMV [ACCEPTED_FMV]; (b) Loan amount [LOAN_AMT]; (c) Predicted appreciation rate [APP_RATE_PREDICTED]; (d) credit history [CREDIT_HIST]; and (e) All other relevant data inputs collected earlier in the process.

iii. Display of Available Terms—All, or a sub-sample, of the available percentage of shared appreciation [X %] and the number of months until the fixed principal payment balance equals $0 [β] are displayed 162 for the borrower. For example, the output might look as follows:

| | NO. | |
|---|---|---|
| | MONTHS BEFORE | SELECT DESIRED |
| PERCENTAGE | FIXED REPAYMENT | TERMS [LINK TO |
| OF SHARED | EQUALS $0 | TERM SHEET AND |
| APPRECIATION [X %] | [β] | LOAN SCHEDULE] |
| 1% | 30 | [symbol] |
| 2% | 29 | [symbol] |
| 3% | 28 | [symbol] |
| ↓ | ↓ | ↓ |
| Max. X % | Min. β | [symbol] |

iv. Direction—Process #3 then commences. The borrower can always come back and reselect an available option.

v. Other Processes—Some of the possible combinations of X % and β will not be offered to the borrower and not displayed. A set of processes 164 using the inputs from above, cost estimates, risk metrics, historical maturities, and minimum profitability metrics will be run to determine which loan options to offer and display.

VI. “β+X %” Process 170

i. Input—The borrower has chosen to enter both (1) the number of months until the fixed principal repayment balance equals $0 [β]; and (2) the percentage of appreciation that will be shared by the lender [X %].

ii. Generation of Available Loan Terms—The maximum available loan amount [LOAN_AMT] is then calculated as a function of the: (a) Accepted FMV [ACCEPTED_FMV]; (b) Number of months until the fixed principal repayment balance equals $0 [β]; (c) Percentage of appreciation that will be shared by the lender [X %]; (d) Predicted appreciation rate [APP_RATE_PREDICTED]; (e) credit history [CREDIT_HIST]; and (f) All other relevant data inputs collected earlier in the process.

iii. Display of Available Terms—The maximum loan amount [LOAN_AMT] is then displayed 172 for the borrower with the option to proceed to the next processing stage, or return an entered different loan terms. For example, the output might look as follows:

| | SELECT |
|---|---|
| | DESIRED TERMS [LINK TO TERM |
| MAXIMUM LOAN AMOUNT | SHEET AND LOAN SCHEDULE] |
| LOAN_AMT | [symbol] |

iv. Direction—Process #3 then commences. The borrower can always come back and reselect an available option.

v. Other Processes—The borrower may have entered a β and X % combination that results in a maximum loan amount of $0. In such a case, they will be returned to the term input stage and asked to input a different combination. A set of processes 174 is run to check for a positive loan, using the inputs from above, cost estimates, risk metrics, historical maturities, and minimum profitability metrics will be run to determine which loan options to offer and display.

VII. “β+LOAN_AMT” Process 180

i. Input—The borrower has chosen to enter both (1) the number of months until the fixed principal repayment balance equals $0 [β]; and (2) the desired loan amount (LOAN_AMT).

ii. Generation of Available Loan Terms—The necessary percentage of appreciation that must be shared by the lender [X %] is then calculated as a function of the: (a) Accepted FMV [ACCEPTED_FMV]; (b) Number of months until the fixed principal repayment balance equals $0 [β]; (c) Loan amount [LOAN_AMT]; (d) Predicted appreciation rate [APP_RATE_PREDICTED]; (e) credit history [CREDIT_HIST]; and (f) All other relevant data inputs collected earlier in the process.

iii. Display of Available Terms—As long as the loan can be offered with an X % acceptable to the lender (tested through a separate process 182), the requisite percentage of appreciation that must be shared by the lend [X %] is then displayed 184 for the borrower with the option to proceed to the next processing stage, or return an entered different loan terms. For example, the output might look as follows:

| NECESSARY | SELECT |
|---|---|
| PERCENTAGE OF SHARED | DESIRED TERMS [LINK TO TERM |
| APPRECIATION | SHEET AND LOAN SCHEDULE] |
| X % | [symbol] |

iv. Direction—Process #3 then commences. The borrower can always come back and reselect an available option.

v. Other Processes—The borrower may have entered a β and LOAN_AMT combination that results in an X % exceeding the maximum set by the lender (tested through a separate process as noted above). In such a case, the borrower will be returned to the term input stage and asked to input a different combination. A set of processes is run to check for an acceptable X %, using the inputs from above, cost estimates, risk metrics, historical maturities, and minimum profitability metrics will be run to determine which loan options to offer and display 186.

VIII.“X %+LOAN_AMT∞ Process 190

i. Input—The borrower has chosen to enter both (1) the percentage of appreciation that will be shared by the lender [X %]; and (2) the desired loan amount (LOAN_AMT).

ii. Generation of Available Loan Terms—The number of months until the fixed principal repayment balance equals $0 [β] is then calculated as a function of the: (a) Accepted FMV [ACCEPTED_FMV]; (b) Percentage of appreciation shared by the lender [X %]; (c) Loan amount [LOAN_AMT]; (d) Predicted appreciation rate [APP_RATE_PREDICTED]; (e) credit history [CREDIT_HIST]; and (f) All other relevant data inputs collected earlier in the process.

iii. Display of Available Terms—As long as the loan can be offered with a β acceptable to the lender (tested through a separate process 192), the number of months until the fixed principal repayment balance equals $0 [β] is then displayed 194 for the borrower with the option to proceed to the next processing stage, or return an entered different loan terms. For example, the output might look as follows:

| | SELECT DESIRED |
|---|---|
| NO. MONTHS BEFORE | TERMS [LINK TO TERM SHEET |
| FIXED REPAYMENT EQUALS $0 | AND LOAN SCHEDULE] |
| β | [symbol] |

iv. Direction—Process #3 then commences. The borrower can always come back and reselect an available option.

v. Other Processes—The borrower may have entered an X % and LOAN_AMT combination that results in a β exceeding the maximum set by the lender (tested through a separate process as noted above). In such a case, the borrower will be returned to the term input stage and asked to input a different combination. A set of processes 196 is run to check for an acceptable β, using the inputs from above, cost estimates, risk metrics, historical maturities, and minimum profitability metrics will be run to determine which loan options to offer and display.

IX. “β+X %+LOAN_AMT” Process 200

i. Input—The borrower has chosen to input all possible data, including (1) the number of months until the fixed principal repayment balance equals $0 [β]; (2) the percentage of appreciation that will be shared by the lender [X %]; and (3) the desired loan amount (LOAN_AMT).

ii. Check for Available Loan Terms—The borrower's inputs are run through a set of processes 202 to check that the loan on such terms is acceptable to the lender, using the inputs from above, cost estimates, risk metrics, historical maturities, and minimum profitability metrics.

iii. Inform of Loan Availability or Request Input of Different Terms—If the inputs result in a loan with terms acceptable to the lender (tested through a separate process), the borrower is informed 204 of the availability of the loan and asked to proceed to the next stage. If not, the borrower is returned to the input stage and asked to input different data. For example, the output might look as follows:

| | SELECT TO PROCEED |
|---|---|
| | WITH YOUR DESIRED |
| | TERMS [LINK TO TERM SHEET |
| LOAN AVAILABILITY | AND LOAN SCHEDULE] |
| CONGRATULATIONS! | [symbol] |
| A LOAN IS AVAILABLE | |
| WITH YOUR DESIRED TERMS. | |

iv. Direction—Process #3 then commences. The borrower can always come back and reselect an available option.

Process #3 (2040 on FIG. 2) See FIG. 10

I. Generation of a Loan Schedule and Term Sheet Process 210

i. Stage of the Process—The borrower has now inputted all data and generated a combination of: (1) the number of months until the fixed principal repayment balance equals $0 [β]; (2) the percentage of appreciation that will be shared by the lender [X %]; and (3) the desired loan amount (LOAN_AMT), that is acceptable to the lender. These data are then used to produce a loan schedule 212 and term sheet 214.

ii. Calculation of Estimated Appreciation Process 220—The amount of appreciation expected 218 for any time subsequent to the grant of the loan is calculated as a function of: (1) Months passed since loan granted [MONTH]; (2) Accepted FMV [ACCEPTED_FMV]; and (3) Predicted appreciation rate [APP_RATE_PREDICTED].

EXPECTED_APPRECIATION=function (MONTH, ACCEPTED_FMV, APP_RATE_PREDICTED).

Note that this process was referenced above to check loan term availability.

iii. Generation of Term Sheet Process 230—The borrower is presented with a list of all of the standard terms of the home appreciation loan, which could include:

(1) Potential Mandatory Terms—Certain terms must be included in all home appreciation loan agreements. These include:

a. Borrowers Right to Contribution towards “Qualified Maintenance, Improvement, or Selling Expenses”—Because the borrowers do not own 100% of the value of the home price appreciation, he or she will not have adequate economic incentives to invest to maintain, improve, or sell the home. The lender may choose to guarantee to reimburse the borrowers for “Qualified Maintenance, Improvement, or Selling Expenses” as specified in the contract up to a specified contribution percentage [Φ %] determined as a function of the lender's economic interest in the home at the time. See below for process to calculate Φ %.

b. Lien—The borrower agrees to grant the lender a lien on the home.

c. Information Updating Obligation—The borrower agrees to provide the lender with certain information at regular intervals, or upon change.

d. Anti-subordination Clause—The borrower agrees to incur no additional debt on the home that would be equal or superior in priority to the lender's claim, without the lender's express written consent.

e. Sale, Transfer, or Repayment Event—Upon occurrence of such a terminal event, the borrower agrees to pay the lender an amount [REPAYMENT_AMT] equal to (1) any fixed repayment of principal balance outstanding [FIXED_BALANCE (as defined below)], plus (2) interest equal to X % of the home's appreciation since the loan was made [INTEREST], which equal to the sale price [SALE_PRICE] less the accepted FMV when the loan was granted [ACCEPTED_FMV].

REPAYMENT_AMT=function (FIXED_BALANCE, SALE_PRICE, ACCEPTED_FMV).

(2) Potential Optional Terms

a. Insurance Coverage Guarantee (or compensating fee)—The borrower is given the option of (A) guaranteeing to insure the property each year for a value equal to the sum of the fixed repayment balance outstanding and X % of the estimated home appreciation (estimated via the same FMV process used above to calculate EST_FMV); or (B) not guaranteeing to insure this value and having the additional cost (a process is used to calculate the risk-based cost) to the lender incorporated in the calculations of β, X %, and/or LOAN_AMT.

b. Transferable Right of First Refusal (or compensating fee)—The borrower is given the option of (A) granting the lender a right of first refusal upon sale (to police low price sales) or (B) not granting a right of first refusal and having the additional cost (a process is used to calculate the risk-based cost) to the lender incorporated in the calculations of β, X %, and/or LOAN_AMT.

iv. Calculation of Lender's ¢Qualified Maintenance, Improvement, and Selling Expenses” Contribution 260—The lender may choose to include a term ensuring its contribution of a percentage of such costs equal to its economic stake in the home [Φ %]. Φ % is a function of the estimated current FMV when the claim is submitted [CURRENT_EST_FMV], the FMV accepted for loan calculations [ACCEPTED_FMV], the percentage of appreciation shared by the lender [X %], the loan amount [LOAN_AMT], and the appreciation expected when the loan was granted [EXPECTED_APPRECIATION].

“Qualified Maintenance, Improvement, and Selling Expenses” are contractually defined.

Φ %=function (CURRENT_EST_FMV, ACCEPTED_FMV, X %, LOAN_AMT, EXPECTED_APPRECIATION).

Φ %=[{LOAN_AMT−EXPECTED_APPRECIATION}+{(CURRENT_EST_FMV−ACCEPTED_FMV)×X %}]/CURRENT_EST_FMV.

v. Generation of Loan Schedule 270—A loan schedule is generated using the number of months since the loan was granted [MONTH] as a variable. The floating interest rate is equal to X % of actual home price appreciation that is observed when the home is sold, which also triggers repayment of the loan. The declining fixed balance that needs to be repaid is calculated as a function of the nominal loan amount [LOAN_AMT] and the expected amount of appreciation [EXPECTED_APPRECIATION].

FIXED_BALANCE=function (LOAN_AMT, EXPECTED_APPRECIATION).

vi. Display of Loan Schedule 280—The loan schedule is then displayed for the borrower. The following is one possible graphical form of the loan schedule:

| NO. | | |
|---|---|---|
| OF MONTHS | | |
| SINCE LOAN | FIXED REPAYMENT | |
| GRANTED | OF PRINCIPAL | |
| [MONTH] | [FIXED_BALANCE] | SHARED APPRECIATION |
| 0 | Nominal Loan Amount | X % of Home Appreciation |
| | [LOAN_AMT] | |
| 1 | Current Fixed | X % of Home Appreciation |
| | Repayment Balance | |
| | [function (LOAN_AMT, | |
| | EXPECTED_{—} | |
| | APPRECIATION)] | |
| 2 | Current Fixed | X % of Home Appreciation |
| | Repayment Balance | |
| | [function (LOAN_AMT, | |
| | EXPECTED_ | |
| | APPRECIATION)] | |
| ↓ | ↓ | ↓ |
| β | $0 | X % of Home Appreciation |
| β + 1 | $0 | X % of Home Appreciation |
| β + 2 | $0 | X % of Home Appreciation |
| ↓ | ↓ | ↓ |
| Month of | $0 | X % of Home Appreciation |
| Terminal Event | | |

Input #4 (2050 on FIG. 2) See FIG. 11

I. Borrower Approves Basic Terms and Instructs to Produce Loan Agreement 300 (in FIG. 11)

i. Review of Offered Loan Terms and Loan Schedule—After reviewing the loan schedule and term sheet, the borrower is prompted to accept the terms or return to an early step in the process and enter different values. If the terms are accepted then Process #4 commences.

Process #4 (2060 on FIG. 2) See FIG. 12

I. Loan Agreement Generation Process 310 (in FIG. 12)

i. Document Production—A set of loan documents 312 is produced once the borrower accepts the loan terms based upon the data collected throughout the process and various internal calculations executed on a computer.

Input #5 (2070 on FIG. 2) See FIG. 13

I. Borrower Reviews Loan Offer/Agreement 320 (in FIG. 13)

i. Review of Loan Agreement—The borrower is provided an opportunity to review the loan agreement.

II. Formal Acceptance 330

i. Formal Acceptance—The borrower may choose to return to a previous step in the process, or formally accept the loan offer. If formal acceptance is given then the loan agreement becomes binding.

Output (2080 on FIG. 2) See FIG. 14

I. Home Appreciation Loan Documentation Created 340 (in FIG. 14)

i. Final Documentation—A final, formal version of the borrower and lender approved home appreciation loan agreement 342 is produced.

Other Processes

I. Minimum Transaction Size Process

i. Minimum Transaction Size—The home appreciation loan lender may choose to employ an additional process that compares the proposed loan amount [LOAN_AMT] with a minimum acceptable transaction size [MIN_ACCEPT_TRANS]. If the loan amount is less than the minimum acceptable transaction size then the borrower is so informed and asked to enter different inputs.

II. General Recordation Process

i. Database Creation and Maintenance—A database entry is created with a unique identifier for each home appreciation loan. All variable changes are recorded along with the original value. All processing results or inputs are recorded as part of the database entry. Database entries are also created for each aborted transaction and/or all rejected borrowers. A wide variety of database platforms or other data storage techniques may be used to implement the system.

III. Periodic Account Updating Process

i. Database Updating—The database entry for each home appreciation loan is periodically updated to reflect changes in data inputs, including (among other items) additional borrowing against the home, repayment of the home appreciation loan, and execution of an intervening event process or terminal event sequence.

IV. Intervening Event Process

i. Intervening Events—Any informational updates, including matters such as foreclosure or conventional mortgage default, which occurs within the term of the home appreciation loan are recorded in the database. Such events may trigger additional processes relating to the continued operation of the home appreciation loan in light of the changed circumstances.

V. Execution of Terminal Event Sequence

i. Sale, Transfer, or Repayment—Upon sale, transfer, or repayment, a process is executed to calculate the amount due [AMT_DUE] to the lender. This includes calculation of the outstanding fixed balance [FIXED_BALANCE] based upon the month since the loan was issued [MONTH]. Similarly, the value of the home appreciation lender's home appreciation interest [X %] is calculated, which equals [{X %×(SALE_PRICE−ACCEPT_FMV)}−{Φ %×Submitted Qualified Selling Expenses}]. A series of recordation, cancellation of obligation, and documentation processes are executed in accordance with the termination of the home appreciation loan. Records of all such documentation, processing, and correspondence are stored in the database.

VI. Utilization of Database

i. Database Utilization—The database containing information on home appreciation loan borrowers and subject properties may be valuable to third party information users. The home appreciation loan lender may choose to intermittently transmit, allow access to, or otherwise manipulate such database information. This information may be utilized in its original state, redacted, stripped of personal identifying data, or otherwise manipulated. The information may be provided to third parties in a variety of forms, including as a continuous data feed, as a full database, or as portions of the full database.

The Home Appreciation Loan Bundling or Securitization Process Overview (FIG. 29)

As above, although we describe examples that involve home appreciation loans in what follows, the same techniques could be applied to other vehicles.

The bundling or securitization of home appreciation loans by a home appreciation loan lender provides the third party vendor/financial intermediary with an investment vehicle with a return correlated with the change in residential real estate prices for specific geographic areas (which could range from an area as broad as the United States or entire globe to an area as small as a zip code or neighborhood). The third party vendor/financial intermediary can then in turn assume or generate geographically-pegged home price contingent liabilities with some measure of risk offsetting. Such assumed liabilities might include the offering of geographically-pegged home price indexed investment accounts. Ultimate consumers of such accounts might include any person with a foreseeable need or desire (i) to invest additional equity in a home (first-home or upgrade) or (ii) to shift existing equity investment in a home to a different geographic market.

At present, such individuals have no viable outlet to invest their funds so as to correlate them with the price of the home they wish to purchase. This investment opportunity and planned liability mismatch imposes risk, which can be profitably intermediated at a lower risk-bearing cost. The value thereby created is divided between the account holder, third party vendor/financial intermediary, and derivatively the home appreciation loan lender.

The home appreciation loan lender, which has either already originated or will originate a “Home Appreciation Loan,” bundles or securitizes the resultant (or expected) home appreciation loan assets and transfers them either in whole or in part to a third party vendor/financial intermediary or issues a guarantee of repayment based in whole or in part upon the returns associated with such home appreciation loan assets.

Order of Steps Interchangeable—The order of the steps in the flow of funds between the home appreciation loan lender and the third party vendor/financial intermediary is interchangeable, but for purposes of illustration, at times in the description it will be assumed that the funds are borrowed first and then repaid. Alternative ordering relationships may also use the same basic process. For example, the process might be commenced by the transmission of data by a third party vendor/financial intermediary seeking to lend funds. Alternatively, the process might be commenced by the home appreciation loan lender offering bundled or securitized home appreciation loan assets to potential third party vendors/financial intermediaries.

Flow of Funds from Third Party Vendor/Financial Intermediary to Home Appreciation Loan Lender—A third party vendor/financial intermediary might transfer funds to the home appreciation loan lender through either: (A) an exchange transaction, which consists of the transfer of a home appreciation loan asset bundle or securitization in exchange for cash, existing home appreciation loan assets, or other securities, or (B) a credit transaction, which might involve (1) a line-of-credit, (2) conventional loan, (3) formal debt instrument, or (4) other debt-like instrument being exchanged for a repayment guarantee.

Nature of Repayment Guarantee—The repayment guarantee could consist of any combination of (1) a repayment of the principal and (2) interest. The principal or interest payment or payments could be in the form of cash or securities, including a collection of home appreciation loan assets.

For example, a third party vendor/financial intermediary might purchase a bond from the home appreciation loan lender for a face amount of $1,000,000, which has terms guaranteeing repayment of the principal in the form of a pool of the fixed repayment balance assets and interest equal to (i) a geographically-pegged home price index change, plus or minus (ii) a market compensating rate.

Another specific example would include a third party vendor/financial intermediary transferring $25,000,000 to the home appreciation loan lender in exchange for the transfer of a pool of 5,000 separate equity participation interests geographically concentrated in the Philadelphia metropolitan area (designated by zip codes or other unique qualifiers).

Flow of Funds from Home Appreciation Loan Lender to Third Party Vendor/Financial Intermediary—A home appreciation loan lender, which will or has generated or acquired home appreciation loan assets, honors or offers either: (A) an immediate exchange of cash or securities for a home appreciation asset bundle or securitization exchange, or (B) a future repayment guarantee, which includes some combination of (1) a repayment of the principal, plus (2) interest with the rate at least in part derived from (i) the returns on a collection of home appreciation loan assets or (ii) pegged to the change in a specific geographic home price index, plus or minus (3) a market compensating rate.

Meaning of “Home Appreciation Loan Assets”—A home appreciation loan includes two principal components:

(1) Component 1: Fixed Balance—the fixed repayment balance (as outlined in the associated loan schedule for the individual home appreciation loan), and

(2) Component 2: Home Price Appreciation Participation—the home price appreciation interest.

Both components of the home appreciation loan are pegged to the geographic zone identified upon origination of the home appreciation loan.

Further Refinement of Components—The loan need not be divided into only the two principal components. Both could be subdivided in an infinite number of subcomponents. For example, the fixed balance could be subdivided into (1) a secured subcomponent that is equal to the fixed balance outstanding less than or equal to existing home equity and (2) an unsecured subcomponent that is equal to the fixed balance outstanding in excess of existing home equity. For simplicity, only the division into the two principal components is discussed below.

Meaning of Bundling—The term “bundling” refers to all methods of consolidating home appreciation loan assets without the addition of any other financial instruments or derivative instruments.

Meaning of Securitization—The term “securitization” refers to all methods of consolidating home appreciation loan assets so as to produce a security with characteristics that do not precisely mimic a simple bundle of home appreciation loan assets. “Securitization” thus refers to some form of simple “bundling” with an additional process or processes that consolidates home appreciation loan assets with at least one other form of financial instrument or derivative instrument.

For example, one possible operation would “bundle” a set of home appreciation loan assets linked to a particular state and then combine those bundled loan assets with a home price futures contract for a zip code within that state that is not well represented within the bundle itself. Such a securitization operation could include all manner of financial derivatives including (among others): basic options (puts and calls), straddles, spreads, American calls, European calls, standard futures contracts, and indices futures contracts.

Critical Distinction between “Securitization” and “Bundling”—“Securitization” is simple “bundling” with at least one additional consolidation step involving a financial instrument or derivative instrument apart from the two principal components of a set of home appreciation loan assets.

Other forms of equity participation interest, such as the equity component of a shared appreciation mortgage, can be bundled and/or securitized in a manner similar to that proposed for home appreciation loans.

Other equity participations can be bundled or securitized to correlate returns or investment payoffs with home price changes within specified geographic areas.

Parties to Exchange Transactions Including Bundled or Securitized Home Appreciation Loan Assets—The basic “bundling” or more complex “securitization” process involves at least two basic parties:

(1) The “third party vendor/financial intermediary”—which represents the counterparty that wishes to acquire additional home appreciation loan assets, peg returns to a contractually-define home price index, and/or rebalance an existing portfolio of home appreciation loan assets, and

(2) The “home appreciation loan lender”—which represents the counterparty that has or will have home appreciation loan assets acquired through loan origination or other transactions to exchange either for cash, debt or debt-like obligations, other home appreciation loan assets, or any other financial or derivative instruments.

Distinct Types of Bundling or Securitization Processes—The actual bundling or securitization process could take various forms within the basic spirit and operation of the processes described in detail below. What follows are only some specific examples. Some of the basic bundling or securitization processes are as follows.

(1) Creation of Tailored Pooled Financial Instruments—This general process involves transmission of data by the third party vendor/financial intermediary pertaining to the desired specifications of the financial instrument or security to be created.

For example, a third party vendor/financial intermediary might transmit data detailing its existing base of home price-pegged accounts in order to have the home appreciation loan lender craft a financial instrument that offsets much of the home appreciation and other risks associated with those home price contingent obligations.

For illustrative purposes only, one possible variant within this group is described below under the heading “(A) Third Party Vendor/Financial Intermediary-Initiated Process & Creation of a Tailored Financial Instrument.”

(2) Creation of Standard Pooled Financial Instruments—This general process involves the pooling of existing or expected home appreciation loan assets into financial instruments with certain marketable characteristics.

For example, a home appreciation loan lender might create a financial instrument with home appreciation assets limited to one zip code and a term of 60 months with (i) an aggregated base home value of $10,000,000 underlying the home appreciation loans, (ii) a weighted-average home price appreciation participation interest of 50%, (iii) an annual compensating fixed interest rate of 1.5%, (iv) a lump sum payment of $500,000 due in 12 months, and (v) a set of home price futures contracts that better correlate the return to a specified home price appreciation index.

Or for example, a home appreciation loan lender might create a new financial instrument that bundles or securitizes a pool of home appreciation loan assets limited to the five most likely retirement locations. The process in this case would be similar to the one described in detail below, except the targeted zone would include multiple discrete geographic locations instead of one encompassing or contiguous zone.

For illustrative purposes only, one possible variant within this group is described below under the heading “(B) Home Appreciation Lender-Initiated Process & Creation of a Standard Financial Instrument.”

(3) Creation of Hybrid Pooled Financial Instruments—This general process involves the pooling of existing or expected home appreciation loan asset bundles or securitized financial instruments with certain marketable financial characteristics. A home appreciation loan lender (at the behest of a third party vendor/financial intermediary or upon its own initiative) might create a new financial instrument by consolidating existing or expected bundles or securitizations of home price loan assets that were created in one or both of prior methods.

For example, a home appreciation loan lender might create a new financial instrument that consolidates the example instruments created above by way of methods (1) or (2).

(4) Creation of Non-pooled Home Price Contingent Financial Obligations—This general process involves the creation of home price contingent financial instruments based upon the change in certain contractually-specified home price indices or other value estimation metrics.

For example, a home appreciation loan lender might create a revolving financial loan agreement collateralized by home appreciation assets diversified throughout the United States with (i) a guaranteed repayment of the nominal value of the loan issued (e.g. $5,000,000 in principal) and (ii) a variable compensating interest rate that guarantees that the total annual interest rate will equal the change in a home price index specified in the contract (change in contract-defined home price index for the U.S.) plus or minus a fixed rate set in the contract (e.g. 2%).

Workings of the Example—In this example, each year the home appreciation lender would pay the third party vendor/financial intermediary an interest payment equal to (1) the percentage change in the contract-specified home price index for the U.S. (this value could be floored at zero or allowed to be negative) plus (2) 2%. If the contract-specified home price index rose 4% over the relevant period then the total interest payment would be 6% of $5,000,000, or $300,000.

For illustrative purposes only, one possible variant within this group is described below under the heading “(C) Creation of Non-pooled Home Price Contingent Financial Obligation.”

Process: Bundling or Securitizing a Home Appreciation Loan 20000 (in FIG. 1)

(A) Third Party Vendor/Financial Intermediary-Initiated Process & Creation of a Tailored Financial Instrument 21000 (FIG. 3)

Process Overview—This general process involves transmission of data by the third party vendor/financial intermediary pertaining to the desired specifications of the financial instrument or security to be created.

Steps in Process

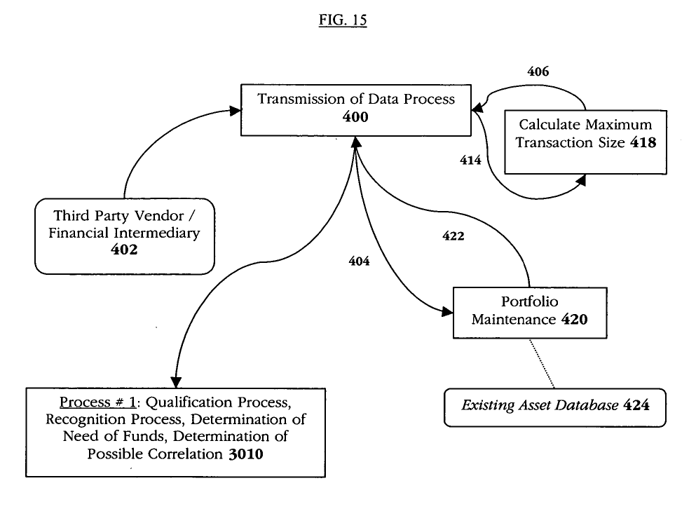

I. INPUT #1: Transmission of Data By Third Party Vendor/Financial Intermediary 3000 (FIG. 15)

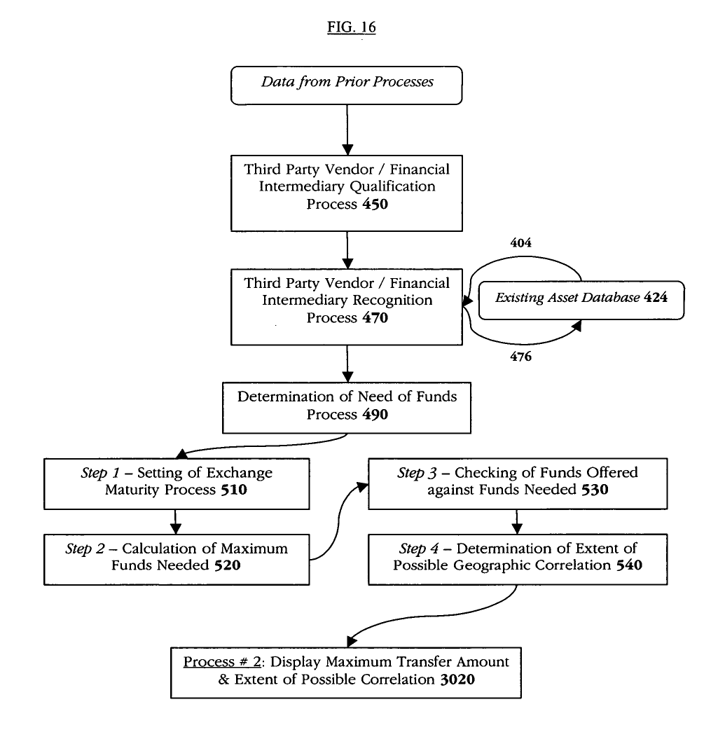

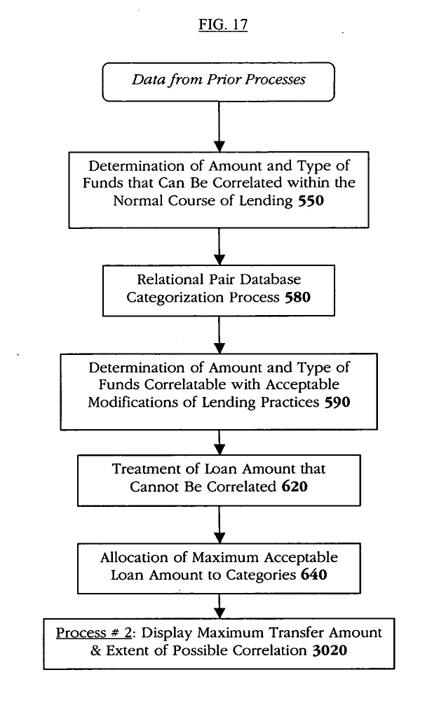

II. PROCESS #1: Third Party Vendor/Financial Intermediary Qualification Process; Third Party Vendor/Financial Intermediary Recognition Process; Determination of Need of Funds Process; Determination of Extent of Possible Geographic Correlation Process 3010 (FIGS. 16, 17)

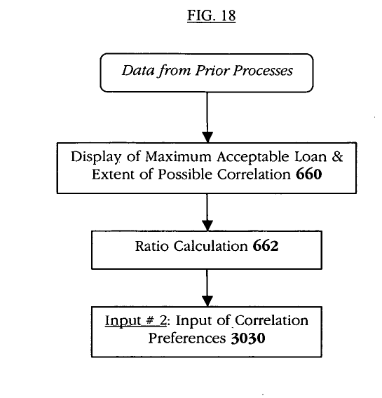

III. PROCESS #2: Display of Maximum Acceptable Loan & Extent of Possible Correlation 3020 (FIG. 18)

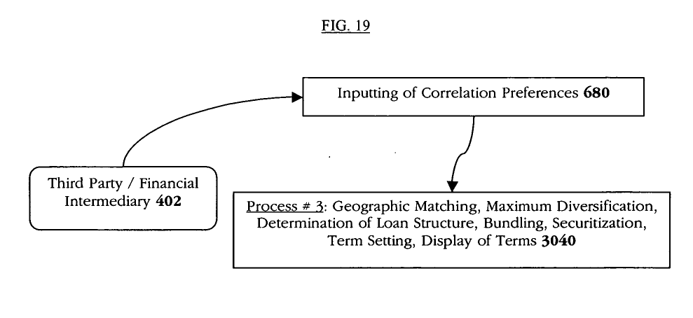

IV. INPUT #2: Input of Correlation Preferences 3030 (FIG. 19)

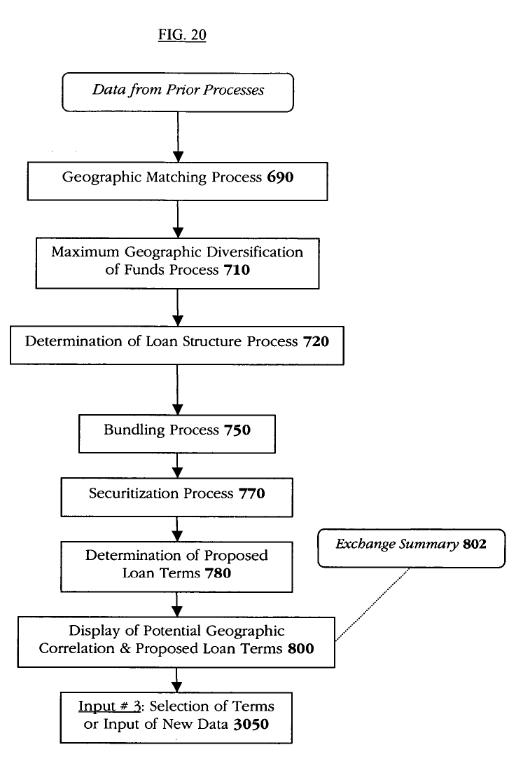

V. PROCESS #3: Geographic Matching Process; Maximum Geographic Diversification of Funds Process; Determination of Loan Structure Process; Bundling Process; Securitization Process; Determination of Proposed Loan Terms Process; Display of Potential Geographic Correlation & Proposed Loan Terms 3040 (FIG. 20)

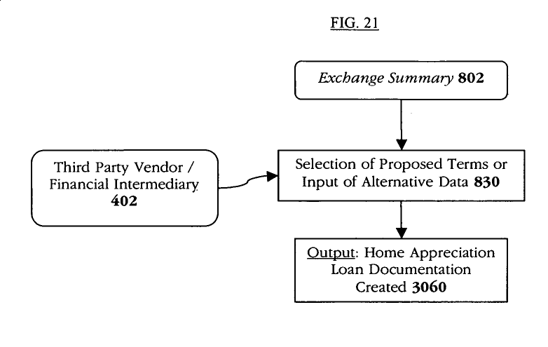

VI. INPUT #3: Selection of Proposed Terms or Input of Alternative Data 3050 (FIG. 21)

VII. OUTPUT: Formalization of Home Appreciation Loan Asset Bundle or Securitization Created 3060 (FIG. 21)

Definition of Inputs, Outputs, and Other Variables

#=A unique identifier. p1 ACCEPTED_FMV=Fair market value of home accepted for use in loan term calculations.

ADDRESS=Address of home appreciation loan borrower's home.

ALL_HOME_APP_LOANS=Database containing records of all outstanding home appreciation loan assets whether owned by lender or other parties.

ALLOCATED_ALT_CORE_FUNDS=Amount of funds actually determined to be transmitted to the home appreciation loan lender that can be geographically correlated by way of modified lending activity within the limits delineated by the lender.

ALLOCATED_NO_CORE_FUNDS=Amount of funds actually determined to be transmitted to the home appreciation loan lender that cannot be geographically correlated within the limits of the policies specified by the lender.

ALLOCATED_STD_CORE_FUNDS=Amount of funds actually determined to be transmitted to the home appreciation loan lender that can be geographically correlated in the lender's normal course of business.

ALT_CORE_FUNDS=Amount of funds proposed to be transmitted to the home appreciation loan lender that can be geographically correlated by way of modified lending activity within the limits delineated by the lender.

ALT_PROJ_LENDING_ACT=Projection of modified lending activity; created through manipulation of the HIST_LENDING_ACT database and other external data such as market interest rates.

ALT_TIME_TO_MATCH=Time specified by lender within which modified lending match must be expected.

β=Number of months after loan granted until fixed repayment balance [FIXED_BALANCE] equals $0. After β months, the outstanding fixed repayment balance is $0 and the lender is only entitled to X % of the home price appreciation.

BUNDLING_FEE=Explicit fee or implicit premium factored into exchange terms.

COMP_RATE=Compensating fixed interest rate.

CURRENT_EST_FMV=Estimate of current FMV based on statistical, actuarial, demographic, and other accurate forms of price analysis, as of day of testing subsequent to loan grant.

DERIVATIVES=Database records pertaining to any financial derivatives consolidated with bundled home appreciation loan assets in the “securitization” process.

EXP_AMT_ALT_MATCH=Expected value of a geographically-pegged amount [GEO_LINK_AMT] matched through modified lending activity.

EXP_AMT_NATURAL_MATCH=Expected value of a geographically-pegged amount [GEO_LINK_AMT] matched in the ordinary course of lending.

EXPECTED_APPRECIATION=Nominal amount of predicted home price appreciation.

FIN_INSTRUMENT_EXP_VALUE=Expected value of the new financial instrument.

FIRM_IDENT=Firm identification information (name, unique indemnifying #, etc.).

FIXED_BALANCE=Portion of repayment that is predetermined and set forth in the loan schedule.

GEO_CAT_LOAN=Geographical value assigned to a GEO_CAT_PAIR when pooled in a financial instrument.

GEO_CAT_PAIR=Relational pair of GEO_LINK_AMT and linked GEOGRAPHY.

GEO_LINK_AMT=Linked dollar amount associated with a particular GEOGRAPHY value. GEOGRAPHY and GEO_LINK_AMT form a “relational pair” [GEO_CAT_PAIR] as used in the descriptions below.

GEO_LINK_AMT_LEFT=Linked dollar amount remaining associated with a particular GEOGRAPHY value after accounting for portion correlated through a natural match (one in the normal course of business) and the portion correlated through modified lending.

GEO_LINK_AMT_REMAINING=Linked dollar amount remaining associated with a particular GEOGRAPHY value after accounting for portion correlated through a natural match (one in the normal course of business).

GEO_POOL_REGION_AMT=Nominal value of pooled home appreciation loan assets for a specified region.

GEOGRAPHY=Geographic area specified with linked dollar amount for return-pegging; ranges from narrow categories such as zip code or neighborhood to broad categories such as the United States or entire globe.

HIST_LENDING_ACT=Database containing records of all existing and prior home appreciation loan lending activity, which can be manipulated to produce trend data and other statistics.

HOME_APP_LOAN_ELASTICITY=Price elasticity of home appreciation loan origination; derived through manipulation of the HIST_LENDING_ACT database and other external data such as market interest rates.

LOAN_AMT=Nominal value of home appreciation loan granted.

LOAN_ATTRIB_SOME=Part of individual relational pair GEO_LINK_AMT that is allocated to STD_CORE_FUNDS and ALT_CORE_FUNDS.

LOAN_ATTRIB_STD_CORE=Part of individual relational pair GEO_LINK_AMT that is allocated to STD_CORE_FUNDS.

LOAN_DATE=Home appreciation loan issuance date.

LOAN_FORM=Form of loan or purchase (immediate purchase, line-of-credit, debt instrument, etc.).

LUMP_SUM=Lump sum payment.

MATURITY=Maturity of the new financial instrument.

MAX_ACCEPT_LOAN=Maximum total value of cash, securities, existing home appreciation loan assets, loan grants, and other financial claims that is accepted by both parties to the transaction for calculation of the exchange terms.

MAX_ACCEPT_TERM=Maximum MATURITY that is acceptable to the home appreciation loan lender.

MAX_FUNDS_NEEDED=Maximum value of funds that the home appreciation loan lender can utilize and/or will accept in the transaction.

MAX_LOAN=Maximum total value of cash, securities, existing home appreciation loan assets, loan grants, and other financial claims that the third party vendor/financial intermediary is willing to exchange.

MAX_TERM=Maximum loan term in months (ranging from 1 month to no expiration term).

MEAN_PART %=Mean home price appreciation participation interest percentage.

MIN_ACCEPT_TERM=Minimum MATURITY that is acceptable to the home appreciation loan lender.

MIN_FIXED_RATE=Minimum acceptable fixed interest rate (as specified by the third party vendor/financial intermediary), which can range from negative 100% (no return of principal) to any positive value.

MONTH=Number of months following the grant of the home appreciation loan.

NO_CORE_FUNDS=Amount of funds proposed to be transmitted to the home appreciation loan lender that cannot be geographically correlated within the limits of the policies specified by the lender.

OWNED_APP_LOANS=Database containing records of all outstanding home appreciation loan assets still owned by the home appreciation loan lender.

PROB_ALT_MATCH=Probability that any given investment amount as designated in a geographically-pegged relational pair can be matched with home appreciation loan assets expected to be acquired through modified lending activity within the time period specified by the lender [ALT_TIME_TO_MATCH].

PROB_NATURAL_MATCH=Probability that any given investment amount as designated in a geographically-pegged relational pair can be matched with existing home appreciation loan assets or matched with such assets expected to be acquired within the time period specified by the lender [TIME_TO_MATCH].

PROJ_LENDING_ACT=Projection of lending activity; created through manipulation of the HIST_LENDING_ACT database and other external data such as market interest rates.

QUALIFIED=Flag to indicate third party vendor/financial intermediary is qualified to enter into a transaction as a counterparty.

RATIO_ALT_CORE=Percentage of funds to be transmitted to the home appreciation loan lender that will be correlated through modified lending activity.

RATIO_NO_CORE=Percentage of funds to be transmitted to the home appreciation loan lender that will not be correlated to the exact geographic region specified in the data transmitted by the third party vendor/financial intermediary. Such funds are correlated as closely as possible in another region.

RATIO_STD_CORE=Percentage of funds to be transmitted to the home appreciation loan lender that will be correlated in the ordinary course of lending.

SECURITIZTION_FEE=Explicit fee or implicit premium factored into exchange terms.

SPREAD_VALUE=Explicit and/or implicit rate factored into exchange terms as specified by the home appreciation loan lender.

STANDARDS=Ranges of the combinations of LOAN_AMT, X %, and/or β that are specified by the home appreciation loan lender as acceptable for use in modified lending activity.

STD_CORE_FUNDS=Amount of funds proposed to be transmitted to the home appreciation loan lender that can be geographically correlated in the lender's normal course of business.

TIME_TO_MATCH=Time specified by lender within which natural match must be expected.

TODAY_DATE=Current date.

TOTAL_EQUITY_BASE=Total value of homes to which all X % included in the new financial instrument are pegged.

TOTAL_LOAN_AMT=Total value of funds received by the home appreciation loan lender in the transaction.

X %=Percentage of home price appreciation shared by the lender.

Δ=Incremental numerical value, which equals $0.01 when modifying LUMP_SUM and 0.000001% when modifying COMP_RATE.

Input #1 (FIG. 15)

I. Transmission of Data By Third Party Vendor/Financial Intermediary Process 400

i. The third party vendor/financial intermediary 402 submits basic data concerning: (1) firm identification [FIRM_IDENT 404]; and (2) either (i) the maximum total amount of funds the firm is willing to lend (or value of cash, existing home appreciation assets, or other securities the counterparty is willing to exchange immediately—collectively referred to as the maximum loan amount below) [MAX_LOAN 406 ] to the home appreciation loan lender 408 or (ii) a data set of relational pairs 410, specifying a geographic areas (ranging from an area as broad as the United States or globe to one possibly as narrow as a zip code or neighborhood) [GEOGRAPHY 412] and linked amounts [GEO_LINK_AMT 414] (with [#416] as a unique identifier for each relational pairing), that can be aggregated through a summation calculation process 418 to arrive at a maximum total amount of funds that firm is willing to lend [MAX_LOAN].

Portfolio Maintenance 420—The maximum loan amount could equal zero if the third party vendor seeks only to rebalance its existing portfolio of bundled or securitized home appreciation loan assets. Existing portfolio information 422 could be (i) transmitted as a set of relational pairs or (ii) retrieved from an existing database 424 using the firm identification provided. Such a transaction would involve the transfer of cash, other financial instruments, existing home appreciation loan assets, and/or existing home appreciation loan-based securities by the third party vendor/financial intermediary in exchange for a transfer of a different mix of cash, other financial instruments, existing home appreciation loan assets, and/or existing home appreciation loan-based securities by the home appreciation loan lender. The processes are similar in nature and effect as those for the traditional lending transaction.

ii. The third party vendor/financial intermediary may also choose to submit data concerning: (3) the preferred form of loan (line-of-credit, debt instrument, etc.) [LOAN_FORM 426]; (4) maximum loan term in months (ranging from 0 months to no expiration term) [MAX_TERM 428]; (5) minimum acceptable fixed interest rate {ranging from negative 100% (no return of principal) to any positive % value} [MIN_FIXED_RATE 430]; and/or (6) information about the firm's existing portfolio (either transmitted by the firm or accessed from existing records as a function of [FIRM_IDENT]).

iii. Example of Possible Input—A third party vendor/financial intermediary might submit data as basic as the following:

| FIRM IDENTIFICATION | MAXIMUM LOAN AMOUNT |
|---|---|
| [FIRM_IDENT] | [MAX_LOAN] |
| XYZ Financial Corp. | $$$ |

iv. Example of Possible Input—A third party vendor/financial intermediary might alternatively submit data as complex as the following:

| FIRM | MAXIMUM LOAN | PREFERRED | MAXIMUM LOAN | MINIMUM FIXED |
|---|---|---|---|---|
| IDENTIFICATION | AMOUNT | LOAN FORM | TERM | INTEREST RATE |
| [FIRM_IDENT] | [MAX_LOAN] | [LOAN_FORM] | [LOAN_TERM] | [MIN_FIXED_RATE] |
| XYZ Financial | [See “Loan | Collateralized | 36 months | 1.5% |
| Corp. | Relational Pairs” | Debt Obligation | | |
| | Data Table] | (CDO) | | |

LOAN RELATIONAL PAIRS DATA TABLE

| UNIQUE | | |
|---|---|---|
| IDENTIFIER | GEOGRAPHICAL AREA | LINKED AMOUNT |
| [#] | [GEOGRAPHY] | [GEO_LINK_AMT] |
| 1 | Wisconsin | $$$ |
| 2 | U.S. | $$$ |
| 3 | ZIP Code 02138 | $$$ |
| 4 | New England | $$$ |
| ↓ | ↓ | ↓ |
| Max. # | 110^{th}-120^{th} Beacon St., | $$$ |
| | Cambridge, MA | |

EXISTING. PORTFOLIO LOAN RELATIONAL PAIRS DATA
TABLE

| UNIQUE | | |
|---|---|---|
| IDENTIFIER | GEOGRAPHICAL AREA | LINKED AMOUNT |
| [#] | [GEOGRAPHY] | [GEO_LINK_AMT] |
| XYZ_1 | Washington, D.C. | $$$ |
| XYZ_2 | Seattle | $$$ |
| XYZ_3 | ZIP Code 89052 | $$$ |
| XYZ_4 | Southern California | $$$ |
| ↓ | ↓ | ↓ |
| XYZ_Max. # | North America | $$$ |

Process #1 (FIG. 16)

I. Third Party Vendor/Financial Intermediary Qualification Process 450 (in FIG. 16)

i. The third party vendor/financial intermediary is qualified as a potential lender using either an internal database, external database, or through a qualifying process that uses home appreciation loan lender specified criteria. If the lender is qualified then the variable [QUALIFIED] is set to “yes” (0 or 1 in a binary system) and the next process commences. If not, the lender is asked to input additional data in an attempt to qualify based upon specified home appreciation loan lender standards.

QUALIFIED=function (FIRM_IDENT, other inputted firm data where necessary)

II. Third Party Vendor/Financial Intermediary Recognition Process 470 (in FIG. 16)

i. Purpose—Third party vendors/financial intermediaries that have previously acquired some form of geographically-pegged home appreciation loan assets can benefit by having those preexisting positions taken into consideration in all processes used to structure a new loan or to rebalance the existing position. For example, adequate geographic diversification could be achieved at a lower cost if existing positions where considered when determining what new positions to issue or substitute for the old as part of a complete third party vendor/financial intermediary financial obligation or loan solution.

ii. Recognition Process—The third party vendor/financial intermediary's identification entry [FIRM_IDENT] is compared with an existing third party vendor/financial intermediary database 424. If the firm is recognized then the associated transaction records concerning existing positions can be retrieved and utilized 476 in further calculations. The default is utilization, but the third party vendor/financial intermediary could be given the option to run the subsequent processes as if the third party vendor/financial intermediary was a new lender.

III. Determination of Need of Funds Process 490 (in FIG. 16)

i. Purpose—The home appreciation loan lender may not always be in a position to take the funds proposed to be lent and originate or acquire home appreciation loan assets correlated with the expected returns. This process assesses the home appreciation loan lender's need for the funds as a function of databases pertaining to its historical lending activity [HIST_LENDING_ACT], projected lending activity [PROJ_LENDING_ACT] as derived through a statistical projection and extrapolation process as a function of HIST_LENDING_ACT and other financial variables such as interest rates, existing portfolio of owned home appreciation loan assets [OWNED_APP_LOANS], and portfolio of all home appreciation loans originated or acquired [ALL_HOME_APP_LOANS].

ii. Setting of Exchange Maturity Process 510—A process is executed to set the maturity in terms of a number of months (or revolving) [MATURITY] of the new financial instrument. The maturity is set equal to the MAX_TERM inputted by the third party vendor/financial intermediary unless this process determines that MAX_TERM is less than the minimum term [MIN_ACCEPT_TERM] specified as acceptable by the home appreciation loan lender or greater than the maximum term [MAX_ACCEPT_TERM] set by the home appreciation loan lender. If either is the case then MATURITY is set equal to the MIN_ACCEPT_TERM or MAX_ACCEPT_TERM as specified by the lender. This MATURITY value is then used in all calculations to produce a set of proposed exchange terms.

If MAX_TERM>MAX_ACCEPT_TERM Then MATURITY=MAX_ACCEPT_TERM.

If MAX_TERM<MIN_ACCEPT_TERM Then MATURITY=MIN_ACCEPT_TERM.

If (MAX_TERM>MIN_ACCEPT_TERM) and (MAX_TERM≦MAX_ACCEPT_TERM) Then MATURITY=MAX_TERM.

iii. Calculation of Maximum Funds Needed 520 This process calculates a value of funds [MAX_FUNDS_NEEDED] that can be reasonably expected (within home appreciation loan lender-specified guidelines) to be lent within a time frame that makes borrowing at present economical.

MAX_FUNDS_NEEDED=function (HIST_LENDING_ACT, PROJ_LENDING_ACT, OWNED_APP_LOANS, ALL_HOME_APP_LOANS)

iv. Checking of Funds Offered Against Funds Needed 530—This process compares the maximum amount of funds offered by the third party vendor/financial intermediary [MAX_LOAN] to the home appreciation loan lender's maximum funds needed [MAX_FUNDS_NEEDED]. If the proposed maximum loan amount equals or is less than the maximum amount of funds needed then the acceptable loan size [MAX_ACCEPT_LOAN] is set equal to the maximum loan amount proposed. If the proposed maximum loan exceeds the maximum amounts of funds needed then the acceptable loan size [MAX_ACCEPT LOAN] is set equal to the maximum amount of funds needed.

If MAX_LOAN≦MAX_FUNDS_NEEDED Then MAX_ACCEPT_LOAN=MAX LOAN.

If MAX_LOAN>MAX_FUNDS_NEEDED Then MAX_ACCEPT_LOAN=MAX_FUNDS_NEEDED.

v. A display process might at this point display the maximum amount acceptable loan amount and ask for third party vendor/financial intermediary acquiescence in the continuation of the process. This step, like many of the processes outlined in this description, is optional.

IV. Determination of Extent of Possible Geographic Correlation Process 540 (in FIG. 16) See FIG. 17

i. Purpose—The determination that the home appreciation lender can make use of the funds proposed to be lent is a necessary, but not a sufficient condition for the transaction appealing to the third party vendor/financial intermediary. The third party vendor/financial intermediary may be attempting to offset particular risks associated with its home price-pegged obligations or other residential real estate price contingent obligations. Third party vendors/financial intermediaries and/or the home appreciation loan lender may be unwilling to proceed without a minimum level of correlation or may be unwilling to pay the cost of having the home appreciation loan lender assume the risk of obligating itself without correlation and sufficient risk offsetting. It must therefore be determined whether the home appreciation loan lender has or is expected to soon acquire sufficiently correlated home appreciation loan assets to offer returns pegged to price indices changes or other home price contingent liabilities within the acceptable standards of both parties. This process produces three critical correlation calculation results.

First, there is the amount of funds that can be geographically correlated in the home appreciation loan lender's normal course of business [STD_CORE_FUNDS].

Second, there is the additional amount of funds that can be geographically correlated through an alteration of the home appreciation loan lender's standard practices [ALT_CORE_FUNDS], that is, acceptable under the policies set by the home appreciation loan lender, such as issuing home appreciation loans on more favorable terms in a targeted geographic area in order to generate home appreciation loan assets pegged to that area. The distinction is important because the home appreciation loan lender may choose to charge a premium explicitly or implicitly (through modification of the loan terms) to account for the additional effort.

Third, there is the amount of funds that cannot be geographically correlated within the limits of the policies specified by the home appreciation loan lender [NO_CORE_FUNDS].

ii. Determination of Amount and Type of Funds that Can be Correlated within Normal Course of Business 550 (in FIG. 17)

No Geographic Preference Indicated—If the third party vendor/financial intermediary has not transmitted preferences as to geographic area to which to peg returns then STD_CORE_FUNDS is set equal to the entire maximum loan amount.

STD_CORE_FUNDS=MAX_ACCEPT_LOAN.

Data Concerning Geographic Pegging Was Submitted—If the third party vendor/financial intermediary has transmitted data concerning geographic pegging of returns then a process is executed which calculates a probability [PROB_NATURAL_MATCH] that any given investment amount as designated in a relational pair, specifying a geographic area [GEOGRAPHY] and linked amounts [GEO_LINK AMT] (with [#] as a unique identifier) can be matched with either (1) existing home appreciation loan assets from that geographic area or (2) would be matched within a time period [TIME_TO_MATCH] established by the home appreciation loan lender in the normal course of business based upon historical lending activity [HIST_LENDING_ACT], projected lending activity [PROJ_LENDING_ACT], existing portfolio of owned home appreciation loan assets [OWNED_APP_LOANS], and portfolio of all home appreciation loans originated or acquired [ALL_HOME_APP_LOANS]. The probability of matching the investment return with home appreciation loan assets for the individual relational pair [PROB_NATURAL_MATCH] is multiplied by the linked amount [GEO_LINK_AMT] to arrive at an expected amount for that particular relational pair that can be correlated in the normal course of course business [EXP_AMT_NATURAL_MATCH]. All such expected amounts that can be correlated for each individual relational pair are aggregated to produce the total amount of funds that is expected to be correlated in the normal course of business [STD_CORE_FUNDS].

PROB_NATURAL_MATCH=function (GEOGRAPHY, GEO_LINK_AMT, TIME_TO_MATCH, HIST_LENDING_ACT, PROJ_LENDING_ACT, OWNED_APP_LOANS, ALL_HOME_APP_LOANS).

EXP_AMT_NATURAL_MATCH=PROB_NATURAL_MATCH×GEO_LINK_AMT.

STD_CORE_FUNDS=sum (EXP_AMT_NATURAL_MATCH for each #).

iii. Relational Pair Database Categorization Process 580 (in FIG. 17) For each relational pair of loan amounts and geographical areas, a new database entry is created to account for the portion the loan amount that has been attributed [LOAN_ATTRIB_STD CORE] to STD_CORE_FUNDS in the previous process. For each pair, a remaining loan amount [GEO_LINK_AMT_REMAINING] is set equal to the original geographically linked loan amount [GEO_LINK_AMT] less the expected amount that could be correlated in the normal course of business [EXP AMT_NATURAL_MATCH].

GEO_LINK_AMT_REMAINING=GEO_LINK_AMT−EXP_AMT_NATURAL_MATCH.

iv. Determination of Amount and Type of Funds Correlatable with Acceptable Modifications of Normal Home Appreciation Loan Lending Practices Process 590 (in FIG. 17)—The home appreciation loan lender may choose to execute an additional process that determines whether any given investment amount as designated in a relational pair, specifying a geographic area [GEOGRAPHY] and linked amounts remaining [GEO_LINK_AMT_REMAINING] (with [#] as a unique identifier) can be matched within a time period [ALT_TIME_TO_MATCH] as established by the home appreciation loan lender based upon a modified projected lending activity [ALT_PROJ_LENDING_ACT]. The modified projected lending activity is calculated as a function of historical lending activity [HIST_LENDING_ACT]. Specifically, a series of calculations are performed using historical lending activity [HIST_LENDING_ACT] and a derivation of regional price elasticity of home appreciation loan origination [HOME_APP_LOAN_ELASTICITY] to determine whether home appreciation loans could be made within lender specified loan alteration limits of the three primary home appreciation loan terms (LOAN_AMT, X %, and/or β) . This process calculates a probability [PROB_ALT_MATCH] that such an alternative or modified match can be created through targeted home appreciation loan lending within a range of acceptable terms [STANDARDS]. The probability of matching the investment return with home appreciation loan assets for the individual relational pair [PROB_ALT_MATCH] is multiplied by the linked amount remaining [GEO_LINK_AMT_REMAINING] to arrive at an expected amount for that particular relational pair that can be correlated outside of the normal course of course business through targeted home appreciation loan term modified lending [EXP_AMT_ALT_MATCH]. All such expected amounts that can be correlated for each individual relational pair is aggregated to produce the total amount of funds that can be correlated in this manner [ALT_CORE_FUNDS].

PROB_ALT_MATCH=function (GEOGRAPHY, GEO_LINK_AMT_REMAINING, ALT_TIME_TO_MATCH, HIST_LENDING_ACT, ALT_PROJ_LENDING_ACT, HOME_APP_LOAN_ELASTICITY, LOAN_AMT, X %, β, STANDARDS).

EXP_AMT_ALT_MATCH=PROB_ALT_MATCH×GEO_LINK_AMT_REMAINING.

ALT_CORE_FUNDS=sum (EXP_AMT_ALT_MATCH for each #).

v. Treatment of Loan Amount that Cannot Be Correlated Process 620 (in FIG. 17) For each relational pair of loan amount and geographical area, a new database entry [LOAN_ATTRIB_SOME] is created to account for the portion the loan amount that has been attributed to STD_CORE_FUNDS and ALT_CORE_FUNDS in the previous processes. For each pair, a remaining loan amount [GEO_LINK_AMT_LEFT] is set equal to the original geographically linked loan amount [GEO_LINK_AMT] less the expected amount that could be correlated in the normal course of business [EXP_AMT_NATURAL_MATCH] and less the expected amount that could be correlated outside of the normal course of business with targeted home appreciation loan lending within lender specified standards [EXP_AMT_ALT_MATCH]. The sum of all such funds that could not be correlated through the prior processes for each individual relational pair is aggregated to produce the total amount of funds that cannot be correlated through home appreciation lending [NO_CORE_FUNDS].

GEO_LINK_AMT_LEFT=GEO_LINK_AMT−EXP_AMT_NATURAL_MATCH−EXP_AMT_ALT_MATCH.

NO_CORE_FUNDS=sum (GEO_LINK_AMT_LEFT for each #).

vi. Allocation of Maximum Acceptable Loan Amount to Categories 640 (in FIG. 17) At this point in the process, the maximum amount of funds that the home appreciation loan lender is willing to accept [MAX_ACCEPT_LOAN] has been established. Based upon submitted data, the following have also been established: (1) the maximum amount of funds that can be correlated through the normal course of home appreciation lending [STD_CORE_FUNDS], (2) the maximum amount of funds that can be correlated through targeted home appreciation loan lending (with modified terms within the limits set by the lender) [ALT_CORE_FUNDS], and (3) the amount of funds that cannot be correlated through home appreciation lending [NO_COR_FUNDS]. Within each category of correlation, database entries have been created to reflect the portion of individual relational pairs that were included.

Example—For example, an original relational pair entry might have been (#57, $500, Boston, Mass.). If the market for home appreciation lending in Boston, Mass. has been and is expected to continue to be fluid then the likelihood that the lender has or will be able to secure correlated home appreciation loan assets is high. The resultant calculation might have attributed a 90% chance of perfect correlation within the normal course of lending. With targeted lending in the Boston, Mass. (with accommodative borrower terms), the chance of correlated lending might increase to 97%. A 3% chance of non-correlation is calculated. The associated expected values were $450 (90% of $500), $35 (7% of $500), and $15 (3% of $500). A database entry with these figures was created as part of the processes above.

Allocation ofMaximum Acceptable Loan Amount—The maximum acceptable loan amount for each relational pair entry is allocated to the individual correlation categories. The priority ordering is as follows: (1^{St}) STD_CORE_FUNDS, (2^{nd}) ALT_CORE_FUNDS, and (3^{rd}) NO_CORE_FUNDS. The exact logical mechanism for each relational pair entry is as follows:

(1) If STD_CORE_FUNDS>MAX_ACCEPT_LOAN Then ALLOCATED_STD_CORE_FUNDS=MAX_ACCEPT_LOAN Else ALLOCATED_STD_CORE_FUNDS=STD_CORE_FUNDS.

(2) MAX_ACCEPT_LOAN_LEFTOVER=MAX_ACCEPT_LOAN−ALLOCATED_STD_CORE_FUNDS.

(3) If MAX_ACCEPT_LOAN_LEFTOVER>0 Then (If ALT_CORE_FUNDS≧MAX_ACCEPT_LOAN_LEFTOVER Then ALLOCATED_ALT_CORE_FUNDS=MAX_ACCEPT_LOAN_LEFTOVER Else ALLOCATED_ALT_CORE_FUNDS=ALT_CORE_FUNDS) Else ALLOCATED_ALT_CORE_FUNDS=0.

(4) MAX_ACCEPT_LOAN_LEFTOVER_NEW MAX_ACCEPT_LOAN_LEFTOVER−ALLOCATED_ALT_CORE_FUNDS.

(5) If MAX_ACCEPT_LOAN_LEFTOVER_NEW>0 Then ALLOCATED_NO_CORE_FUNDS=MAX_ACCEPT_LOAN_LEFTOVER_NEW Else ALLOCATED_NO_CORE_FUNDS=0.

Recordation—For each relational pair, this process records the values of the amounts allocated to each of the three categories: (1)

ALLOCATED_STD_CORE_FUNDS, (2)

ALLOCATED_ALT_CORE_FUNDS, and (3)

ALLOCATED_NO_CORE_FUNDS.

Example Continued—The associated expected values for each category from the previous example were $450 (90% of $500), $35 (7% of $500), and $15 (3% of $500) respectively. A database entry with these figures was created as part of the processes above. If the maximum acceptable loan amount had been $500 then the allocation would have been $450, $35, and $15 respectively as well. If the maximum acceptable loan amount was lower, say $300, then the allocation would have been $300, $0, and $0 respectively.

Use of Categorized Data—For each relational pair, an individual priority ordering has been established. This ordering could be used to offer the third party vendor/financial intermediary the option of maximizing overall correlation by matching only parts of individual relational pairs. A possible stylized interaction using this process is offered below.

General Step One—The third party vendor/financial intermediary transmitted (A) basic information including a firm identifier (name, account number, etc.), (B) a series of 5,000 relational pairs representing individual home price-pegged accounts [(#13559, $456.23, U.S.), (#25656, $89,432.34, Reno, Nev.), . . . ], (C) a preferred form of obligation [a collateralized debt obligation (CDO)], (D) a preferred maximum term [10 years or 120 months], (E) a minimum fixed interest rate of 0% [meaning the third party vendor/financial intermediary wants a fixed return equal to principal plus some variable return pegged to home appreciation loan assets].

General Step Two—The third party vendor/financial intermediary is qualified using internal database records or external database information.

General Step Three—The home appreciation loan lender accesses a database with records of previous third party vendor/financial intermediary counterparties. If this third party vendor/financial intermediary is a repeat counterparty then the home appreciation loan lender accesses all records of existing financial securities based in whole or in part upon home appreciation loan assets. The third party vendor/financial intermediary might be asked to specify whether they would be willing to exchange such existing securities or financial instruments as part of the transaction. If so then all subsequent processes could include relational pairings for the home appreciation loan assets underlying those securities or financial instruments as well. Similarly, a third party vendor/financial intermediary might seek portfolio rebalancing services without lending net additional funds to the home appreciation loan lender.

General Step Four—A series of processes are executed to determine whether the home appreciation loan lender can make use of the offered funds. An amount is determined equal to the maximum amount the home appreciation loan lender will accept.

General Step Five—A series of processes are executed to determine how closely the returns on the offered funds can be correlated to home price indices changes for each individual relational pair and the aggregation of all funds offered. The result is a categorization into three groups: (1) correlation within the ordinary course of lending, (2) correlation with targeted lending, and (3) funds that cannot be correlated to the exact geographic region specified. This information may be displayed as explained in section “Process #2” below and the third party vendor/financial intermediary may be asked to respond as explained in “Input #2” below.

Process #2 (FIG. 18)

I. Display of Maximum Acceptable Loan & Extent of Possible Correlation 660

I. Ratio Calculation 662—Using the database records created in the processes above and retrieved from prior transactions, aggregate ratios are calculated for each of the correlation categories.

For the funds that can be correlated in the ordinary course: RATIO_STD_CORE=ALLOCATED_STD_CORE_FUNDS/MAX_ACCEPT_LOAN.

For the funds that can be correlated with targeted lending: RATIO_ALT_CORE=ALLOCATED_ALT_CORE_FUNDS/MAX_ACCEPT_LOAN.

For the funds that cannot be correlated to the exact specified region: RATIO_NO_CORE=ALLOCATED_NO_CORE_FUNDS/MAX_ACCEPT_LOAN.

II. Display—This process displays: (1) the maximum amount of loan acceptable to the home price loan lender [MAX_ACCEPT_LOAN]; and (2) the extent of possible correlation as represented by the nominal amount and percentage of the maximum loan amount attributable to each of the three correlation categories. This display could be offered to the third party vendor/financial intermediary as described below in the section labeled “Input #2” or it might be used only internally and stored in a database. A possible display might appear as follows:

| MAXIMUM | | | | | | |
|---|---|---|---|---|---|---|
| ACCEPTABLE | CORRELATED IN | | CORRELATED WITH | | | |
| LOAN | ORDINARY COURSE | | TARGETED LENDING | | NOT CORRELATED | |
| AMOUNT | AMOUNT | RATIO | AMOUNT | RATIO | AMOUNT | RATIO |
| [MAX_{—} | [ALLOCATED_{—} | [RATIO_{—} | [ALLOCATED_{—} | [RATIO_{—} | [ALLOCATED_{—} | [RATIO_{—} |
| ACCEPT_{—} | STD_CORE_{—} | STD_{—} | ALT_CORE_{—} | ALT_{—} | NO_{—} | NO_{—} |
| LOAN] | FUNDS] | CORE] | FUNDS] | CORE] | CORE_FUNDS] | CORE] |
| $5,000,000 | $4,500,000 | 90.0% | $400,000 | 8.0% | $100,000 | 2.0% |

III. Purpose of Distinguishing Categories—The home appreciation loan lender might choose to offer different loan terms based upon the allocation of the funds among the three categories. For example, a premium might be charged for amounts used in the category requiring targeted home appreciation lending (and thus more favorable terms to home appreciation borrowers; worse for the lender). Such discriminatory pricing mechanisms are utilized in separate processes at the discretion of the home appreciation loan lender.

Input #2 (FIG. 19)

I. Input of Correlation Preferences 680

i. Possible Input of Correlation Preferences—A third party vendor/financial intermediary might be presented with a chart and/or graph containing the data in the chart above. The third party vendor/financial intermediary might be given a choice of excluding some or all of the relation pairings from the transaction based upon a correlation threshold. For example, the third party vendor/financial intermediary might specify that only relational pairings with 95% or more of the GEO_LINK_AMT falling into the two correlated categories should be included in the transaction. The third party lender might also specify that all relational pairings be included in the transaction, but that portion of each relational pairing loan share falling in either the targeted lending [ALLOCATED_ALT_CORE_FUNDS] or no exact correlation [ALLOCATED_NO_CORE_FUNDS] categories be excluded. Any and all such combinations are within the scope of the claims.

Process #3 (FIG. 20)

I. Geographic Matching Process 690

i. Stage in Process≦At this point in the overall process, a full and complete database has been populated with data pertaining to the overall loan amount and the specific division of the total loan amount among individual geographically-pegged relational pairs. If the option is provided to the third party vendor/financial intermediary to exclude certain classes of individual relational pairs based upon the associated correlation probabilities, such screening and exclusion has taken place in a separate process. The relevant data set now includes only those individual relational pairing of amounts and geographic specifications that in the aggregate constitute the total loan amount.

ii. Ordering of Relational Pairs Process—The relational pairs in the database are ordered from most specific geographic specification to most general. For example, one possible ordering would be: (1^{st}) All zip code-pegged records, (2^{nd}) All city-pegged records, (3^{rd}) All metropolitan area-pegged records, (4^{th}) All county-pegged records, (5^{th}) All state-pegged records, (6^{th}) All multi-state region-pegged records, (7^{th}) All United States-pegged records, (8^{th}) All continent-pegged records, (9^{th}) All multinational political block-pegged records, followed by (10^{th}) All globally-pegged records. This is but one possible application of. All other geographic orderings are possible, and this one serves merely for illustrative purposes.

iii. Pooling of Existing and Expected Home Appreciation Loan Assets Process—All pre-existing and expected (within the TIME_TO_MATCH or ALT_TIME_TO_MATCH as applicable) home appreciation loan assets are pooled by the geographic classifications established in the previous step, creating an aggregate pool for each geographic or geopolitical region equal to a set nominal value [GEO_POOL_REGION_AMT].

iv. Overflow of Pooled Accounts Process—When the size of the pool for each categorization is smaller than necessary to accommodate the amount of funds attributed to the specific category, the excess amount is carried over to the next most specific categorization with the more specific categorization representing a geographic subdivision of the next category. For example, if $3,000,000 where pegged to the zip code 89052, but the home appreciation loan lender had only $2,000,000 in home appreciation assets appropriately correlated to zip code 89052 then $1,000,000 would overflow to the next most specific categorization available. In this example, this might be represented by the city of Henderson, Nev., which contains all of zip code 89052. This process continues until the entire loan amount has been matched as closely as possible to the specified geographic area.

V. Database Recordation—Each individual relational pair is flagged with its relevant assigned geographic categorization. A geographical categorization variable [GEO_CAT_LOAN] is recorded for each pair [GEO_CAT_PAIR]. Similarly, any existing home appreciation loan asset that is to be exchanged in the transaction is flagged and a record is created to reflect any deficit in the pooled home appreciation asset class that is expected to be filled within the TIME_TO_MATCH or ALT_TIME_TO_MATCH with newly originated or acquired home appreciation loan assets.

II. Maximum Geographic Diversification of Funds Process 710

i. Geographic Diversification—Within each of the geographic pools established in the previous process [all loans with the same GEO_CAT_LOAN], the home appreciation loan assets are bundled or securitized so as to achieve maximum geographical diversification within the specified zone. This can be accomplished using global positioning markers and a process to maximize the aggregate distance between all homes underlying the home price loan appreciation assets or through a simpler mechanism of allocating by grids within the specified geographic area.

III. Determination of Loan Structure Process 720

i. Stage in Process—At this point in the process, the size of the loan [MAX_ACCEPT_LOAN] has been determined and a geographic matching process has been executed to find home appreciation loan assets that are geographically-correlated with the geographical regions specified for subamounts as delineated in the relational pairings originally transmitted by the third party vendor/financial intermediary and/or retrieved from an existing database based upon previous transactions. The assets have been ranked ordered in terms of their geographic suitability. Within the equally suitable category of pooled home appreciation loan assets, a process was run to maximize the diversification of those assets.

ii. Purpose—Now, a loan or loan-like financial product meeting the specifications transmitted by the third party vendor/financial intermediary as to maturity [MATURITY], amount [MAX_ACCEPT_LOAN], geographic correlation of returns [relational pairings of GEOGRAPHY and GEO_LINK_AMT], and all other inputted characteristics must be created using the underlying home appreciation loan assets identified and categorized above.

iii. Components of the Identified/Matched “Home Appreciation Loan Assets”—The identified or matched “home appreciation loan assets,” which together represent the assets transferred to the home appreciation lender when originating a single home appreciation loan, includes two principal components:

(1) Component 1: Fixed Balance—the fixed repayment balance [FIXED_BALANCE] (which essentially compensates for termination of the loan because of transfer or sale prior to β, and

(2) Component 2: Home Price Appreciation Participation—the home price appreciation interest [X %].

Both principal components of the home appreciation loan are pegged to the geographic zone identified upon origination of the home appreciation loan. The following chart depicts part of a database containing records of currently held bundles of “home appreciation loan assets.” Note this database or a separate database could be populated with shadow records, which essentially are used to flag future home appreciation loans made within the TIME_TO_MATCH or ALT_TIME_TO_MATCH.

HOME APPRECIATION LOAN RECORDS DATABASE

| | | | | | “HOME APPRECIATION LOAN | |
|---|---|---|---|---|---|---|
| | | | CURRENT | ORIGINAL | ASSETS” | |
| | ISSUANCE | | ESTIMATE | FMV UPON | FIXED | HOME PRICE |
| | DATE | | OF VALUE | ISSUANCE | BALANCE | APPRECIATION |
| UNIQUE | [LOAN_{—} | | [CURRENT_{—} | [ACCEPTED_{—} | [FIXED_{—} | PARTICIPATION |
| IDENTIFIER | DATE] | ADDRESS | EST_FMV] | FMV] | BALANCE] | [X %] |

| | | | | | |
|---|---|---|---|---|---|
| Record # | Date | Address | $$$ | $$$ | Linked to Loan Schedule |
| | | | | | Record Below |

| NO. | | |
|---|---|---|
| OF MONTHS | | |
| SINCE LOAN | FIXED REPAYMENT | |
| GRANTED | OF PRINCIPAL | SHARED |
| [MONTH] | [FIXED_BALANCE] | APPRECIATION |
| 0 | Nominal Loan Amount | X % of Home Appreciation |
| | [LOAN_AMT] | |
| 1 | Current Fixed Repayment | X % of Home Appreciation |
| | Balance [function (LOAN_{—} | |
| | Balance EXPECTED_{—} | |
| | APPRECIATON)] | |
| 2 | Current Fixed Repayment | X % of Home Appreciation |
| | Balance [function (LOAN_{—} | |
| | AMT, EXPECTED_{—} | |
| | APPRECIATON)] | |
| ↓ | ↓ | ↓ |
| β | $0 | X % of Home Appreciation |
| β + 1 | $0 | X % of Home Appreciation |
| β + 2 | $0 | X % of Home Appreciation |
| ↓ | ↓ | ↓ |
| Month of | $0 | X % of Home Appreciation |
| Termination | | |
| Event | | |

iv. Calculation of Month Since Loan Granted—A process compares the current date [TODAY_DATE] to the loan issuance date [LOAN_DATE] to calculate the number of months since the loan was granted [MONTH].

v. Calculation of Current Estimate of Value—CURRENT_EST_FMV is calculated in the same manner as above as part of the home appreciation loan origination/generation process.

vi. Determination of the Structure—First, a process is run to as closely as possible match the requirements of the loan through a pure “bundling” of the existing assets. Second, a process could be run to alter the features of the pure bundled collection of home appreciation loan assets by consolidating them with other financial instruments or derivative instruments into a new security (“securitization”). Both of these processes are described in detail below.

IV. Bundling Process 750

i. Stage in Process—Using the processes above, sets of home appreciation loan assets were identified as suitable for inclusion in this bundled or securitized financial instrument (as a function of ADDRESS, LOAN_AMT, X %, β, and other home appreciation loan characteristics). The components of a single home appreciation loan could be unbundled and rebundled in various ways. For example, a security could be created with only fixed balance interests or only home price appreciation interests. The number of combinations is infinite. Such alternative unbundling and rebundling is an alternative, but for descriptive purposes it is assumed that an entire set of the two principal home appreciation loan components (the fixed balance and home price appreciation components) are combined with other entire sets to form a financial instrument.

ii. Bundling Process—Particular sets of home appreciation loan assets have been flagged by the processes above for inclusion in the new financial instrument. A process is executed to create a database of all previously flagged home appreciation loan assets (or shadow assets for expected future home appreciation loan lending within the TIME_TO_MATCH or ALT_TIME_TO_MATCH).

The process proceeds through the list of flagged home appreciation loan assets [all included loans with the matching GEO_CAT_LOAN value] until the sum of the current estimate FMV of the underlying homes [CURRENT_EST_FMV] of all the included asset sets equals the aggregate nominal value set for the same geographical region [GEO_POOL_REGION_AMT]. Once the sum equals or exceeds the nominal value of assets needed to be correlated to the target region then this process stops (the final bundle of loan assets might be included in whole, included in part, or excluded) and proceeds to the next geographical or geopolitical region.

Once this process has been executed for all regions flagged for correlation as part of the relational pairings transmitted by the third party vendor/financial intermediary or determined in one of the processes above, the bundling process terminates.

Result—A database of home appreciation loan assets (here, fixed balances and home price appreciation interests in tandem) to be included in the financial security has been populated. Such a database might appears as follows:

HOME APPRECIATION LOAN ASSETS FLAGGED FOR INCLUSION IN NEW FINANCIAL
INSTRUMENT

| | | | | ORIGINAL | “HOME APPRECIATION | |
|---|---|---|---|---|---|---|
| | | | CURRENT | FMV | LOAN ASSETS” | |
| | ISSUANCE | | ESTIMATE | UPON | FIXED | HOME PRICE |
| | DATE | | OF VALUE | ISSUANCE | BALANCE | APPRECIATION |
| UNIQUE | [LOAN_{—} | | [CURRENT_{—} | [ACCEPTED_{—} | [FIXED_{—} | PARTICIPATION |
| IDENTIFIER | DATE] | ADDRESS | EST_FMV] | FMV] | BALANCE] | [X %] |
| Record # | Date | Address | $$$ | $$$ | $$$ | X % |

iii. Evaluation of the Bundled Home Appreciation Loan Portfolio Process—A process may then be executed to determine whether, according to standards set by the home appreciation loan lender, other forms of financial securities or derivative instruments should be added to the “bundled” home appreciation loan assets through a “securitization” process as described below.

iv. Alternative Use of Same “Bundling” Process—This same bundling process could be used to create a bundle of geographically-pegged home appreciation loan assets based upon only the inputting of relational pair data without a proposed cash transfer amount (that is, without specifying the maximum value of any immediate exchange or loan grant). The expected value of the bundled home appreciation loan could be calculated in a separate process. The home appreciation loan lender might demand the transfer of a premium or fee [BUNDLING_FEE] in addition to the transfer of assets (cash or other assets) with an expected value equal to the bundled home appreciation loan assets. These alternative processes are also possible, but for purposes of the description below they are omitted.

V. Securitization Process 770

i. Securitization Process—When utilized, this process consolidates the existing “bundle” of home appreciation loan assets with other forms of financial securities or derivative instruments so as to alter the return or risk characteristics of the aggregated assets. These additional instruments are added to the database of bundled home appreciation loan assets.

Example: Compensating Interest Rate—For example, such additional instruments might include a guarantee of a stream of fixed payments in addition to the collection of home appreciation participations, thus constituting a compensating fixed interest rate component [COMP_RATE] of a securitized asset. This may be required if the third party vendor/financial intermediary specified a minimum acceptable fixed interest rate [MIN_FIXED_RATE] and a process determines that the expected variable interest rate formed as an aggregate of the equity participation interests and fixed balance payments is below this rate. Another process might include a compensating rate through the consolidation of other financial instruments or guarantees so as to bring the total expected interest rate of the newly created financial instrument in line with market interest rates. All such alteration processes are possible alternatives and those specified are merely included to serve as illustrations of possible components.

Example: Alteration of Financial Characteristics Through Inclusion of Home Price Derivative Instruments—The “securitization” process might consolidate the “bundled” home appreciation loan assets with other instruments such as home price futures contracts that serve to fill in correlation gaps or alter other characteristics of the financial security so created. A record or series of records is added to the database to account for such included instruments [DERIVATIVES].

Example: Lump Sum Payment—The “securitization” process might consolidate the “bundled” home appreciation loan assets with a lump sum payment [LUMP_SUM], such as a cash payment equal to the nominal amount of the loan granted by the third party vendor/financial intermediary.

ii. Alternative Use of the “Securitization” Process—This same securitization process could be used to create a securitized instrument consisting of a bundle of geographically-pegged home appreciation loan assets and other financial or derivative instruments based upon only the inputting of relational pair data without a proposed cash transfer amount (that is, without specifying the maximum value of any immediate exchange or loan grant). The expected value of the securitized instrument is calculated in a separate process using basic financial calculations such as present value, internal rate of return, and net present value formulas. The home appreciation loan lender might demand the transfer of a premium or fee [SECURITIZATION_FEE] in addition to the transfer of assets (cash or other assets) with an expected value equal to the securitized instrument. These processes are possible alternatives, but for purposes of the description below they are omitted.

VI. Determination of Proposed Loan Terms Process 780

i. Stage in the Process—At this point, all of the parts of the financial instrument that the home appreciation loan lender will transfer to the third party vendor/financial intermediary have been determined and duly recorded in the database pertaining to this instrument. The various components that might be included as a result of the previous processes include (among others):

(1) “Home Appreciation Loan Assets”—represented by one or more geographically-pegged fixed balances [FIXED_BALANCE] and/or home price appreciation interests [X %].

(2) Stream of Cash Payments representing additional payment guarantees that could be as simple as one lump-sum payment of principal or part of principal [LUMP_SUM] or relatively complex streams of interest payments representing a compensating interest rate [COMP_RATE].

ii. Calculation of Expected Value of Newly Created Financial Instrument Process—A process is run to calculate the expected value of the entire financial instruments with the component parts outlined above. The expected value of the “home appreciation loan assets” is calculated as a function of the loan characteristics in the same manner as outlined above when determining the home appreciation loan terms. The expected value of the stream of cash payments is calculated using standard financial metrics like present value, internal rate of return, and net present value formulas. The total expected value of the newly created instrument [FIN_INSTRUMENT_EXP_VALUE] is equal to the sum of these expected values.

iii. Comparison of Expected Value of Financial Instrument and Loan Amount Process—The home appreciation loan lender does not wish to transfer a newly created financial instrument with an expected value exceeding the amount of funds received as part of the loan from the third party vendor/financial intermediary. In addition, the home appreciation loan lender may demand some return spread value [SPREAD_VALUE] (as calculated in a separate process as a function of the component characteristics, geographic correlation characteristics, and other variables from the processes above, and certain other derived variables) between the value of the financial instrument transferred and the amount of funds received [TOTAL_LOAN_AMT]. A process is executed that reduces COMP_RATE and/or LUMP_SUM by a set numerical value [Δ] (equal to $0.01 for LUMP_SUM and 0.0000001% for COMP_RATE) until the financial instrument's expected value equals the sum of the total loan amount and spread value. COMP_RATE is thus set at a sufficiently low value, though at minimum equal to MIN_FIXED_RATE. If the MIN_FIXED_RATE is hit before sufficient adjustment then LUMP_SUM is reduced by A until sufficient adjustment is made. If COMP_RATE is reduced to MIN_FIXED_RATE and LUMP_SUM to $0 and sufficient adjustment has not occurred then this is reported to the third party vendor/financial intermediary and they are asked to either allow COMP_RATE to fall below MIN_FIXED_RATE or input other data in one of the processes above.

Initial Step—Loop (If FIN_INSTRUMENT_EXP_VALUE#≠TOTAL_LOAN_AMT+SPREAD_VALUE Then (If COMP_RATE>MIN_FIXED_RATE Then COMP_RATE=COMP_RATE−Δ Else If LUMP_SUM>$0 Then LUMP_SUM=LUMP_SUM−Δ) Until (1) FIN_INSTRUMENT_EXP_VALUE=TOTAL_LOAN_AMT+SPREAD_VALUE or (2) COMP_RATE=MIN_FIXED_RATE and LUMP_SUM=$0.

After Completion of Initial Step—If FIN_INSTRUMENT_EXP_VALUE≠TOTAL_LOAN_AMT+SPREAD_VALUE Then Run Alert and New Input Request Process (as described above).

VII. Display of Potential Geographic Correlation & Proposed Loan Terms 800

i. Stage in the Process—At this point, all of the parts of the financial instrument that the home appreciation loan lender will transfer to the third party vendor/financial intermediary have been determined and duly recorded in the database pertaining to this instrument. A process has been executed to adjust the components of the newly created financial instrument [COMP_RATE and LUMP_SUM] in accordance with a return spread value [SPREAD_VALUE] specified by the home appreciation loan lender.

ii. Calculation of Correlated Equity Base Process—A process is executed which sums the individual amount of base equity interest [CURRENT_EST_FMV] to which the home price appreciation participation is pegged, producing the total amount of home equity interest to which the home price return is pegged [TOTAL_EQUITY_BASE].

TOTAL EQUITY_BASE=Sum (CURRENT_EST_FMV for each Unique Included Home Appreciation Loan Assets Identifier #).

iii. Calculation of Correlated Average Appreciation Interest Process—A process is executed which calculates the mean home price appreciation participation percentage [MEAN_PART %] associated with the entire aggregated equity base value [TOTAL_EQUITY_BASE]. The mean home price appreciation participation percentage is equal to the weighted average (by equity base of the individual set of home appreciation loan assets) of all individual equity participation interests [X %] associated with each individual set of home appreciation loan assets included in the new financial instrument.

MEAN_PART %=Weighted Average (X % for each Unique Included Home Appreciation Loan Assets Identifier #).

iv. Display of Terms—A summary of the proposed loan terms and characteristics is then presented to the third party vendor/financial intermediary in the form of an exchange summary 802 for review. One possible variant of this exchange summary appears as follows:

EXCHANGE SUMMARY

| | | | | | HOME PRICE CORRELATED | |
|---|---|---|---|---|---|---|
| | | | FIXED | | PORTION | |
| | | | INTEREST | FIXED | TOTAL | WEIGHTED |
| | | LUMP SUM | RATE DUE | INTEREST | EQUITY | AVERAGE HOME |
| | | DUE AT | AT | RATE DUE | BASE | PRICE |
| | | MATURITY | MATURITY | ANNUALLY | [TOTAL_{—} | APPRECIATION |
| LOAN | TERM | [LUMP_{—} | [COMP_{—} | [COMP_{—} | EQUITY_{—} | PARTICIPATION |
| AMOUNT | [MATURITY] | SUM] | RATE_1] | RATE_2] | BASE] | [MEAN_PART %] |
| $$$ | No. Months | $$$ | % | % | $$$ | MEAN_PART % |
| | (or | | | | | |
| | revolving) | | | | | |

INCLUDED HOME APPRECIATION LOAN ASSETS

| | | | CURRENT | | “HOME APPRECIATION LOAN | |
|---|---|---|---|---|---|---|
| | | | ESTIMATE | ORIGINAL | ASSETS” | |
| | ISSUANCE | | OF VALUE | FMV UPON | FIXED | HOME PRICE |
| | DATE | | OF HOME | ISSUANCE | BALANCE | APPRECIATION |
| UNIQUE | [LOAN_{—} | AD- | [CURRENT_{—} | [ACCEPTED_{—} | [FIXED_{—} | PARTICIPATION |
| IDENTIFIER | DATE] | DRESS | EST_FMV] | FMV] | BALANCE] | [X %] |
| Record # | Date | Address | $$$ | $$$ | $$$ | X % |
| Record # | Date | Address | $$$ | $$$ | $$$ | X % |
| ↓ | ↓ | ↓ | ↓ | ↓ | ↓ | ↓ |
| Record # | Date | Address | $$$ | $$$ | $$$ | X % |

Input #3 (FIG. 21)

I. Selection of Proposed Terms or Input of Alternative Data 830

i. Acceptance or Return to Enter New Inputs—After reviewing the exchange summary, the third party vendor/financial intermediary is presented with an opportunity to accept the proposed exchange terms or to return to an earlier stage in the process and enter different inputs. If the terms are accepted then Process #4 commences.

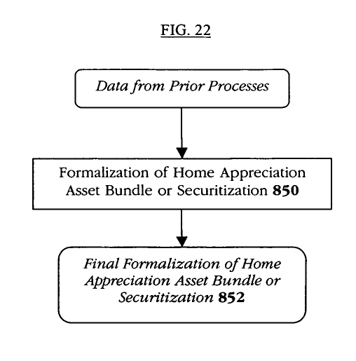

Output (FIG. 22)

I. Formalization of Home Appreciation Loan Asset Bundle or Securitization 850

i. Final Documentation—A final, formal version of the third party vendor/financial intermediary and home appreciation loan lender approved exchange agreement 852 is produced.

(B) Home Appreciation Lender-Initiated Process & Creation of a Standard Financial Instrument 22000 (FIG. 1)

Process Overview—This general process involves the pooling of existing or expected home appreciation loan assets into financial instruments with certain marketable characteristics.

Purpose of Certain Subprocesses—A geographic testing process is needed in order to determine whether the home appreciation loan lender has or will have sufficient home appreciation loan assets to create a standard financial instrument targeted at a specified geographic zone. This might also be executed as part of a larger process that begins with the narrowest recorded zone (perhaps being a zip code or neighborhood) and continuing to the broadest zone (perhaps being a country or the global). If the geographic testing process determines that sufficient assets do exist within the selected geographic zone then a separate process is executed to bundle those flagged assets into a financial instrument with returns pegged to the zone. An additional evaluative step may be run, which may trigger a “securitization” process that combines the bundled home appreciation loan assets with other guarantees, financial instruments, or derivative instruments so as to modify the return characteristics. This additional step is generally performed when geographic gaps or other undesirable characteristics exist with the simple bundle and the “securitization” process would enhance marketability of the new financial instrument.

Steps in Process

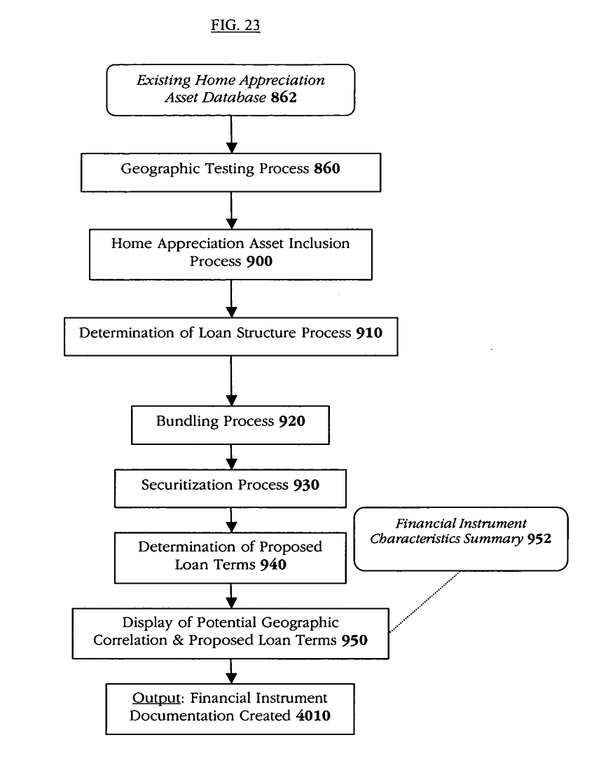

I. PROCESS #1: Geographic Testing Process; Home Price Appreciation Asset Inclusion Process; Determination of Loan Structure Process; Bundling Process; Securitization Process; Determination of Proposed Loan Terms Process; and Display of Potential Geographic Correlation & Proposed Loan Terms 4000 (FIG. 23)

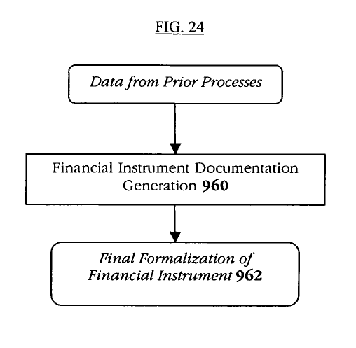

II. OUTPUT: Financial Instrument Documentation Generation 4010 (FIG. 24)

Definition of Inputs, Outputs, and Other Variables

#=A unique identifier.

ACCEPT_MAX_EQUITY_BASE=Maximum acceptable TOTAL_EQUITY_BASE as specified by the home appreciation loan lender.

ACCEPT_MIN_EQUITY_BASE=Minimum acceptable TOTAL_EQUITY_BASE as specified by the home appreciation loan lender.

ACCEPTED_FMV=Fair market value of home accepted for use in loan term calculations.

ADDRESS=Address of home appreciation loan borrower's home.

ALT_TIME_TO_MATCH=Time specified by lender within which modified lending match must be expected.

β=Number of months after loan granted until fixed repayment balance [FIXED_BALANCE] equals $0. After β months, the outstanding fixed repayment balance is $0 and the lender is only entitled to X % of the home price appreciation.

COMP_RATE=Compensating fixed interest rate.

CURRENT_EST_FMV=Estimate of current FMV based on statistical, actuarial, demographic, and other accurate forms of price analysis, as of day of testing subsequent to loan grant.

DERIVATIVES=Database records pertaining to any financial derivatives consolidated with bundled home appreciation loan assets in the “securitization” process.

EXPECTED_APPRECIATION=Nominal amount of predicted home price appreciation.

FIXED_BALANCE=Portion of repayment that is predetermined and set forth in the loan schedule.

LOAN_AMT=Nominal value of home appreciation loan granted.

LOAN_DATE=Home appreciation loan issuance date.

LUMP_SUM=Lump sum payment.

MATURITY=Maturity of the new financial instrument.

MEAN_PART %=Mean home price appreciation participation interest percentage.

MIN_UNIQUE_LOANS=Minimum number of unique underlying home appreciation loans as specified by the home appreciation loan lender.

MONTH=Number of months following the grant of the home appreciation loan.

SPREAD_VALUE=Explicit and/or implicit rate factored into exchange terms as specified by the home appreciation loan lender.

TARGET_ZONE=Specific targeted geographic area.

TIME_TO_MATCH=Time specified by lender within which natural match must be expected.

TOTAL_EQUITY_BASE=Total value of homes to which all X % included in the new financial instrument are pegged.

X %=Percentage of home price appreciation shared by the lender.

Process #1 (FIG. 24)

I. Geographic Testing Process 860

i. Stage in Process—At the outset, the home appreciation loan lender has existing database 862 that contains records of all home appreciation loan assets acquired through home appreciation loan origination or some other transaction and those still in the home appreciation loan lender's possession. These assets are geographically-pegged and can be variously categorized as a function of the underlying home's address [ADDRESS] as recorded in a home appreciation loan records database. Such an existing database might look as follows:

HOME APPRECIATION LOAN RECORDS DATABASE

| | | | | | “HOME APPRECIATION LOAN | |
|---|---|---|---|---|---|---|
| | | | CURRENT | ORIGINAL | ASSETS” | |
| | ISSUANCE | | ESTIMATE | FMV UPON | FIXED | HOME PRICE |
| | DATE | | OF VALUE | ISSUANCE | BALANCE | APPRECIATION |
| UNIQUE | [LOAN_{—} | | [CURRENT_{—} | [ACCEPTED_{—} | [FIXED_{—} | PARTICIPATION |
| IDENTIFIER | DATE] | ADDRESS | EST_FMV] | FMV] | BALANCE] | [X %] |

| | | | | | |
|---|---|---|---|---|---|
| Record # | Date | Address | $$$ | $$$ | Linked to Loan Schedule |
| | | | | | Record Below |

| NO. | | |
|---|---|---|
| OF MONTHS | | |
| SINCE LOAN | FIXED REPAYMENT | |
| GRANTED | OF PRINCIPAL | |
| [MONTH] | [FIXED_BALANCE] | SHARED APPRECIATION |
| 0 | Nominal Loan Amount | X % of Home Appreciation |
| | [LOAN_AMT] | |
| 1 | Current Fixed | X % of Home Appreciation |
| | Repayment Balance | |
| | [function (LOAN_AMT, | |
| | EXPECTED_{—} | |
| | APPRECIATON] | |
| 2 | Current Fixed | X % of Home Appreciation |
| | Repayment Balance | |
| | [function (LOAN_{—} | |
| | AMT, EXPECTED_{—} | |
| | APPRECIATON] | |
| ↓ | ↓ | ↓ |
| β | $0 | X % of Home Appreciation |
| β + 1 | $0 | X % of Home Appreciation |
| β + 2 | $0 | X % of Home Appreciation |
| ↓ | ↓ | ↓ |
| Month of | $0 | X % of Home Appreciation |
| Termination | | |
| Event | | |

ii. Geographic Testing Process—The process begins with either the inputting, or automatic triggering and inputting as part of a larger process, of a specific targeted geographic zone [TARGET_ZONE]. A process is executed which examines the ADDRESS for the set of home appreciation loan assets. If the ADDRESS falls within the TARGET_ZONE then the record is flagged. After all home appreciation loan assets are scanned, the flagged home appreciation loan assets are used to populate a new database for possible inclusion in a new financial instrument.

iii. Calculation of Current Estimate of Value—CURRENT_EST_FMV is calculated in the same manner as above as part of the home appreciation loan origination/generation process.

iv. Calculation of Correlated Equity Base—A process is executed which sums the individual amount of base equity interest [CURRENT_EST_FMV] to which the home price appreciation participation is pegged, producing the total amount of home equity interest to which the home price return is pegged [TOTAL_EQUITY_BASE].

TOTAL_EQUITY_BASE=Sum (CURRENT_EST_FMV for each Unique Included Home Appreciation Loan Assets Identifier #).

v. Calculation of Correlated Average Appreciation Interest—A process is executed which calculates the mean home price appreciation participation percentage [MEAN_PART %] associated with the entire aggregated equity base value [TOTAL_EQUITY_BASE]. The mean home price appreciation participation percentage is equal to the weighted average (by equity base of the individual set of home appreciation loan assets) of all individual equity participation interests [X %] associated with each individual set of home appreciation loan assets included in the new financial instrument.

MEAN_PART %=Weighted Average (X % for each Unique Included Home Appreciation Loan Assets Identifier #).

vi. Determination of Minimum Acceptable Assets—The home appreciation loan lender may choose to specify minimum acceptable characteristics of the flagged home appreciation assets necessary for a new financial instrument to be created. Such a process could screen for (1) an acceptable minimum number of unique records [MIN_UNIQUE_LOANS], (2) minimum equity base (equals sum of all CURRENT_EST_FMV) [ACCEPT_MIN_EQUITY_BASE], or (3) other criteria recorded as part of the existing database or derivable through basic mathematical processes. If the actual characteristics of the flagged home appreciation asset pool satisfy the minimum requirement then the processing continues. Otherwise, this process terminates and a notification is transmitted and/or recorded.

II. Home Price Appreciation Asset Inclusion Process 900

i. Determination of Maximum Acceptable Assets or Inclusion Based Upon Other Characteristics—The home appreciation loan lender may choose to specify maximum acceptable characteristics of the flagged home appreciation assets, limiting their inclusion in the new financial instrument. A process could be executed which takes a home appreciation loan lender's maximum limit and records a second flag for those home appreciation loan assets (within the initially flagged group) that will be included in the new financial security. For example, the home appreciation loan lender might specify that the maximum home value base upon which the appreciation interests rest [ACCEPT_MAX_EQUITY_BASE] is $100,000,000. This process would select among the initially flagged assets until the actual equity base (equal to sum of all CURRENT_EST_FMV) equaled $100,000,000 exactly or within some margin of error specified as acceptable. This might involve taking a proportionate share of all initially flagged loans. Another such method would be to order the loan assets from greatest equity to smallest, flagging them in order until the maximum was hit. This process might also use historical lending data, historical price appreciation data, predicted lending data, predicted price appreciation data, or any other relevant data set to provide a second flag to the initially flag loans so as to create a subset (or new database) with certain desirable characteristics, which could include (among many others variants): (1) maximizing or minimizing projected returns, (2) risk-weighting metrics, (3) optimizing diversification within the targeted zone, (4) correlating the components positively or negatively, (5) ensuring regulatory compliance of the aggregation, and/or (6) tailoring the aggregation to appeal to particular targeted investment profiles (such as long-term investors, institutional investors, home price-pegged accountholders, first-time homebuyers, prospective retirees, etc.).

III. Determination of Loan Structure Process 910

i. Stage in Process—At this point in the process, all home appreciation loan assets that will be included in the newly created financial instrument have been selected and used to populate an inclusion database.

ii. Purpose—Now, a new financial instrument meeting the specifications provided by the home appreciation loan lender (or derived through a separate process based upon observable metrics from the market for such securities) is to be created. The critical characteristics of this newly created financial instrument could include any or all of the following: (1) the maturity [MATURITY] if there is a maturity separate from the natural maturity of the included assets, (2) the targeted geographic or geopolitical zone [TARGET_ZONE], (3) the underlying aggregate home equity base upon which the home appreciation interest is contingent [TOTAL_EQUITY_BASE], (4) the weighted average home price appreciation participation [MEAN_PART %], (5) a lump sum due at maturity or at a time prior to maturity [LUMP_SUM], (6) the fixed interest rate due at maturity or paid periodically [COMP_RATE]. In addition, the financial security's documentation could include the database records for each of the included home appreciation loan assets, including the fixed balance component [FIXED_BALANCE] and home price appreciation component [X %], among the other variables included in the record.

iii. Adjusting Terms Process—Some of the terms are either set as part of the fixed characteristics of the underlying home appreciation loan assets or where determined in the prior processes. These fixed characteristics include: (1) the targeted geographic or geopolitical zone [TARGET_ZONE], (2) the underlying aggregate home equity base upon which the home appreciation interest is contingent [TOTAL_EQUITY_BASE], and (3) the weighted average home price appreciation participation [MEAN_PART %]. The terms left for tailoring at this point include: (1) the maturity [MATURITY] if there is a maturity separate from the natural maturity of the included assets, (2) the amount, if any, of the lump sum due at maturity or at a time prior to maturity [LUMP_SUM], and (3) the fixed interest rate, if any, due at maturity or paid periodically [COMP_RATE]. The adjustment of these three terms is done through a “securitization” process, whereby the simple bundled home appreciation loan assets are combined with other financial instruments, derivative instruments, obligations, or guarantees so as to alter the characteristics of the aggregated consolidation.

IV. Bundling Process 920

i. Stage in Process—Using the processes above, home appreciation loan assets were identified as suitable for inclusion in this bundled or securitized financial instrument (as a function of ADDRESS, LOAN_AMT, X %, β, and the other recorded home appreciation loan characteristics). The components of a single home appreciation loan could be unbundled and rebundled in various ways. For example, a security could be created with only fixed balance interests or only home price appreciation interests. The number of combinations is infinite. Such unbundling and rebundling is a possible alternative, but for descriptive purposes it is assumed that an entire set of the two principal home appreciation loan components are combined with other entire sets to form a financial instrument.

ii. Bundling—Particular home appreciation loan assets have been flagged for inclusion in this new financial security. A process is executed to create a database of all such affected home appreciation loan assets (or shadow assets for expected future home appreciation loan appreciation with the TIME_TO_MATCH or ALT_TIME_TO_MATCH).

Result—A database of home appreciation loan assets (here, fixed balances and home price appreciation interests in tandem) to be included in the financial security has been populated. Such a database might appears as follows:

INCLUDED HOME APPRECIATION LOAN ASSETS

| | | | | | “HOME APPRECIATION LOAN | |
|---|---|---|---|---|---|---|
| | | | CURRENT | ORIGINAL | ASSETS” | |
| | ISSUANCE | | ESTIMATE | FMV UPON | FIXED | HOME PRICE |
| | DATE | | OF VALUE | ISSUANCE | BALANCE | APPRECIATION |
| UNIQUE | [LOAN_{—} | | [CURRENT_{—} | [ACCEPTED_{—} | [FIXED_{—} | PARTICIPATION |
| IDENTIFIER | DATE] | ADDRESS | EST_FMV] | FMV] | BALANCE] | [X %] |
| Record # | Date | Address | $$$ | $$$ | $$$ | X % |
| Record # | Date | Address | $$$ | $$$ | $$$ | X % |
| ↓ | ↓ | ↓ | ↓ | ↓ | ↓ | ↓ |
| Record # | Date | Address | $$$ | $$$ | $$$ | X % |

III. Evaluation of the Bundled Home Appreciation Loan Portfolio Process—A process may then be executed to determine whether, according to standards set by the home appreciation loan lender, other forms of financial securities or derivative instruments should be added to the “bundled” home appreciation loan assets through a “securitization” process as described below.

V. Securitization Process 930

i. Securitization Process—This process consolidates the existing “bundle” of home appreciation loan assets with other forms of financial securities or derivative instruments so as to alter the return or risk characteristics of the aggregated assets.

Example: Compensating Interest Rate—For example, such additional instruments might include a guarantee of a stream of fixed payments in addition to the collection of home appreciation participations, thus constituting a compensating fixed interest rate component [COMP_RATE] of a securitized asset. Another process might include a compensating rate through the consolidation of other financial instruments or guarantees so as to bring the total expected interest rate of the newly created financial instrument in line with market interest rates. All such processes are possible alternatives and those specified are merely included to serve as illustrations of possible components.

Example: Alteration of Financial Characteristics Through Inclusion of Home Price Derivative Instruments—The “securitization” process might consolidate the “bundled” home appreciation loan assets with other instruments such as home price futures contracts that serve to fill in correlation gaps or alter other characteristics of the financial security so created. A record or series of records is added to the database to account for such included instruments [DERIVATIVES].

Example: Lump Sum Payment—The “securitization” process might consolidate the “bundled” home appreciation loan assets with a lump sum payment [LUMP_SUM], such as a cash payment equal to the nominal amount of the loan granted by the third party vendor/financial intermediary.

VI. Determination of Proposed Loan Terms Process 940

i. Stage in the Process—At this point, all component parts of the new financial instrument have been identified and duly recorded in the database pertaining to this instrument.

ii. Implicit Term Modulation Process—The home appreciation loan lender may choose to include some additional return spread [SPREAD_VALUE] (as calculated in a separate process as a function of the component characteristics, geographic correlation characteristics, and other variables from the processes above, and certain other derived variables). A process is executed that reduces COMP_RATE and/or LUMP_SUM so as to account for this SPREAD_VALUE. For example, COMP_RATE could be set equal to COMP_RATE less the SPREAD_VALUE. This implicit modulation of terms is not necessary and the same compensation could be exacted explicitly through a fee, premium, or other contractual device.

VII. Display of Potential Geographic Correlation & Proposed Loan Terms 950

i. Display of Terms—A summary of the financial instruments terms and characteristics is recorded and documented for presentment to potential purchasers. One possible variant of this financial instrument characteristics summary 952 appears as follows:

FINANCIAL INSTRUMENT CHARACTERISTICS SUMMARY

| | | | | | | HOME PRICE CORRELATED | |
|---|---|---|---|---|---|---|---|
| | | | | FIXED | | PORTION | |
| | | LUMP SUM | | INTEREST | | TOTAL | |
| TARGETED | | DUE AT | | RATE DUE AT | | EQUITY | AVERAGE HOME |
| GEOGRAPH- | | SPECIFIED | | SPECIFIED | | BASE | PRICE |
| ICAL AREA | | TIME | | TIME | | [TOTAL_{—} | APPRECIATION |
| [TARGET_{—} | TERM | [LUMP_SUM] | | [COMP_RATE] | | EQUITY_{—} | PARTICIPATION |
| ZONE] | [MATURITY] | DATE | AMT | DATE | AMT | BASE] | [MEAN_PART %] |
| TARGET_ZONE | No. Months | Date | $$$ | Date | $$$ | $$$ | MEAN_PART % |
| | (or natural | ↓ | ↓ | ↓ | ↓ | | |
| | maturity) | Date | $$$ | Date | $$$ | | |

INCLUDED HOME APPRECIATION LOAN ASSETS

| | | | CURRENT | | “HOME APPRECIATION LOAN | |
|---|---|---|---|---|---|---|
| | | | ESTIMATE | ORIGINAL | ASSETS” | |
| | ISSUANCE | | OF VALUE | FMV UPON | FIXED | HOME PRICE |
| | DATE | | OF HOME | ISSUANCE | BALANCE | APPRECIATION |
| UNIQUE | [LOAN_{—} | | [CURRENT_{—} | [ACCEPTED_{—} | [FIXED_{—} | PARTICIPATION |
| IDENTIFIER | DATE] | ADDRESS | EST_FMV] | FMV] | BALANCE] | [X %] |
| Record # | Date | Address | $$$ | $$$ | $$$ | X % |
| Record # | Date | Address | $$$ | $$$ | $$$ | X % |
| ↓ | ↓ | ↓ | ↓ | ↓ | ↓ | ↓ |
| Record # | Date | Address | $$$ | $$$ | $$$ | X % |

Output (FIG. 24)

I. Financial Instrument Documentation Generation 960

i. Document Production—A document or set of documents 962 is produced, reflecting the new financial instrument's characteristics as described and generated in the processes above.

(C) Creation of Non-Pooled Home Price Contingent Financial Obligation 23000 (FIG. 5)

Process Overview—This general process involves the creation of home price change contingent financial instruments based upon certain contractually-specified home price indices or value change estimation metrics whether at the behest of a third party vendor/financial intermediary or as part of a process initiated by the home appreciation loan lender.

For example, a home appreciation loan lender might create a revolving loan agreement collateralized by home appreciation assets diversified throughout the United States with (i) a guaranteed repayment of the nominal value of a loan issued by the third party vendor/financial intermediary (e.g. $5,000,000 in principal) and (ii) a variable compensating interest rate that guarantees that the total annual interest rat e will equal the change in a home price index specified in the contract (change in contract-defined home price index for the U.S.) plus a fixed rat e specified in the contract (e.g. 2%).

Workings of the Example—In this example, each year the home appreciation lender would pay the third party vendor/financial intermediary an interest payment equal to (i) the percentage change in the contract-specified home price index for the U.S. (this value could be floored at zero or allowed to be negative) plus (ii) 2%. If the contract-specified home price index rose 4% over the relevant period then the total interest payment would be 6% of $5,000,000, or $300,000.

Illustration Below—For purposes of illustrating one such transaction, it is assumed that the home appreciation loan lender has initiated the process to create a non-pooled home price contingent financial obligation that possess the characteristics described in the example above. Alternative mechanisms might include a process that evaluates the existing portfolio of home appreciation loan assets and creates optimal non-pooled home price contingent financial obligations based upon those underlying available assets with or without consideration of market variables and/or metrics. Similarly, a third party vendor/financial intermediary might be asked to specify desired characteristics or transmit data that can be used to generate a custom-tailored non-pooled home price contingent financial obligation. All such methods and alternative mechanisms. The following description is but one illustrative example of this functional mechanism and set of processes.

Steps in Process

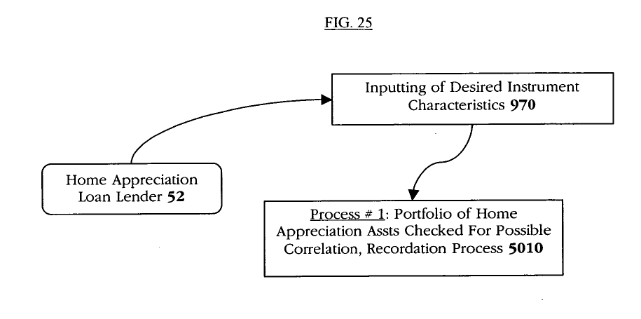

I. INPUT #1: Home Appreciation Loan Lender, Third Party/Financial Intermediary, or an Automatic Process Initiates the Process With a Data Transmission or Input 5000 (FIG. 25)

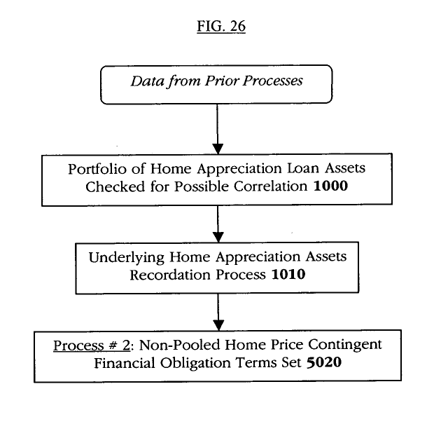

II. PROCESS #1: Portfolio of Home Appreciation Loan Assets Checked for Possible Correlation; Underlying Home Appreciation Loan Assets Recordation 5010 (FIG. 26)

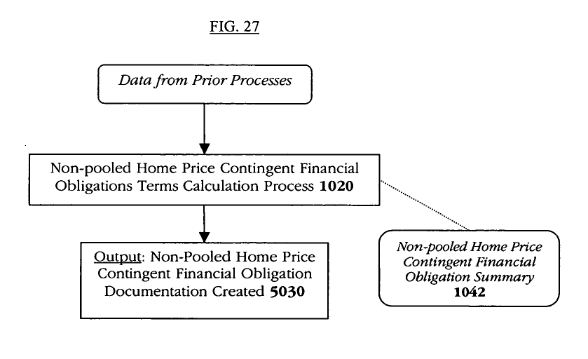

III. PROCESS #2: Non-pooled Home Price Contingent Financial Obligation Terms Calculated 5020 (FIG. 27)

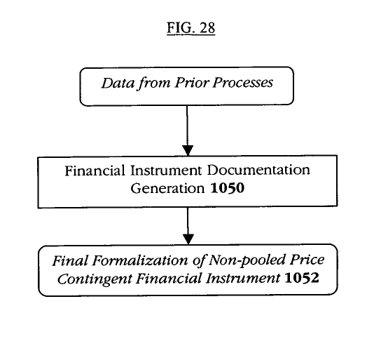

IV. OUTPUT: Non-pooled Home Price Contingent Financial Obligation Documentation Created 5030 (FIG. 28)

Definition of Inputs, Outputs, and Other Variables

HOME_PRICE_INDEX_IDENT=Informational variable that indicates the particular home price indices referenced in the obligation.

NONPOOL_PRINCIPAL=Guaranteed principal payment due upon maturity (if applicable).

NONPOOL_RATE_FIXED=Portion of the overall interest rate that is fixed.

NONPOOL_RATE_PEGGED=Portion of the overall interest rate that is derived mathematically in reference to the change in a specific geographic home price index.

NONPOOL_RATE_PREM=Portion of the overall interest rate that represents a premium that can be specified as desired.

NONPOOL_TERM=Obligation's term, which equals either a number of months or value signifying it is revolving (unlimited, redeemable, or callable).

Input #1 (FIG. 25)

I. Home Appreciation Loan Lender Inputs Desired Instrument Characteristics 970

i. Critical Components—The non-pooled home price contingent financial obligation or instrument has the following critical components: (1) the term [NONPOOL_TERM 974], which could be a number of months or revolving (unlimited, redeemable, or callable), (2) the guaranteed principal payment at maturity [NONPOOL_PRINCIPAL 976], and (3) the interest rate 978 which could be annual, quarterly, monthly, daily, or set according to any division of time.

Principal—The principal payment simply represents a lump sum transferred after the term has expired.

Interest Rate—The interest rate is formed as a combination of (1) a rate pegged to specific geographic home price indices [NONPOOL_RATE_PEGGED 980] (equal to the percentage change in that index) and (2) a fixed rate component [NONPOOL_RATE_FIXED 982] (which may be reduced by a home appreciation loan lender-specified (or calculated) premium [NONPOOL_RATE_PREM 984]).

Pegged Rate Component—If NONPOOL_RATE_PEGGED exceeds 0% then information pertaining to the home price indices referenced in the contract [HOME_PRICE_INDEX_IDENT 986] is stored as a new variable within the record. For purposes of this illustration, it is assumed that there is only one relevant home price index referenced and one associated rate equal to some function of the change in that index. It is also possible that multiple indices would be referenced with distinct rates associated with the change in each. NONPOOL_RATE_PEGGED would then equal the weighted average rate of these individual subcomponents.

Variations—Like all financial obligations, this one could include a highly particularized or irregular stream of payments with multiple lump sums paid at various dates, interest amortizing or being paid only during certain periods of the term, or possessing any other of the common financial obligation features. Similarly, other components could be included.

ii. Inputting of Desired Characteristics Process—The home appreciation loan lender might choose to input any or all of the characteristics or allow a pricing process to take the inputted variables and calculate the remaining according to minimum and maximum thresholds specified by the lender.

iii. Automatic Process—The home appreciation loan lender might alternatively, or concurrently, choose to utilize a process that scans the existing database of home appreciation loan assets (or shadow entries for expected assets) and automatically generates non-pooled home price contingent financial obligations once minimum lender specified thresholds are met. For example, the home appreciation loan lender might program this process to create a non-pooled home price contingent financial obligation with a term equal to the average historical maturity of home appreciation loan assets once the assets within a targeted zone exceeded a minimum underlying total equity base floor. The possible home appreciation loan lender specified standards are numerous based upon all the data collected in the earlier processes, market data that can be accessed from external networks, and data that can be generated as a function of these other variables. All such variations in spirit with this basic mechanism.

Process #1 (FIG. 26)

I. Portfolio of Home Appreciation Loan Assets Checked for Possible Correlation 1000

i. Automatic Process Bypass—If the automatic process was used to trigger creation of this obligation then the database of existing home appreciation loan assets has already been screened for acceptable correlation to the newly created obligation. If so, this process is bypassed and the operation proceeds to the recordation process. If not, this process commences.

ii. Correlation Checking Process—The home appreciation loan lender may choose to restrict non-pooled home price contingent financial obligation creation based upon its ability to offset these contingent liabilities with an existing or expected portfolio of home appreciation loan assets. The process evaluates the potential level of correlation possible to the targeted home price index (or indices) [HOME_PRICE_INDEX_IDENT]. This process is effectively the same as that described in detail above in the section labeled “Determination of Extent of Possible Geographic Correlation Process.” Only minor modifications within the spirit of that basic process are necessary. If the correlation checking process finds sufficient possible correlation within home appreciation loan lender specified standards between (1) the newly created home price contingent liability and (2) the existing or expected portfolio of home appreciation loan assets then the operation proceeds to the recordation process. If not, the process is terminated, the insufficiency is recorded, and/or the home appreciation loan lender is alerted to the problem.

II. Underlying Home Appreciation Loan Assets Recordation Process 1010

I. Updating Records of Home Appreciation Loan Portfolio—The database record of any underlying home appreciation loan assets that were used to satisfy the minimum sufficient correlation in the last process is flagged to reflect its usage in that process. This flag may be used in future correlation process checking or other operations to avoid overleveraging the same underlying home appreciation loan assets for separate home appreciation loan derived securities. The same type of process is run after all the transaction types described in this application to avoid such overleveraging.

Process #2 (FIG. 27)

I. Non-pooled Home Price Contingent Financial Obligation Terms Calculation Process 1020

i. Calculating Open Terms Process—If one of the critical terms of the non-pooled home price contingent financial obligation or instrument has not been specified or previously determined then a process is run to calculate this value in accordance with the specifications of the home appreciation loan lender or as a function of such specifications in conjunction with numerical processes utilizing information gathered above, stored in one of the lender's informational databases, or transmitted from an external information network (such data might include, for example, market interest rate data).

ii. Stage in the Process—At this point, all of the critical component terms of the new non-pooled home price contingent financial obligation or instrument have been determined, including: (1) the term [NONPOOL_TERM], (2) the guaranteed principal payments [NONPOOL_PRINCIPAL], and (3) the interest rate, which is equal to (i) a rate pegged to specific geographic or geopolitical home price indices [NONPOOL_RATE_PEGGED] plus (ii) a fixed rate component [NONPOOL_RATE_FIXED] (which may be reduced by a premium [NONPOOL_RATE_PREM]). Any associated home price index that has been referenced was recorded [HOME_PRICE_INDEX_IDENT]. The terms of the new non-pooled home price contingent financial obligation or instrument have been checked against the existing or expected portfolio of home appreciation loan assets to ensure minimum sufficient correlation. All necessary recordation has taken place. Formalization of the non-pooled home price contingent financial obligation or instrument is all that remains to be completed.

II. Display of Financial Obligation Terms 1040

i. Display of Terms—A summary of the financial obligation's terms and characteristics is recorded and documented for presentment to potential purchasers. One possible variant of this non-pooled home price contingent financial obligation summary 1042 appears as follows:

NON-POOLED HOME PRICE CONTINGENT FINANCIAL
OBLIGATION SUMMARY

| | | GURANTEED | HOME PRICE | |
|---|---|---|---|---|
| LINKED HOME | | PRINCIPAL | INDICES RETURN | |
| PRICE INDICES | TERM | PAYMENT | RATE | FIXED RATE |
| [HOME_PRICE_{—} | [NONPOOL_{—} | [NONPOOL_{—} | [NONPOOL_{—} | [NONPOOL_{—} |
| INDEX_IDENT] | TERM | PRINCIPAL | RATE_PEGGED] | RATE_FIXED] |
| Home Price Index | No. | $$$ | Δ% of Specified | % |
| Descriptor | Months (or | | Home Price Indices | |
| | other | | | |
| | maturity | | | |
| | descriptor) | | | |

Output (FIG. 28)

I. Financial Instrument Documentation Generation 1050

i. Document Production—A document or set of documents 1052 is produced, reflecting the financial instruments characteristics described and generated in the processes above.

User Interfaces

An example of user interface pages that would be seen and used by a home appreciation loan borrower is shown in FIGS. 31 through 51. Each of the figures could represent a page displayed in a web browser or information displayed to a borrower in some other way that permits user entry of information and control of the sequence of interaction. Similarly, an example of user interface pages that would be seen and used by a third party vendor/financial intermediary is shown in FIGS. 51 through 85.

Other features and implementations are also within the scope of the following claims. For example, In the case of securitization, the fixed payments would be in addition to the collection of home appreciation participations, thus constituting a compensating fixed interest rate component [COMP_RATE] of a securitized asset. This may be required if the third party vendor/financial intermediary specified a minimum acceptable fixed interest rate [MIN_FIXED_RATE] and a process determines that the expected variable interest rate formed as an aggregate of the equity participation interests and fixed balance payments is below this rate.

Another process might incorporate a compensating rate through the consolidation of other financial instruments or guarantees so as to bring the total expected interest rate of the newly created financial instrument in line with market interest rates. These combinations are included to serve as illustrations of possible components.

As one example: Alteration of Financial Characteristics Through Inclusion of Home Price Derivative Instruments—The “securitization” process might consolidate the “bundled” home appreciation loan assets with other instruments such as home price futures contracts that serve to fill in correlation gaps or alter other characteristics of the financial security so created. A record or series of records is added to the database to account for such included instruments [DERIVATIVES].

As another example: Lump Sum Payment The “securitization” process might consolidate the “bundled” home appreciation loan assets with a lump sum payment [LUMP_SUM], such as a cash payment equal to the nominal amount of the loan granted by the third party vendor/financial intermediary.

In general, there are numerous alternative timing sequences of the same basic process. Such processes can begin at any point and flow either from the lender or third party vendor/financial intermediary's first action.

Calculation or use of a compensating interest rate to make the returns on the bundles or securitizations of the home price appreciation assets attractive to market participants.

Further Division of Home Appreciation Loan Assets—The two primary components of “home appreciation loan assets” are the (1) fixed repayment balance and (2) home price appreciation participation interest. This can be further subdivided and any “bundling” or “securitization” of these subcomponents is also claimed.

All Distinct Types of Bundling or Securitization—The actual bundling or securitization process could take various forms within the basic spirit and operation of the processes claimed.

Creation of Tailored Pooled Financial Instruments—This general process involves transmission of data by the third party vendor/financial intermediary pertaining to the desired specifications of the financial instrument or security to be created.

Creation of Standard Pooled Financial Instruments—This general process involves the pooling of existing or expected home appreciation loan assets into financial instruments with certain marketable characteristics.

Creation of Hybrid Pooled Financial Instruments—This general process involves the pooling of existing or expected home appreciation loan asset bundles or securitized financial instruments with certain marketable financial characteristics. A home appreciation loan lender (at the behest of a third party vendor/financial intermediary or upon its own initiative) might create a new financial instrument by consolidating existing or expected bundles or securitizations of home price loan assets that were created through one or both of the prior methods.

Creation of Non-pooled Home Price Contingent Financial Obligations—This general process involves the creation of home price contingent financial instruments based upon the change in certain contractually-specified home price indices or other value estimation metrics.

Use of Existing Customer Database of Home Price Contingent Assets—Many of the processes provide a mechanism to evaluate the existing portfolio of geographically-pegged assets of the third party vendor/financial intermediary so as to provide a more carefully tailored financial product or solution, taking the whole existent set (old and new with the possibility of exchange) into account.

Portfolio Maintenance—A process that rebalances an existing third party vendor/financial intermediary's portfolio so as to alter the characteristics of the portfolio, including (among others) the following desired changes: (1) maximum diversification, (2) more accurate price contingent liability correlation, (3) geographic rebalancing, etc.

Relational Pair Database Creation and Use—A relational pair database is created and used which links (1) an amount of funds with (2) a geographic area. This database is manipulated, scanned, and utilized substantially throughout the processes.

Third Party/Financial Intermediary Qualification Process—A process that qualifies the third party vendor/financial intermediary to serve as a counterparty in an exchange transaction involving, at least in part, home appreciation loan assets.

Third Party Vendor/Financial Intermediary Recognition Process—A process that identifies the third party vendor/financial intermediary as a previous counterparty in a transaction with the lending or exchange activity involving, at least in part, home appreciation loan assets. This is a trigger for access and use of an existing customer database.

Determination of Need of Funds Process—A process to evaluate whether the home appreciation loan lender can effectively utilize the funds proposed to be transferred by the third party vendor/financial intermediary.

Determination of Extent of Possible Geographic Correlation Process—A process that evaluates the relational pair database populated with third party vendor/financial intermediary data concerning nominal amounts and the linked geographic region to determine what level of correlation is possible (if any) with home price changes in that area.

Three Categories—Divides the funds into three categories: (1) those that can be correlated in the lender's ordinary course of lending, (2) those that can be correlated through modification of lending practices within tolerances specified by the lender, and (3) those that cannot be correlated exactly with the region specified by the third party vendor/financial intermediary. This last group is pegged to the most closely correlated second best region available.

Ability to Subdivide Price Contingent Assets Based on Correlation—Distinct home price appreciation assets can be included or excluded from the bundle or securitized instrument based upon its categorization. Additionally, a part of any single home price appreciation loan asset can be included or excluded based on a probabilistic estimate of it falling into one of the categories.

Inputting of Correlation Preferences—A process could be utilized to offer the third party vendor/financial intermediary the option of including or excluding home price appreciation assets based upon the categorization process described above.

Evaluation of Historical Lending Activity—A process that statistically analyzes historical home appreciation loan lending to predict whether correlation will be achieved in the future within the three categories specified above.

Geographic Matching Process—A process which matches the available home price appreciation assets with the geographic regions specified by the third party vendor/financial intermediary, beginning with the narrowest region (e.g. zip code or neighborhood) proceeding to the broadest (e.g. the United States or entire globe) within which the relevant address is located. For example, assume the subject property's address is Cambridge, Mass. 02138 and the nominal amount of funds was $1,000. This process would run through the database of existing home price appreciation assets starting with the zip code 02138 then going broader to a level such as the city Cambridge then MA then New England then the U.S. then the globe. The exact regions can be defined in many ways.

Maximum Diversification of Funds Process—A process which maximizes the diversification of the available matched home price appreciation assets. This could be done by maximizing the summed distances between the included assets or through a simpler mechanism such as dividing the region into grids.

Home Price Appreciation Asset Inclusion Process—A process could be executed which takes a home appreciation loan lender's maximum limit and records a second flag for those home appreciation loan assets (within the initially flagged group) that will be included in the new financial security. This process might also use historical lending data, historical price appreciation data, predicted lending data, predicted price appreciation data, or any other relevant data set to provide a second flag to the initially flag loans so as to create a subset with certain desirable characteristics, which could include (among many others variants): (1) maximizing or minimizing projected returns, (2) satisfying risk-weighting metrics, (3) optimizing diversification within the targeted zone, (4) correlating the components positively or negatively, (5) ensuring regulatory compliance of the aggregation, and/or (6) tailoring the aggregation to appeal to particular targeted investment profiles (such as long-term investors, institutional investors, home price-pegged accountholders, first-time homebuyers, prospective retirees, etc.).

Automatic Monitoring of Home Price Appreciation Assets and Bundling or Securitization Triggering—A process that scans the third party vendor's/financial intermediary's existing or expected portfolio of home price appreciation assets according to certain lender-specified characteristics and triggers a bundling or securitization process when those criteria are satisfied.

Implementations of the invention may include one or more of the following features. The aggregating comprises bundling asset appreciation interests. The aggregating comprises securitizing asset appreciation interests and another form of instrument. The other form of instrument includes a financial instrument, a derivative instrument, or an obligation. The instrument includes a guarantee of a stream of fixed payments.

1. A method comprising
crediting a value to a holder of an appreciating asset, and
in exchange for the crediting, receiving a commitment by the holder (a) of repayment of an amount, which declines over time whether or not the holder has paid any portion of the amount, and (b) that a share of appreciation of the asset will be paid upon the transfer of the asset by the holder.

2. A method comprising
crediting a value to a holder of an appreciating asset, and
in exchange for the crediting, receiving a commitment by the holder that a share of appreciation of the asset will be paid upon the transfer of the asset by the holder, without receiving a commitment by the holder to pay any other interest amount not based on appreciation.

3. A method comprising
receiving from a holder of an asset an indication of a share of appreciation of the asset that would be paid in exchange for a loan, and
calculating proposed terms of the loan based on the indicated share of appreciation.

4. A method comprising
setting a value to be credited to a holder of an appreciating asset,
setting a share of appreciation of the asset that would be paid in exchange for the value, and
determining a time period in which a repayment amount will decline to a predetermined value, based on the credited value and the share of appreciation.

5. The method of claim 1 or 4 in which the repayment amount declines to a predetermined amount.

6. The method of claim 5 in which the repayment amount declines to the predetermined amount within a predefined number of months.

7. The method of claim 5 in which the predetermined amount is $0.

8. The method of claim 1, 2, 3 or 4 in which the share of appreciation comprises a percentage of the appreciation.

9. The method of claim 1, 2, 3, or 4 in which the asset comprises a house and the holder is an owner of the house.

10. The method of claim 1, 2, 3, or 4 also including receiving a commitment of the holder to fund insurance against risk of loss of the asset.

11. The method of claim 1, 2, 3, or 4 also including receiving a transferable right of first refusal from the holder with respect to the asset.

12. The method of claim 1, 2, 3, or 4 also including receiving an information updating commitment from the holder.

13. The method of claim 1, 2, 3, or 4 also including receiving an anti-subordination commitment from the holder.

14. The method of claim 1, 2, 3, or 4 also including placing a lien on the asset.

15. The method of claim 1, 2, 3, or 4 also including providing a mechanism for reimbursement of the holder's maintenance, improvement, or selling expenses with respect to the asset.

16. The method of claim 1, 2, 3, or 4 also including receiving an estimate of the value of the asset, and analyzing the accuracy of the estimated value to determine a corrected value.

17. A method comprising
receiving information describing an asset associated with the appreciation loan, and
comparing the information to information defining properties qualifying to underlie the appreciation loan.

18. The method of claim 16 in which, if the corrected value is not within a threshold of the estimated value, the holder may either accept the estimated value, accept the corrected value, or obtain an appraisal.

19. A method comprising
determining if an asset which is to be associated with an appreciation loan is subject to a legal impediment that would restrict transfer of the asset, and
if so, adjusting terms of the appreciation loan.

20. The method of claim 19 in which the impediment is associated with at least one of: homesteading laws, usury laws, mandatory loan waiting periods, and mandatory cancellation periods.

21. A method comprising
receiving from a holder of an asset, proposed values of variables associated with a proposed appreciation loan supported by the asset, the variables including at least one of the amount of the loan, the share of appreciation to be paid back by the holder, and the number of months during which a principal balance will decline to a predetermined amount, and
providing to the holder proposed values for the variables that have not been received from the holder.

22. A method comprising generating a schedule of a balance of a principal amount and an appreciation interest for any time period after issuance of a loan associated with an appreciating asset.

23. A method comprising
receiving a proposed nominal value of an appreciation loan associated with an appreciating asset, and
determining whether the nominal value meets guidelines of a lender of the loan.

24. A method comprising
recording values of the terms of asset appreciation loans and information about aborted loans or rejected borrowers.

25. A method comprising
calculating amounts due to a lender upon transfer of an appreciating asset or repayment of an appreciation loan associated with the asset based on a loan schedule.

26. A method comprising
determining a lender's economic interest in an asset associated with an appreciation loan at a given time, and
reimbursing a holder of the asset for maintenance, improvement, or selling expenses up to a specified contribution percentage determined as a function of the lender's economic interest.

27. A method comprising
aggregating asset appreciation interests, the assets being organized based on geographic characteristics of the assets.

28. The method of claim 27 in which the aggregating comprises bundling asset appreciation interests.

29. The method of claim 28 in which the aggregating comprises securitizing asset appreciation interests with another form of instrument.

30. The method of claim 28 in which the other form of instrument includes a financial instrument, a derivative instrument, or an obligation.

31. The method of claim 28 in which the instrument includes a guarantee of a stream of fixed payments.

32. The method of claim 31 in which the fixed payments comprise a compensating fixed interest rate component of a securitized asset with respect to collection of the asset appreciation interests.

33. The method of claim 32 in which an acquirer of the asset appreciation interests specifies a minimum acceptable fixed interest rate and the method includes determining that an expected variable interest rate formed as an aggregate of the asset appreciation interests and fixed balance payments is below the minimum acceptable rate.

34. The method of claim 27 comprising
consolidating the aggregated appreciation assets with other instruments selected to achieve financial characteristics that match predetermined financial characteristics.

35. The method of claim 34 also including updating a database to include records for the other instruments.

36. The method of claim 34 in which the other instruments include an obligation to make a lump sum payment.

37. The method of claim 36 in which the lump sum payment comprises a cash payment equal to a nominal amount of a loan granted by a third party vendor/financial intermediary.

38. The method of claim 34 in which the consolidating is triggered either by an action of a lender or an action of a third party vendor/financial intermediary.

39. A method comprising
organizing asset appreciation interests to include a fixed repayment balance and an asset appreciation participation interests.

40. The method of claim 39 in which the asset appreciation participation interests are subdivided.

41. The method of claim 39 in which the interests are bundled or securitized.

42. A method comprising
forming a pooled financial instrument that includes asset appreciation interests, and
basing the constituents of the pooled financial instrument on predefined financial characteristics.

43. The method of claim 42 in which the predefined financial characteristics are received from a third-party vendor/financial intermediary.

44. The method of claim 43 in which existing or expected appreciation asset interests are bundled or securitized as the financial instrument having the financial characteristics.

45. The method of claim 43 in which the financial instrument comprises an asset appreciation contingent financial instrument in which a value of the instrument is based upon a change in a contractually-specified valuation metric.

46. The method of claim 45 in which the valuation metric comprises indices of values of the financial instrument.

47. A method comprising
evaluating a portfolio of geographically-pegged appreciation assets of a third-party vendor/financial intermediary, and
offering a financial product through the intermediary a based on the evaluated portfolio.

48. The method of claim 47 in which the financial product is offered based on a consideration of old assets, new assets, and exchanges of assets.

49. A method comprising
rebalancing a portfolio of asset appreciation interests to achieve at least one of improved diversification, more accurate price contingent liability correlation, and geographic adjustment.

50. A method comprising
maintaining a database, the database comprising relational pairs, each of the pairs linking an amount of funds associated with asset appreciation interests with a geographic area associated with appreciation assets.

51. A method comprising
evaluating a party as a possible third-party vendor/financial intermediary to serve as counterparty in an exchange transaction involving appreciation loan assets.

52. The method of claim 51 in which the third-party vendor/financial intermediary is identified as a previous counterparty in a transaction involving appreciation loan assets.

53. A method comprising
evaluating whether a lender of funds on asset appreciation loans can utilize funds proposed to be provided by a third-party vendor/financial intermediary, and
if so, accepting the funds from the intermediary.

54. The method of claim 51 also including
evaluating the relational pair database for a correlation of asset appreciation interests in the area.

55. The method of claim 51 also including
dividing a fund of asset appreciation interests into three categories: (1) those interests that can be correlated in a lender's ordinary course of lending, (2) those interests that can be correlated through modification of lending practices within predefined, and (3) those interests that cannot be correlated exactly with the region specified by the third-party vendor/financial intermediary.

56. The method of claim 55 in which distinct appreciation assets are included or excluded in a bundled or securitized instrument based upon their categorization.

57. The method of claim 56 in which the constituents of the appreciation interest comprise appreciation assets that are included or excluded in the instrument based on a probabilistic estimate of their falling into one of the categories.

58. The method of claim 57 in which the inclusion or exclusion is based on a choice made by the third-party vendor/financial intermediary.

59. The method of claim 55 also including statistically analyzing historical asset appreciation loan lending to predict whether correlation will be achieved in the future within the three categories.

60. A method comprising
matching available appreciation assets with geographic regions specified by a third-party vendor/financial intermediary, with respect to a narrower geographic region and then with respect to a broader within which an asset is associated.

61. A method comprising
maximizing a diversification of available matched appreciation assets based on geographic diversity.

62. The method of claim 61 in which the maximizing comprises maximizing geographic distances among included assets.

63. A method comprising
selecting appreciation assets for inclusion in a financial security, the selecting being based on an appreciation asset loan lender's lending limit, and
from the selected group, identifying appreciation loan assets to be included in the new financial security.

64. The method of claim 63 also including identifying the assets to be included based on at least one of historical lending data, historical price appreciation data, predicted lending data, and predicted price appreciation data.

65. The method of claim 63 in which the appreciation loan assets are identified in a manner to achieve at least one of: (1) maximizing or minimizing projected returns, (2) risk-weighting metrics, (3) optimizing diversification within a targeted zone, (4) correlating components positively or negatively, (5) ensuring regulatory compliance of financial security, and (6) tailoring the financial security to appeal to a targeted investor.

66. A method comprising
scanning a third-party vendor's/financial intermediary's existing or expected portfolio of appreciation assets according to lender-specified characteristics, and
triggering a bundling or securitization process when the characteristics are satisfied.
